(19) United States
(12) Patent Application Publication
(10) Pub. No.: US 2020/0302655 A1
(43) Pub. Date: Sep. 24, 2020

(54) POINT CLOUD DATA TRANSMISSION DEVICE, POINT CLOUD DATA TRANSMISSION METHOD, POINT CLOUD DATA RECEPTION DEVICE AND POINT CLOUD DATA RECEPTION METHOD

(71) Applicant: LG ELECTRONICS INC., Seoul (KR)

(72) Inventor: Sejin OH, Seoul (KR)

(73) Assignee: LG ELECTRONICS INC., Seoul (KR)

(21) Appl. No.: 16/825,904

(22) Filed: Mar. 20, 2020

(30) Foreign Application Priority Data
Mar. 20, 2019 (KR) 10-2019-0032004

(51) Int. Cl. G06T 9/40

(52) U.S. Cl. CPC G06T 9/40

(57) ABSTRACT

Disclosed herein are a point cloud data transmission method including encoding point cloud data and transmitting the point cloud data, and a point cloud data reception method including receiving point cloud data, decoding the point cloud data, and rendering the point cloud data.

Pursuant to 35 U.S.C. § 119(a), this application claims the benefit of earlier filing date and right of priority to Korean Application No. 10-2019-0032004, filed on Mar. 20, 2019, the contents of which are all hereby incorporated by reference herein in its entirety.

### BACKGROUND OF THE INVENTION

### Field of the Invention

Embodiments provide a method for providing point cloud contents to provide a user with various services such as virtual reality (VR), augmented reality (AR), mixed reality (MR), and autonomous driving services.

### Discussion of the Related Art

A point cloud is a set of points in a three-dimensional (3D) space. It is difficult to generate point cloud data because the number of points in the 3D space is large.

A large amount of throughput is required to transmit and receive data of a point cloud, which raises an issue.

### SUMMARY OF THE INVENTION

An object of the present disclosure is to provide a point cloud data transmission apparatus, a point cloud data transmission method, a point cloud data reception apparatus, and a point cloud data reception method for efficiently transmitting and receiving a point cloud.

Another object of the present disclosure is to provide a point cloud data transmission apparatus, a point cloud data transmission method, a point cloud data reception apparatus, and a point cloud data reception method for addressing latency and encoding/decoding complexity.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a method of transmitting point cloud data may include encoding point cloud data, and transmitting a bitstream including the point cloud data.

The point cloud data may include geometry data, attribute data, and occupancy map data, which are encoded by a video-based point cloud compression (V-PCC) scheme.

The bitstream may include V-PCC units, each of which includes a header and a payload. The header may include type information for identifying data included in the payload that includes one of the geometry data, the attribute data, the occupancy map data and metadata, the metadata including at least patch information or parameter information.

At least the header or the metadata may include layer information related to a layer of the geometry data and a layer of the attribute data.

The layer information may include at least one of information for indicating whether multiple layers have been used to encode the geometry data, information for indicating whether multiple layers have been used to encode the attribute data, information for indicating whether a number of layers used to encode the geometry data is different from a number of layers used to encode the attribute data, information for indicating the number of layers used to encode the geometry data, and information for indicating the number of layers used to encode the attribute data.

A point cloud data transmission device according to embodiments may include an encoder for encoding point cloud data and a transmitter for transmitting a bitstream that includes the point cloud data.

The point cloud data may include geometry data, attribute data, and occupancy map data, which are encoded by a video-based point cloud compression (V-PCC) scheme.

The bitstream may include V-PCC units, each of which includes a header and a payload. The header may include type information for identifying data included in the payload that includes one of the geometry data, the attribute data, the occupancy map data and metadata, the metadata including at least patch information or parameter information.

At least the header or the metadata may include layer information related to a layer of the geometry data and a layer of the attribute data.

The layer information may include at least one of information for indicating whether multiple layers have been used to encode the geometry data, information for indicating whether multiple layers have been used to encode the attribute data, information for indicating whether a number of layers used to encode the geometry data is different from a number of layers used to encode the attribute data, information for indicating the number of layers used to encode the geometry data, and information for indicating the number of layers used to encode the attribute data.

A point cloud data reception method according to embodiments may include receiving a bitstream that includes point cloud data, decoding the point cloud data, and rendering the point cloud data.

The point cloud data may include geometry data, attribute data, and occupancy map data, which are encoded by a video-based point cloud compression (V-PCC) scheme.

The bitstream may include V-PCC units, each of which includes a header and a payload. The header may include type information for identifying data included in the payload that includes one of the geometry data, the attribute data, the occupancy map data and metadata, the metadata including at least patch information or parameter information.

At least the header or the metadata may include layer information related to a layer of the geometry data and a layer of the attribute data.

The layer information may include at least one of information for indicating whether multiple layers have been used to encode the geometry data, information for indicating whether multiple layers have been used to encode the attribute data, information for indicating whether a number of layers used to encode the geometry data is different from a number of layers used to encode the attribute data, information for indicating the number of layers used to encode the geometry data, and information for indicating the number of layers used to encode the attribute data.

A point cloud data reception device according to embodiments may include a receiver for receiving a bitstream that includes point cloud data, a decoder for decoding the point cloud data, and a renderer for rendering the point cloud data.

The point cloud data may include geometry data, attribute data, and occupancy map data, which are encoded by a video-based point cloud compression (V-PCC) scheme.

The bitstream may include V-PCC units, each of which includes a header and a payload. The header may include type information for identifying data included in the payload that includes one of the geometry data, the attribute data, the occupancy map data and metadata, the metadata including at least patch information or parameter information.

At least the header or the metadata may include layer information related to a layer of the geometry data and a layer of the attribute data.

The layer information may include at least one of information for indicating whether multiple layers have been used to encode the geometry data, information for indicating whether multiple layers have been used to encode the attribute data, information for indicating whether a number of layers used to encode the geometry data is different from a number of layers used to encode the attribute data, information for indicating the number of layers used to encode the geometry data, and information for indicating the number of layers used to encode the attribute data.

A point cloud data transmission method, a point cloud data transmission apparatus, a point cloud data reception method, and a point cloud data reception apparatus according to embodiments may provide a good-quality point cloud service.

A point cloud data transmission method, a point cloud data transmission apparatus, a point cloud data reception method, and a point cloud data reception apparatus according to embodiments may achieve various video codec methods.

A point cloud data transmission method, a point cloud data transmission apparatus, a point cloud data reception method, and a point cloud data reception apparatus according to embodiments may provide universal point cloud content such as an autonomous driving service.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 illustrates an exemplary structure of a transmission/reception system for providing point cloud content according to embodiments;

FIG. 2 illustrates capture of point cloud data according to embodiments;

FIG. 3 illustrates an exemplary point cloud, geometry, and texture image according to embodiments;

FIG. 4 illustrates an exemplary V-PCC encoding process according to embodiments;

FIG. 5 illustrates an example of a tangent plane and a normal vector of a surface according to embodiments;

FIG. 6 illustrates an exemplary bounding box of a point cloud according to embodiments;

FIG. 7 illustrates an example of determination of individual patch positions on an occupancy map according to embodiments;

FIG. 8 shows an exemplary relationship among normal, tangent, and bitangent axes according to embodiments;

FIG. 9 shows an exemplary configuration of the minimum mode and maximum mode of a projection mode according to embodiments;

FIG. 10 illustrates an exemplary EDD code according to embodiments;

FIG. 11 illustrates an example of recoloring based on color values of neighboring points according to embodiments;

FIG. 12 illustrates an example of push-pull background filling according to embodiments;

FIG. 13 shows an exemplary possible traversal order for a 4*4 block according to embodiments;

FIG. 14 illustrates an exemplary best traversal order according to embodiments;

FIG. 15 illustrates an exemplary 2D video/image encoder according to embodiments;

FIG. 16 illustrates an exemplary V-PCC decoding process according to embodiments;

FIG. 17 shows an exemplary 2D video/image decoder according to embodiments;

FIG. 18 is a flowchart illustrating operation of a transmission device according to embodiments of the present disclosure;

FIG. 19 is a flowchart illustrating operation of a reception device according to embodiments;

FIG. 20 illustrates an exemplary architecture for V-PCC based storage and streaming of point cloud data according to embodiments;

FIG. 21 is an exemplary block diagram of an apparatus for storing and transmitting point cloud data according to embodiments;

FIG. 22 is an exemplary block diagram of a point cloud data reception device according to embodiments;

FIG. 23 illustrates an exemplary structure operable in connection with point cloud data transmission/reception methods/devices according to embodiments;

FIG. 24 illustrates an example of a V-PCC bitstream architecture according to the embodiments;

FIG. 25 illustrates an example of a syntax structure of each V-PCC unit according to the embodiments;

FIG. 26 illustrates an example of a syntax structure of a V-PCC unit header according to the embodiments;

FIG. 27 illustrates an example of a type of a V-PCC unit allocated to a vpcc_unit_type field according to the embodiments;

FIG. 28 illustrates an example of an attribute video data type allocated to a vpcc_attribute_type field according to the embodiment;

FIG. 29 illustrates an example of a syntax structure of a V-PCC unit payload according to the embodiments;

FIGS. 30 and 31 illustrate examples of a syntax structure of a sequence parameter set included in V-PCC unit payload according to the embodiments;

FIG. 32 illustrates an example of a syntax structure of profile tier level( ) information included in a sequence parameter set according to the embodiments;

FIG. 33 illustrates an example of a syntax structure of an occupancy parameter set according to the embodiments;

FIG. 34 illustrates an example of a syntax structure of a geometry parameter set according to the embodiments;

FIG. 35 illustrates an example of a syntax structure of geometry sequence parameters according to the embodiments;

FIG. 36 illustrates an example of a syntax structure of an attribute parameter set according to the embodiments;

FIG. 37 illustrates an example of a syntax structure of attribute sequence parameters according to the embodiments;

FIG. 38 illustrates an example of a structure of a patch data frame according to the embodiments;

FIG. 39 illustrates an example of a syntax structure of a geometry patch frame parameter set according to the embodiments;

FIG. 40 illustrates an example of a syntax structure of geometry patch frame parameters according to the embodiments;

FIG. 41 illustrates an example of a syntax structure of an attribute patch frame parameter set according to the embodiments;

FIG. 42 illustrates an example of a syntax structure of attribute patch frame parameters according to the embodiments;

FIG. 43 illustrates an example of dividing a point cloud object into one or multiple tiles according to the embodiments;

FIG. 44 illustrates an example of a syntax structure of a tile parameter set according to the embodiments;

FIG. 45 illustrates an example of a syntax structure of patch information data according to the embodiments;

FIG. 46 illustrates a point cloud data transmission method according to the embodiments; and

FIG. 47 illustrates a point cloud data reception method according to the embodiments.

### DETAILED DESCRIPTION OF THE INVENTION

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that can be implemented according to the present disclosure. The following detailed description includes specific details in order to provide a thorough understanding of the present disclosure. However, it will be apparent to those skilled in the art that the present disclosure may be practiced without such specific details.

Although most terms used in the present disclosure have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings.

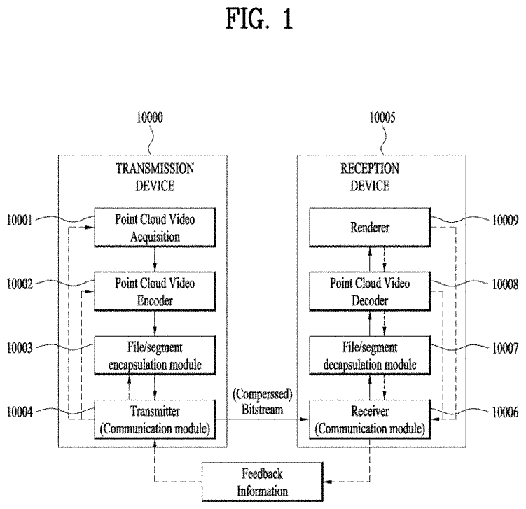

FIG. 1 illustrates an exemplary structure of a transmission/reception system for providing point cloud content according to embodiments.

In this disclosure, a method for providing point cloud contents to provide a user with various services such as virtual reality (VR), augmented reality (AR), mixed reality (MR), and autonomous driving service. Point cloud contents according to the embodiments indicate data obtained by expressing objects as points, and may be referred to as point cloud, point cloud data, point cloud video data, point cloud image data, etc.

A point data transmission device 10000 according to the embodiments includes a point cloud video acquisition unit 10001, a point cloud video encoder 10002, a file/segment encapsulation module 10003, and a transmitter 10004 (or communication module). The transmission device according to the embodiments may make sure of and process point cloud video (or point cloud content) and transmit the processed point cloud video. In accordance with the embodiments, the transmission device may include a fixed station, a base transceiver system (BTS), a network, Artificial Intelligence (AI) device and/or system, a robot, AR/VR/XR device and/or server, etc. Also, in accordance with the embodiments, the transmission device 10000 may include a device, a robot, a vehicle, an AR/VR/XR device, a portable device, a home appliance, an Internet of Thing (IoT) device, an AI device/server, etc., which perform communication with a base station and/or another wireless device, by using wireless access technology (for example, 5G New RAT (NR) and Long Term Evolution (LTE)).

The point cloud video acquisition unit 10001 according to the embodiments acquires Point Cloud video data through a process of capturing, synthesizing or generating the point cloud video.

The point cloud video encoder 10002 according to the embodiments encodes the point cloud video data acquired by the point cloud video acquisition unit 10001. In accordance with the embodiments, the point cloud video encoder 10002 may be referred to as a point cloud encoder, a point cloud data encoder, an encoder, etc. Also, point cloud compression coding (encoding) according to the embodiments is not limited to the aforementioned embodiment. The point cloud video encoder may output bitstreams including the encoded point cloud video data. The bitstreams may include signaling information related to encoding of the point cloud video data as well as the encoded point cloud video data.

The point cloud video encoder 10002 according to the embodiments may support a Geometry-based Point Cloud Compression (G-PCC) encoding scheme and/or a Video-based Point Cloud Compression (V-PCC) encoding scheme. Also, the point cloud video encoder 10002 may encode point cloud (indicating point cloud data or points) and/or signaling data related to point cloud.

The file/segment encapsulation module 10003 according to the embodiments encapsulates the point cloud data in the form of file and/or segment. The point cloud data transmission method/device according to the embodiments may transmit the point cloud data in the form of file and/or segment.

The transmitter 10004 (or communication module) according to the embodiments transmits the encoded point cloud video data in the form of bitstreams. In accordance with the embodiments, files or segments may be transmitted to the reception device through the network, or may be stored in a digital storage medium (for example, USB, SD, CD, DVD, Blu-ray, HDD, SSD, etc.). The transmitter according to the embodiments may perform wire/wireless communication the reception device (or receiver) through 4G, 5G, 6G, etc. Also, the transmitter may perform a necessary data processing operation in accordance with a network system (for example, a communication network system such as 4G, 5G, 6G, etc.). Also, the transmission device may transmit the encapsulated data in accordance with an On Demand scheme.

The point cloud data reception device 10005 according to the embodiments includes a receiver 10006, a file/segment decapsulation module 10007, a point cloud video decoder 10008, and/or a renderer 10009. In accordance with the embodiments, the reception device may include a device, a robot, a vehicle, an AR/VR/XR device, a portable device, a home appliance, an Internet of Thing (IoT) device, an AI device/server, etc., which perform communication with a base station and/or another wireless device, by using wireless access technology (for example, 5G New RAT (NR) and Long Term Evolution (LTE)).

The receiver 10006 according to the embodiments receives a bitstream containing point cloud video data. According to embodiments, the receiver 10006 may transmit feedback information to the point cloud data transmission device 10000.

The file/segment decapsulation module 10007 decapsulates a file and/or a segment containing point cloud data.

The point cloud video decoder 10008 decodes the received point cloud video data.

The renderer 10009 renders the decoded point cloud video data. According to embodiments, the renderer 10009 may transmit the feedback information obtained at the reception side to the point cloud video decoder 10008. The point cloud video data according to the embodiments may carry feedback information to the receiver 10006. According to embodiments, the feedback information received by the point cloud transmission device may be provided to the point cloud video encoder 10002.

An arrow marked with a dotted line as shown indicates a transmission path of feedback information acquired from the reception device 10005. The feedback information is information for reflecting interactivity with a user who consumes point cloud content, and includes a user's information (for example, head orientation information), viewport information, etc. Particularly, if the point cloud content is a content for a service (for example, autonomous driving service) that requires interaction with a user, the feedback information may be delivered to a content transmission side (for example, transmission device 10000) and/or a service provider. In accordance with the embodiments, the feedback information may be used even in the reception device 10005 as well as the transmission device 10000, or may not be provided.

The head orientation information according to the embodiments is information on a user's head position, direction, angle, motion, etc. the reception device 10005 according to the embodiments may calculate viewport information based on the head orientation information. The viewport information is information on an area of a point cloud video viewed by a user. A viewpoint is a point at which a user views point cloud video, and may mean a center point of a viewport area. That is, the viewport is an area based on a viewpoint, and a size, shape, etc. of the area may be determined by a field of view (FOV). Therefore, the reception device 10005 may extract viewport information based on a vertical or horizontal FOV supported by a device, in addition to the head orientation information. Also, the reception device 10005 identifies a user's point cloud consuming scheme, a point cloud video area at which a user gazes, and a gaze time by performing gaze analysis. In accordance with the embodiments, the reception device 10005 may transmit feedback information including the result of gaze analysis to the transmission device 10000. The feedback information according to the embodiments may be acquired by the process of rendering and/or display. The feedback information according to the embodiments may be obtained by one or multiple sensors included in the reception device 10005. Also, in accordance with the embodiments, the feedback information may be obtained by the renderer 10009 or a separate external element (or device, component, etc.). The dotted line of FIG. 1 illustrates a delivery step of the feedback information obtained by the renderer 10009. The point cloud content providing system may process (encode/decode) point cloud data based on the feedback information. Therefore, the point cloud video decoder 10008 may perform the decoding operation based on the feedback information. Also, the reception device 10005 may transmit the feedback information to the transmission device. The transmission device (or the point cloud video encoder 10002) may perform the encoding operation based on the feedback information. Therefore, the point cloud content providing system may efficiently process necessary data (for example, point cloud data corresponding to a user's head position) based on the feedback information without processing (encoding/decoding) all of the point cloud data, and may provide a user with a point cloud content.

In accordance with the embodiments, the transmission device 10000 may be referred to as an encoder, a transmitter, etc., and the reception device 10005 may be referred to as a decoder, a receiver, etc.

The point cloud data processed (processed by a series of processes of acquisition/encoding/transmission/decoding/rendering) by the point could content providing system of FIG. 1 may be referred to as point cloud content data or point cloud video data. In accordance with the embodiments, the point cloud content data may be used as a content that includes metadata or signaling information related to the point cloud data.

The elements of the point cloud content providing system shown in FIG. 1 may be implemented by hardware, software, a processor and/or their combination.

Embodiments may provide a method of providing point cloud content to provide a user with various services such as virtual reality (VR), augmented reality (AR), mixed reality (MR), and autonomous driving.

In order to provide a point cloud content service, a point cloud video may be acquired first. The acquired point cloud video may be transmitted through a series of processes, and the reception side may process the received data back into the original point cloud video and render the processed point cloud video. Thereby, the point cloud video may be provided to the user. Embodiments provide a method of effectively performing this series of processes.

The entire processes for providing a point cloud content service (the point cloud data transmission method and/or point cloud data reception method) may include an acquisition process, an encoding process, a transmission process, a decoding process, a rendering process, and/or a feedback process.

According to embodiments, the process of providing point cloud content (or point cloud data) may be referred to as a point cloud compression process. According to embodiments, the point cloud compression process may represent a video-based point cloud compression (V-PCC) process.

Each element of the point cloud data transmission device and the point cloud data reception device according to the embodiments may be hardware, software, a processor, and/or a combination thereof.

The point cloud compression system may include a transmission device and a reception device. According to embodiments, the transmission device may by referred to as an encoder, a transmission apparatus, a transmitter, or a point cloud transmission device. According to embodiments, reception device may be referred to as a decoder, a reception apparatus, a receiver, or a point cloud reception device. The transmission device may output a bitstream by encoding a point cloud video, and deliver the same to the reception device through a digital storage medium or a network in the form of a file or a stream (streaming segment). The digital storage medium may include various storage media such as a USB, SD, CD, DVD, Blu-ray, HDD, and SSD.

The transmission device as shown in FIG. 1 may include a point cloud video acquisition unit, a point cloud video encoder, a file/segment encapsulation module, and a transmitter. The reception device as shown in FIG. 1 may include a receiver, a file/segment decapsulation module, a point cloud video decoder, and a renderer. The encoder may be referred to as a point cloud video/picture/picture/frame encoder, and the decoder may be referred to as a point cloud video/picture/picture/frame decoding device. The renderer may include a display. The renderer and/or the display may be configured as separate devices or external components. The transmission device and the reception device may further include a separate internal or external module/unit/component for the feedback process. Each element included in a transmission device and a reception device according to embodiments may be made up of hardware, software and/or processor.

According to embodiments, the operation of the reception device may be the reverse of the operation of the transmission device.

The point cloud video acquirer may perform the process of acquiring point cloud video through a process of capturing, composing, or generating point cloud video. In the acquisition process, data of 3D positions (x, y, z)/attributes (color, reflectance, transparency, etc.) of multiple points, for example, a polygon file format (PLY) (or the Stanford triangle format) file may be generated. For a video having multiple frames, one or more files may be acquired. During the capture process, point cloud related metadata (e.g., capture related metadata) may be generated.

A point cloud data transmission device according to embodiments may include an encoder configured to encode point cloud data, and a transmitter configured to transmit the point cloud data or a bitstream including the point cloud data.

A point cloud data reception device according to embodiments may include a receiver configured to receive point cloud data, a decoder configured to decode the point cloud data, and a renderer configured to render the point cloud data.

The method/device according to the embodiments represents the point cloud data transmission device and/or the point cloud data reception device.

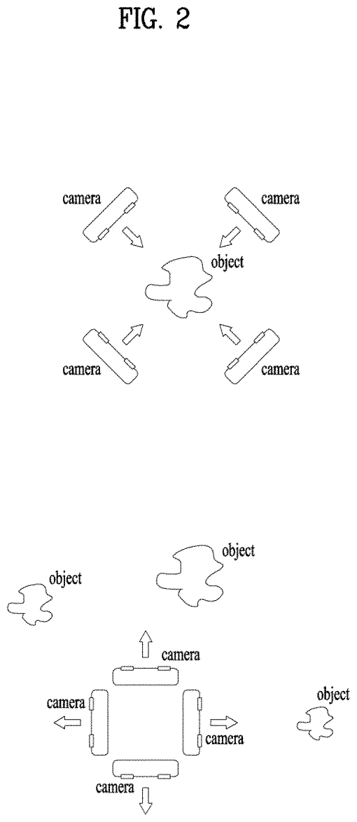

FIG. 2 illustrates capture of point cloud data according to embodiments.

Point cloud data (or point cloud video data) according to embodiments may be acquired by a camera or the like. A capturing technique according to embodiments may include, for example, inward-facing and/or outward-facing.

In the inward-facing according to the embodiments, one or more cameras inwardly facing an object of point cloud data may photograph the object from the outside of the object.

In the outward-facing according to the embodiments, one or more cameras outwardly facing an object of point cloud data may photograph the object. For example, according to embodiments, there may be four cameras.

The point cloud data or the point cloud content according to the embodiments may be a video or a still image of an object/environment represented in various types of 3D spaces.

For capture of point cloud content, a combination of camera equipment (a combination of an infrared pattern projector and an infrared camera) capable of acquiring depth and RGB cameras capable of extracting color information corresponding to the depth information may be configured. Alternatively, the depth information may be extracted through LiDAR, which uses a radar system that measures the location coordinates of a reflector by emitting a laser pulse and measuring the return time. A shape of the geometry consisting of points in a 3D space may be extracted from the depth information, and an attribute representing the color/reflectance of each point may be extracted from the RGB information. The point cloud content may include information about the positions (x, y, z) and color (YCbCr or RGB) or reflectance (r) of the points. For the point cloud content, the outward-facing technique of capturing an external environment and the inward-facing technique of capturing a central object may be used. In the VR/AR environment, when an object (e.g., a core object such as a character, a player, a thing, or an actor) is configured into point cloud content that may be viewed by the user in any direction (360 degrees), the configuration of the capture camera may be based on the inward-facing technique. When the current surrounding environment is configured into point cloud content in a mode of a vehicle, such as autonomous driving, the configuration of the capture camera may be based on the outward-facing technique. Because the point cloud content may be captured by multiple cameras, a camera calibration process may need to be performed before the content is captured to configure a global coordinate system for the cameras.

The point cloud content may be a video or still image of an object/environment presented in various types of 3D spaces.

Additionally, in the point cloud content acquisition method, any point cloud video may be composed based on the captured point cloud video. Alternatively, when a point cloud video for a computer-generated virtual space is to be provided, capturing with an actual camera may not be performed. In this case, the capture process may be replaced simply by a process of generating related data.

Post-processing may be needed for the captured point cloud video to improve the quality of the content. In the video capture process, the maximum/minimum depth may be adjusted within a range provided by the camera equipment. Even after the adjustment, point data of an unwanted area may still be present. Accordingly, post-processing of removing the unwanted area (e.g., the background) or recognizing a connected space and filling the spatial holes may be performed. In addition, point clouds extracted from the cameras sharing a spatial coordinate system may be integrated into one piece of content through the process of transforming each point into a global coordinate system based on the coordinates of the location of each camera acquired through a calibration process. Thereby, one piece of point cloud content having a wide range may be generated, or point cloud content with a high density of points may be acquired.

The point cloud video encoder 10002 may encode the input point cloud video into one or more video streams. One point cloud video may include a plurality of frames, each of which may correspond to a still image/picture. In this specification, a point cloud video may include a point cloud image/frame/picture. In addition, the term “point cloud video” may be used interchangeably with a point cloud image/frame/picture. The point cloud video encoder 10002 may perform a video-based point cloud compression (V-PCC) procedure. The point cloud video encoder 10002 may perform a series of procedures such as prediction, transformation, quantization, and entropy coding for compression and encoding efficiency. The encoded data (encoded video/image information) may be output in the form of a bitstream. Based on the V-PCC procedure, the point cloud video encoder 10002 may encode point cloud video by dividing the same into a geometry video, an attribute video, an occupancy map video, and auxiliary information, which will be described later. The geometry video may include a geometry image, the attribute video may include an attribute image, and the occupancy map video may include an occupancy map image. The auxiliary information (or auxiliary data) may include auxiliary patch information. The attribute video/image may include a texture video/image.

The file/segment encapsulation module 10003 may encapsulate the encoded point cloud video data and/or metadata related to the point cloud video in the form of, for example, a file. Here, the metadata related to the point cloud video may be received from the metadata processor. The metadata processor may be included in the point cloud video encoder 10002 or may be configured as a separate component/module. The file/segment encapsulation module 10003 may encapsulate the data in a file format such as ISOBMFF or process the same in the form of a DASH segment or the like. According to an embodiment, the file/segment encapsulation module 10003 may include the point cloud video-related metadata in the file format. The point cloud video related metadata may be included, for example, in boxes at various levels on the ISOBMFF file format or as data in a separate track within the file. According to an embodiment, the file/segment encapsulation module 10003 may encapsulate the point cloud video-related metadata into a file. The transmission processor may perform processing for transmission on the point cloud video data encapsulated according to the file format. The transmission processor may be included in the transmitter 10004 or may be configured as a separate component/module. The transmission processor may process the point cloud video data according to a transmission protocol. The processing for transmission may include processing for delivery over a broadcast network and processing for delivery through a broadband. According to an embodiment, the transmission processor may receive point cloud video-related metadata from the metadata processor with the point cloud video data, and perform processing of the point cloud video data for transmission.

The transmitter 10004 may transmit the encoded video/image information or data that is output in the form of a bitstream to the receiver 10006 of the reception device through a digital storage medium or a network in the form of a file or streaming. The digital storage medium may include various storage media such as USB, SD, CD, DVD, Blu-ray, HDD, and SSD. The transmitter may include an element for generating a media file in a predetermined file format, and may include an element for transmission over a broadcast/communication network. The receiver may extract the bitstream and transmit the extracted bitstream to the decoding device.

The receiver 10006 may receive point cloud video data transmitted by the point cloud video transmission device according to the present disclosure. Depending on the transmission channel, the receiver may receive the point cloud video data over a broadcast network or through a broadband. Alternatively, the point cloud video data may be received through a digital storage medium.

The reception processor may process the received point cloud video data according to the transmission protocol. The reception processor may be included in the receiver 10006 or may be configured as a separate component/module. The reception processor may reversely perform the above-described process of the transmission processor such that the processing corresponds to the processing for transmission performed at the transmission side. The reception processor may deliver the acquired point cloud video data to the file/segment decapsulation module 10007, and the acquired point cloud video-related metadata to the metadata processor (not shown). The point cloud video-related metadata acquired by the reception processor may take the form of a signaling table.

The file/segment decapsulation module 10007 may decapsulate the point cloud video data received in the form of a file from the reception processor. The file/segment decapsulation module 10007 may decapsulate the files according to ISOBMFF or the like, and may acquire a point cloud video bitstream or point cloud video-related metadata (a metadata bitstream). The acquired point cloud video bitstream may be delivered to the point cloud video decoder 10008, and the acquired point cloud video-related metadata (metadata bitstream) may be delivered to the metadata processor (not shown). The point cloud video bitstream may include the metadata (metadata bitstream). The metadata processor may be included in the point cloud video decoder 10008 or may be configured as a separate component/module. The point cloud video-related metadata acquired by the file/segment decapsulation module 10007 may take the form of a box or a track in the file format. The file/segment decapsulation module 10007 may receive metadata necessary for decapsulation from the metadata processor, when necessary. The point cloud video-related metadata may be delivered to the point cloud video decoder 10008 and used in a point cloud video decoding procedure, or may be transferred to the renderer 10009 and used in a point cloud video rendering procedure.

The point cloud video decoder 10008 may receive the bitstream and decode the video/image by performing an operation corresponding to the operation of the point cloud video encoder. In this case, the point cloud video decoder 10008 may decode the point cloud video by dividing the same into a geometry video, an attribute video, an occupancy map video, and auxiliary information as described below. The geometry video may include a geometry image, and the attribute video may include an attribute image. The occupancy map video may include an occupancy map image. The auxiliary information may include auxiliary patch information. The attribute video/image may include a texture video/image.

The 3D geometry may be reconstructed based on the decoded geometry image, the occupancy map, and auxiliary patch information, and then may be subjected to a smoothing process. A color point cloud image/picture may be reconstructed by assigning color values to the smoothed 3D geometry based on the texture image. The renderer 10009 may render the reconstructed geometry and the color point cloud image/picture. The rendered video/image may be displayed through a display (not shown). The user may view all or part of the rendered result through a VR/AR display or a typical display.

The feedback process may include transferring various kinds of feedback information that may be acquired in the rendering/displaying process to the transmission side or to the decoder of the reception side. Interactivity may be provided through the feedback process in consuming point cloud video. According to an embodiment, head orientation information, viewport information indicating a region currently viewed by a user, and the like may be delivered to the transmission side in the feedback process. According to an embodiment, the user may interact with things implemented in the VR/AR/MR/autonomous driving environment. In this case, information related to the interaction may be delivered to the transmission side or a service provider during the feedback process. According to an embodiment, the feedback process may be skipped.

The head orientation information may represent information about the location, angle and motion of a user's head. On the basis of this information, information about a region of the point cloud video currently viewed by the user, that is, viewport information, may be calculated.

The viewport information may be information about a region of the point cloud video currently viewed by the user. Gaze analysis may be performed using the viewport information to check the way the user consumes the point cloud video, a region of the point cloud video at which the user gazes, and how long the user gazes at the region. The gaze analysis may be performed at the reception side and the result of the analysis may be delivered to the transmission side on a feedback channel. A device such as a VR/AR/MR display may extract a viewport region based on the location/direction of the user's head, vertical or horizontal FOV supported by the device, and the like.

According to an embodiment, the aforementioned feedback information may not only be delivered to the transmission side, but also be consumed at the reception side. That is, decoding and rendering processes at the reception side may be performed based on the aforementioned feedback information. For example, only the point cloud video for the region currently viewed by the user may be preferentially decoded and rendered based on the head orientation information and/or the viewport information.

Here, the viewport or viewport region may represent a region of the point cloud video currently viewed by the user. A viewpoint is a point which is viewed by the user in the point cloud video and may represent a center point of the viewport region. That is, a viewport is a region around a viewpoint, and the size and form of the region may be determined by the field of view (FOV).

The present disclosure relates to point cloud video compression as described above. For example, the methods/embodiments disclosed in the present disclosure may be applied to the point cloud compression or point cloud coding (PCC) standard of the moving picture experts group (MPEG) or the next generation video/image coding standard.

As used herein, a picture/frame may generally represent a unit representing one image in a specific time interval.

A pixel or a pel may be the smallest unit constituting one picture (or image). Also, “sample” may be used as a term corresponding to a pixel. A sample may generally represent a pixel or a pixel value, or may represent only a pixel/pixel value of a luma component, only a pixel/pixel value of a chroma component, or only a pixel/pixel value of a depth component.

A unit may represent a basic unit of image processing. The unit may include at least one of a specific region or module of the picture and information related to the region. The unit may be used interchangeably with term such as block or area in some cases. In a general case, an M×N block may include samples (or a sample array) or a set (or array) of transform coefficients configured in M columns and N rows.

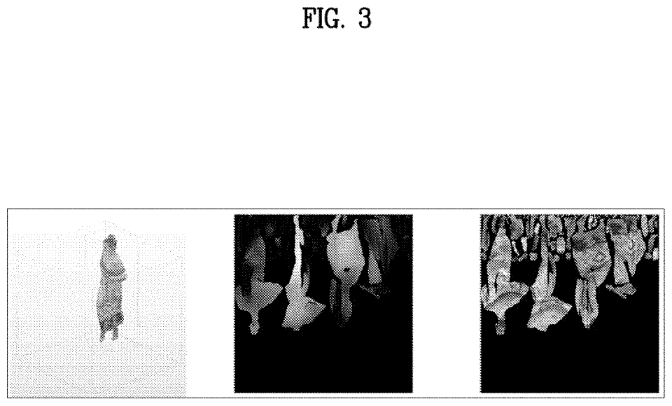

FIG. 3 illustrates an exemplary point cloud, geometry, and texture image according to embodiments.

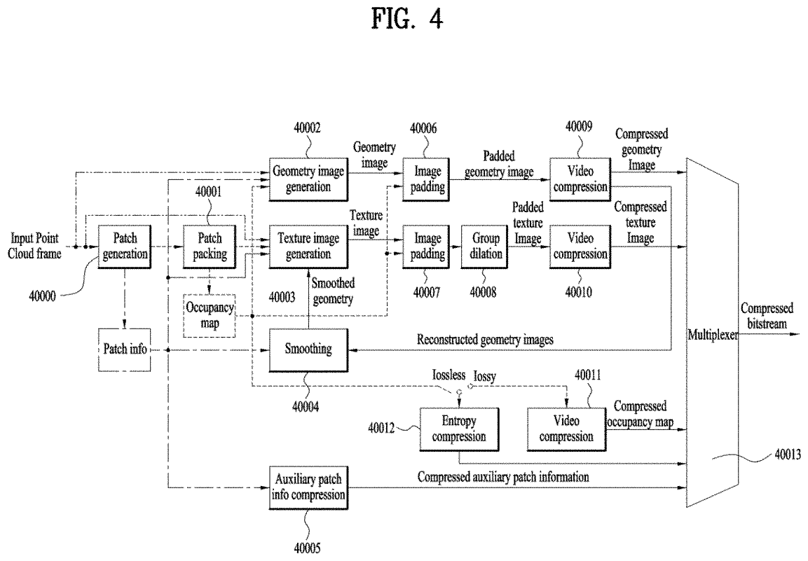

The point cloud according to the embodiments may be input to a V-PCC encoding process of FIG. 4, which will be described later, whereby a geometry image and a texture image may be generated. In accordance with the embodiments, the point cloud may be used to refer to the point cloud data.

A left side in FIG. 3 illustrates s a point cloud that may indicate a point cloud object located on a 3D space by a bounding box. A middle side in FIG. 3 illustrates a geometry image, and a right side in FIG. 3 illustrates a texture (non-padding) image. In this specification, the geometry image may be referred to as a geometry patch frame/picture or geometry frame/picture. The texture image may be referred to as an attribute patch frame/picture or attribute frame/picture.

Video-based point cloud compression (V-PCC) according to embodiments may provide a method of compressing 3D point cloud data based on a 2D video codec such as HEVC (Efficiency Video Coding) or VVC (Versatile Video Coding). Data and information that may be generated in the V-PCC compression process are as follows:

Occupancy map: this is a binary map indicating whether there is data at a corresponding position in a 2D plane, using a value of 0 or 1 in dividing the points constituting a point cloud into patches and mapping the same to the 2D plane.

Patch: is a set of points constituting a point cloud, which indicates that points belonging to the same patch are adjacent to each other in 3D space and are mapped in the same direction among 6-face bounding box planes in the process of mapping to a 2D image.

Geometry image: this is an image in the form of a depth map that presents position information (geometry) about each point constituting a point cloud on a patch-by-patch basis. The geometry image may be composed of pixel values of one channel.

Texture image: this is an image representing the color information about each point constituting a point cloud on a patch-by-patch basis. A texture image may be composed of pixel values of a plurality of channels (e.g., three channels of R, G, and B). The texture is included in an attribute. According to embodiments, a texture and/or attribute may be interpreted as the same object and/or having an inclusive relationship.

Auxiliary patch info (or information): this indicates metadata needed to reconstruct a point cloud with individual patches. Auxiliary patch information may include information about the position, size, and the like of a patch in a 2D/3D space.

The point cloud data according to the embodiments represents PCC data according to video-based point cloud compression (V-PCC). The point cloud data may include a plurality of components. For example, it may include an occupancy map, a patch, a geometry and/or a texture.

FIG. 4 illustrates an example of a point cloud video encoder according to the embodiments.

FIG. 4 illustrates a V-PCC encoding process for generating and compressing an occupancy map, a geometry image, a texture image, and auxiliary patch information. The V-PCC encoding process of FIG. 4 may be processed by the point cloud video encoder 10002 of FIG. 1. Each component of FIG. 4 may be implemented by hardware, software, a processor and/or their combination.

A patch generation unit 40000, a point cloud frame (which may be in the form of a bitstream containing point cloud data) is received. The patch generation unit 40000 generates a patch from the point cloud data. In addition, patch information including information about patch generation is generated.

Patch packing unit 40001 may pack one or more patches. In addition, an occupancy map containing information about patch packing is generated.

Geometry image generation unit 40002 generates a geometry image based on point cloud data, patch information (or auxiliary patch information) and/or occupancy map information. The geometry image means data (that is, 3D coordinate values of points) that include a geometry on point could data, and may be referred to as a geometry frame.

Texture image generation unit 40003 generates a texture image based on point cloud data, patch, packed patch, patch information (or auxiliary patch information) and/or smoothed geometry. The texture image may be referred to as an attribute frame.

Smoother 40004 may reduce or remove an error included in image data. For example, the smoother 40004 perform a smoothing process for reconstructed geometry images based on patch information, that is, smoothly filter a portion where an error between data may be caused, thereby generating a smoothed geometry. The smoothed geometry is output to the texture image generation unit 40003.

In an auxiliary patch info compression unit 40005, auxiliary patch information related to the patch information generated in the patch generation process is compressed. In addition, the auxiliary patch information compressed by the auxiliary patch info compression unit 40005 may be transmitted to the multiplexer 40013. The auxiliary patch information may be used in the geometry image generation unit 40002.

In image padding units 40006 and 40007, the geometry image and the texture image may be padded, respectively. That is, padding data may be padded to a geometry image and a texture image.

In group dilation unit 40008, data may be added to the texture image in a similar manner to image padding.

Video compression units 40009, 40010 and 40011 may respectively compress a padded geometry image, a padded texture image and/or an occupancy map. In other words, the video compression units 40009, 40010 and 40011 may respectively compress the geometry frame, the attribute frame and/or the occupancy map frame, which are input, and may output them as video bitstreams of the geometry, video bitstreams of the texture image, and video bitstreams of the occupancy map. The video compression may encode the geometry information, the texture information, and the occupancy information.

Entropy compression unit 40012 may compress the occupancy map based on an entropy scheme.

In accordance with the embodiments, entropy compression and/or video compression may be performed for the occupancy map frame depending on the case that the point cloud data are lossless and/or lossy.

A multiplexer 40013 multiplexes video bitstreams of the geometry, video bitstreams of the texture image, video bitstreams of the occupancy map, and bitstreams of auxiliary patch information, which are compressed by each compression unit, into one bitstream.

The aforementioned blocks may be omitted, or may be replaced by blocks having similar or same functions. Also, each block shown in FIG. 4 may operate as at least one of processor, software and hardware.

The operations in each process of FIG. 4 are described in detail below.

Patch Generation 40000

The patch generation process refers to a process of dividing a point cloud into patches, which are mapping units, in order to map the point cloud to the 2D image. The patch generation process may be divided into three steps: normal value calculation, segmentation, and patch segmentation.

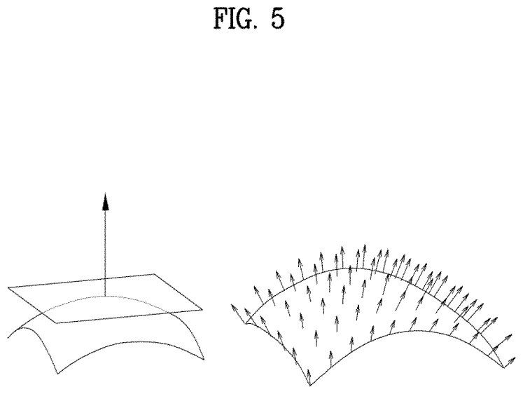

The normal value calculation process will be described in detail with reference to FIG. 5.

FIG. 5 illustrates an example of a tangent plane and a normal vector of a surface according to embodiments.

Normal Calculation Related Patch Generation

Each point of a point cloud has its own direction, which is represented by a 3D vector called a normal vector. Using the neighbors of each point obtained using a K-D tree or the like, a tangent plane and a normal vector of each point constituting the surface of the point cloud as shown in FIG. 5 may be obtained. The search range applied to the process of searching for neighbors may be defined by the user.

The tangent plane refers to a plane that passes through a point on the surface and completely includes a tangent line to the curve on the surface.

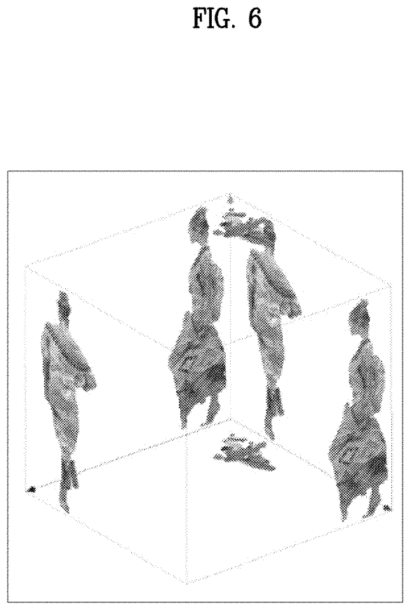

FIG. 6 illustrates an exemplary bounding box of a point cloud according to embodiments.

A method/device according to embodiments, for example, patch generation unit 40000, may employ a bounding box in generating a patch from point cloud data.

The bounding box may be used for a process of projecting a point cloud object for point cloud data on a plane of each hexahedron based on a hexahedron on a 3D space. The bounding box may be generated and processed by the point cloud video acquisition unit 10001 and the point cloud video encoder 10002 of FIG. 1. Also, the patch generation 40000, the patch packing 40001, the geometry image generation 40002 and the texture image generation 40003 of the V-PCC encoding process in FIG. 4 may be performed based on the bounding box.

Patch Generation Related Segmentation

Segmentation includes two processes of initial segmentation and refine segmentation.

The point cloud video encoder 10002 according to the embodiments projects a point on one plane of the bounding box. In detail, each point constituting the point cloud is projected onto one of 6 planes of the bounding box surrounding the point cloud as shown in FIG. 6, and initial segmentation is a process of determining one of planes of the bounding box onto which each point is to be projected.

\vec{n}_{P}_{_{idx}}, which is a normal value corresponding to each of the six planar faces, is defined as follows:

(1.0, 0.0, 0.0), (0.0, 1.0, 0.0), (0.0, 0.0, 1.0), (−1.0, 0.0, 0.0), (0.0, −1.0, 0.0), (0.0, 0.0, −1.0).

As shown in the equation below, a face that yields the maximum value of dot product of the normal vector \vec{n}ₚ_{ᵢ} of each point obtained in the normal value calculation process and \vec{n}ₚ_{_{idx}} is determined as a projection plane of the corresponding point. That is, a plane whose normal vector is most similar to the direction of the normal vector of a point is determined as the projection plane of the point.

$${max}_{{p}_{idx}} \{ {\vec{n}}_{{p}_{i}} {\vec{n}}_{{p}_{idx}} \}$$

The determined plane may be identified by one cluster index, which is one of 0 to 5.

Refine segmentation is a process of enhancing the projection plane of each point constituting the point cloud determined in the initial segmentation process in consideration of the projection planes of neighboring points. In this process, a score normal, which represents the degree of similarity between the normal vector of each point and the normal of each planar face of the bounding box which are considered in determining the projection plane in the initial segmentation process, and score smooth, which indicates the degree of similarity between the projection plane of the current point and the projection planes of neighboring points, may be considered together.

Score smooth may be considered by assigning a weight to the score normal. In this case, the weight value may be defined by the user. The refine segmentation may be performed repeatedly, and the number of repetitions may also be defined by the user.

Patch Segmentation Related Patch Generation

Patch segmentation is a process of dividing the entire point cloud into patches, which are sets of neighboring points, based on the projection plane information about each point constituting the point cloud obtained in the initial/refine segmentation process. The patch segmentation may include the following steps:

1) Calculate neighboring points of each point constituting the point cloud, using the K-D tree or the like. The maximum number of neighbors may be defined by the user;

2) When the neighboring points are projected onto the same plane as the current point (when they have the same cluster index), extract the current point and the neighboring points as one patch;

3) Calculate geometry values of the extracted patch; and

4) Repeat operations 2) to 3) until there is no unextracted point.

The occupancy map, geometry image and texture image for each patch as well as the size of each patch are determined through the patch segmentation process.

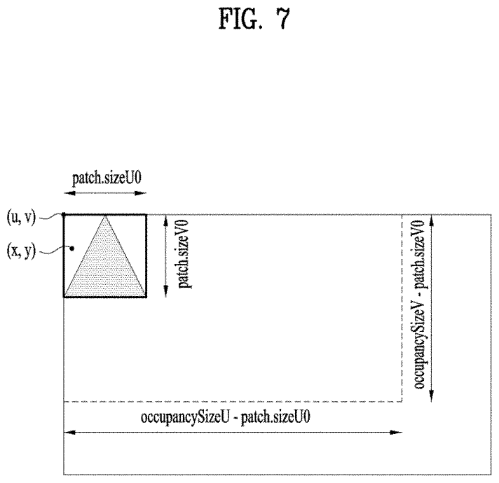

FIG. 7 illustrates an example of determination of individual patch positions on an occupancy map according to embodiments.

Patch Packing & Occupancy Map Generation 40001

This is a process of determining the positions of individual patches in a 2D image to map the segmented patches to the 2D image. The occupancy map, which is a kind of 2D image, is a binary map that indicates whether there is data at a corresponding position, using a value of 0 or 1. The occupancy map is composed of blocks and the resolution thereof may be determined by the size of the block. For example, when the block is 1*1 block, a pixel-level resolution is obtained. The occupancy packing block size may be determined by the user.

The process of determining the positions of individual patches on the occupancy map may be configured as follows:

1) Set all positions on the occupancy map to 0;

2) Place a patch at a point (u, v) having a horizontal coordinate within the range of (0, occupancySizeU-patch.sizeU0) and a vertical coordinate within the range of (0, occupancySizeV-patch.sizeV0) in the occupancy map plane;

3) Set a point (x, y) having a horizontal coordinate within the range of (0, patch.sizeU0) and a vertical coordinate within the range of (0, patch.sizeV0) in the patch plane as a current point;

4) Change the position of point (x, y) in raster order and repeat operations 3) and 4) if the value of coordinate (x, y) on the patch occupancy map is 1 (there is data at the point in the patch) and the value of coordinate (u+x, v+y) on the global occupancy map is 1 (the occupancy map is filled with the previous patch). Otherwise, proceed to operation 6);

5) Change the position of (u, v) in raster order and repeat operations 3) to 5);

6) Determine (u, v) as the position of the patch and copy the occupancy map data about the patch onto the corresponding portion on the global occupancy map; and

7) Repeat operations 2) to 6) for the next patch.

occupancySizeU: indicates the width of the occupancy map. The unit thereof is occupancy packing block size.

occupancy SizeV: indicates the height of the occupancy map. The unit thereof is occupancy packing block size.

patch.sizeU0: indicates the width of the occupancy map. The unit thereof is occupancy packing block size.

patch.sizeV0: indicates the height of the occupancy map. The unit thereof is occupancy packing block size.

For example, as shown in FIG. 7, a box corresponding to a patch having a patch size in a box corresponding to an occupancy packing size block exists, and points (x, y) may be located in the box.

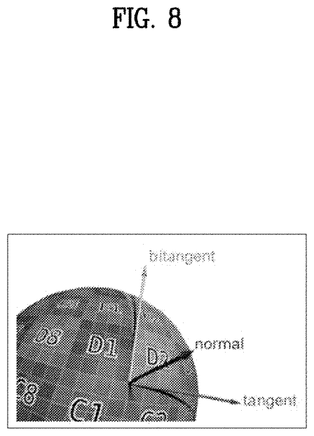

FIG. 8 illustrates an example of a relation of normal, tangent and bitangent axes according to the embodiments.

The point cloud video encoder 1002 according to the embodiments may generate a geometry image. The geometry image means image data including geometry information of the point cloud. The three axes (normal, tangent and bitangent) of the patch in FIG. 8 may be used for the process of generating a geometry image.

Geometry Image Generation 40002

In this process, the depth values constituting the geometry images of individual patches are determined, and the entire geometry image is generated based on the positions of the patches determined in the patch packing process described above. The process of determining the depth values constituting the geometry images of individual patches may be configured as follows.

1) Calculate parameters related to the position and size of an individual patch. The parameters may include the following information. A position of a patch may be included in patch information.

A normal index indicating the normal axis is obtained in the previous patch generation process. The tangent axis is an axis coincident with the horizontal axis u of the patch image among the axes perpendicular to the normal axis, and the bitangent axis is an axis coincident with the vertical axis v of the patch image among the axes perpendicular to the normal axis. The three axes may be expressed as shown in FIG. 8.

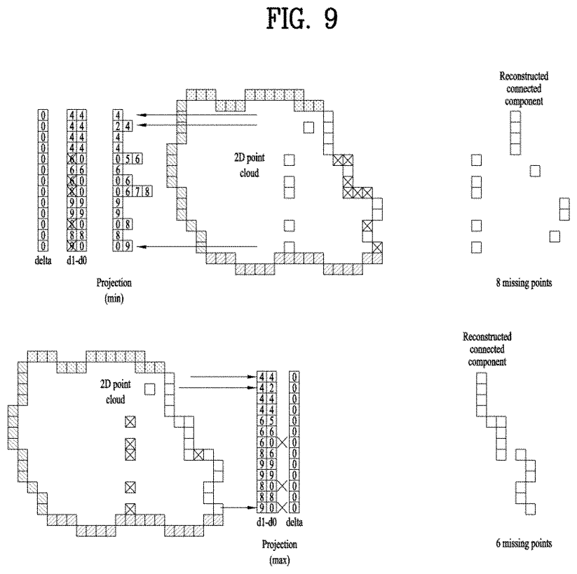

FIG. 9 illustrates an example of a minimum mode and a maximum mode of a projection mode according to the embodiments.

The point cloud video encoder 1002 according to the embodiments may perform projection based on the patch to generate a geometry image. The projection according to the embodiments includes a minimum mode and a maximum mode.

3D spatial coordinates of a patch may be calculated based on the bounding box of the minimum size surrounding the patch. The 3D spatial coordinates may include the minimum tangent value of the patch (on the patch 3d shift tangent axis) of the patch, the minimum bitangent value of the patch (on the patch 3d shift bitangent axis), and the minimum normal value of the patch (on the patch 3d shift normal axis).

2D size of a patch indicates the horizontal and vertical sizes of the patch when the patch is packed into a 2D image. The horizontal size (patch 2d size u) may be obtained as a difference between the maximum and minimum tangent values of the bounding box, and the vertical size (patch 2d size v) may be obtained as a difference between the maximum and minimum bitangent values of the bounding box.

2) Determine a projection mode of the patch. The projection mode may be either the min mode or the max mode. The geometry information about the patch is expressed with a depth value. When each point constituting the patch is projected in the normal direction of the patch, two layers of images, an image constructed with the maximum depth value and an image constructed with the minimum depth value, may be generated.

In generating images d0 and d1 of two layers, as shown in FIG. 9 in case of a min mode, a minimum depth may be configured for d0 and a maximum depth existing within a surface thickness from the minimum depth may be configured for d1.

For example, if the point cloud is located in 2D as shown in FIG. 9, a plurality of patches that include a plurality of points may exist. This indicates that points marked with a shade of a same style may belong to the same patch as shown in FIG. 9. A process of projecting patches of points marked with blank is shown.

If the points marked with blank are projected from side to side, a number for depth calculation of points may be displayed toward a right direction by increasing a depth based on a left side as much as 1 like 0, 1, 2, . . . , 6, 7, 8, 9.

The same projection mode may be applied to all point clouds or different projection modes may be applied to respective frames or patches according to user definition. When different projection modes are applied to the respective frames or patches, a projection mode that may enhance compression efficiency or minimize missed points may be adaptively selected.

3) Calculate the depth values of the individual points.

In the min mode, image d0 is constructed with depth0, which is a value obtained by subtracting the minimum normal value of the patch (on the patch 3d shift normal axis) calculated in operation 1) from the minimum normal value of the patch (on the patch 3d shift normal axis) for the minimum normal value of each point. If there is another depth value within the range between depth0 and the surface thickness at the same position, this value is set to depth1. Otherwise, the value of depth0 is assigned to depth1. Image d1 is constructed with the value of depth1.

For example, in determining a depth of the points of d0, a minimum value may be calculated (4 2 4 4 0 6 0 0 9 9 0 8 0). In determining a depth of the points of d1, a greater value of two or more points may be calculated, or if there is only one point, a value corresponding to the point may be calculated (4 4 4 4 6 6 6 8 9 9 8 8 9). Also, some points may be lost in the middle of the process of encoding and reconstructing the points of the patch (for example, 8 points are lost as shown).

In the max mode, image d0 is constructed with depth0, which is a value obtained by subtracting the minimum normal value of the patch (on the patch 3d shift normal axis) calculated in operation 1) from the minimum normal value of the patch (on the patch 3d shift normal axis) for the maximum normal value of each point. If there is another depth value within the range between depth0 and the surface thickness at the same position, this value is set to depth1. Otherwise, the value of depth0 is assigned to depth1. Image d1 is constructed with the value of depth1.

For example, in determining a depth of the points of d0, a maximum value may be calculated (4 4 4 4 6 6 6 8 9 9 8 8 9). In determining a depth of the points of d1, a smaller value of two or more points may be calculated, or if there is only one point, a value corresponding to the point may be calculated (4 2 4 4 5 6 0 6 9 9 0 8 0). Also, some points may be lost in the middle of the process of encoding and reconstructing the points of the patch (for example, 6 points are lost as shown).

The entire geometry image may be generated by placing the geometry images of the individual patches generated through the above-described processes onto the entire geometry image based on the patch position information determined in the patch packing process.

Layer d1 of the generated entire geometry image may be encoded using various methods. A first method (absolute d1 method) is to encode the depth values of the previously generated image d1. A second method (differential encoding method) is to encode a difference between the depth values of previously generated image d1 and the depth values of image d0.

In the encoding method using the depth values of the two layers, d0 and d1 as described above, if there is another point between the two depths, the geometry information about the point is lost in the encoding process, and therefore an enhanced-delta-depth (EDD) code may be used for lossless coding.

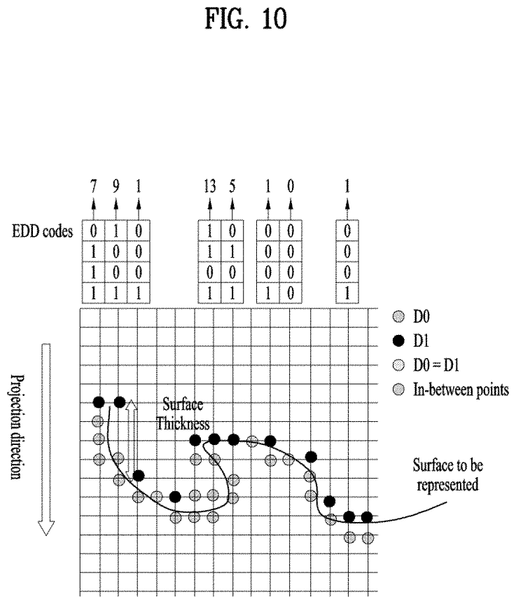

Hereinafter, the EDD code will be described in detail with reference to FIG. 10.

FIG. 10 illustrates an exemplary EDD code according to embodiments.

The point cloud video encoder 10002 and/or a partial/entire process (e.g., video compression 40009) may encode geometry information of points based on an EOD code.

As shown in FIG. 10, the EDD code is used for binary encoding of the positions of all points within the range of surface thickness including d1. For example, in FIG. 10, the points included in the second left column may be represented by an EDD code of 0b1001 (=9) because the points are present at the first and fourth positions over D0 and the second and third positions are empty. When the EDD code is encoded together with D0 and transmitted, a reception terminal may restore the geometry information about all points without loss.

For example, when a point over a basic point is present, the EDD code is 1 and when a point is not present, the EDD code is 0. Accordingly, a code may be represented based on 4 bits.

Smoothing 40004

Smoothing is a process for eliminating discontinuity that may occur on the patch boundary due to deterioration of the image quality occurring during the compression process. Smoothing may be performed by the point cloud video encoder 10002 or the smoother 40004 through the following operations:

1) Reconstruct the point cloud from the geometry image. This operation may be the reverse of the geometry image generation described above;

2) Calculate neighboring points of each point constituting the reconstructed point cloud using the K-D tree or the like;

3) Determine whether each of the points is positioned on the patch boundary. For example, when there is a neighboring point having a different projection plane (cluster index) from the current point, it may be determined that the point is positioned on the patch boundary;

4) If there is a point present on the patch boundary, move the point to the center of mass of the neighboring points (positioned at the average x, y, z coordinates of the neighboring points). That is, change the geometry value. Otherwise, maintain the previous geometry value.

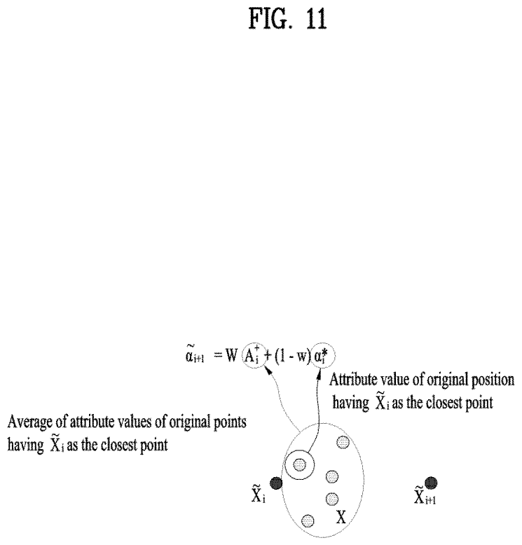

FIG. 11 illustrates an example of recoloring based on color values of neighboring points according to embodiments.

The point cloud video encoder 10002 or the texture image generation unit 40003 according to embodiments may generate a texture image based on re-coloring.

Texture Image Generation 40003

The texture image generation process, which is similar to the geometry image generation process described above, includes generating texture images of individual patches and generating an entire texture image by arranging the texture images at determined positions. However, in the operation of generating texture images of individual patches, an image with color values (e.g., R, G, and B values) of the points constituting a point cloud corresponding to a position is generated in place of the depth values for geometry generation.

In estimating a color value of each point constituting the point cloud, the geometry previously obtained through the smoothing process may be used. In the smoothed point cloud, the positions of some points may have been shifted from the original point cloud, and accordingly a recoloring process of finding colors suitable for the changed positions may be required. Recoloring may be performed using the color values of neighboring points. For example, as shown in FIG. 11, a new color value may be calculated in consideration of the color value of the nearest neighboring point and the color values of the neighboring points.

For example, referring to FIG. 11, an appropriate color value of a changed position may be calculated by recoloring based on an average of attribute information of original points closest to a point and/or an average of attribute information of an original position closest to a point.

The texture image may be generated by two layers of t0/t1 in the same manner as the geometry image generated by two layers of d0/d1.

Auxiliary Patch Info Compression 40005

The point cloud video encoder 10002 or auxiliary patch information compression unit 40005 according to the embodiments may compress auxiliary patch information (auxiliary information on point cloud).

The auxiliary patch information compression unit 40005 compresses auxiliary patch information generated in the patch generation, patch packing, and geometry generation processes described above. The auxiliary patch information may include the following parameters:

Index (cluster index) for identifying the projection plane (normal plane);

3D spatial position of a patch, i.e., the minimum tangent value of the patch (on the patch 3d shift tangent axis), the minimum bitangent value of the patch (on the patch 3d shift bitangent axis), and the minimum normal value of the patch (on the patch 3d shift normal axis);

2D spatial position and size of the patch, i.e., the horizontal size (patch 2d size u), the vertical size (patch 2d size v), the minimum horizontal value (patch 2d shift u), and the minimum vertical value (patch 2d shift u); and

Mapping information about each block and patch, i.e., a candidate index (when patches are disposed in order based on the 2D spatial position and size information about the patches, multiple patches may be mapped to one block in an overlapping manner. In this case, the mapped patches constitute a candidate list, and the candidate index indicates the position in sequential order of a patch whose data is present in the block), and a local patch index (which is an index indicating one of the patches present in the frame). Following Table 1 shows a pseudo code representing the process of matching between blocks and patches based on the candidate list and the local patch indexes.

The maximum number of candidate lists may be defined by a user.

TABLE 1

for( i = 0; i < BlockCount; i++ ) {

if( candidatePatches[ i ].size( ) == 1) {

blockToPatch[ i ] = candidatePatches[ i ][ 0 ]

} else {

candidate_index
if( candidate_index == max_candidate_count ) {

blockToPatch[ i ] = local_patch_index

} else {

blockToPatch[ i ] = candidatePatches[ i ][
candidate_index ]

}

}
}

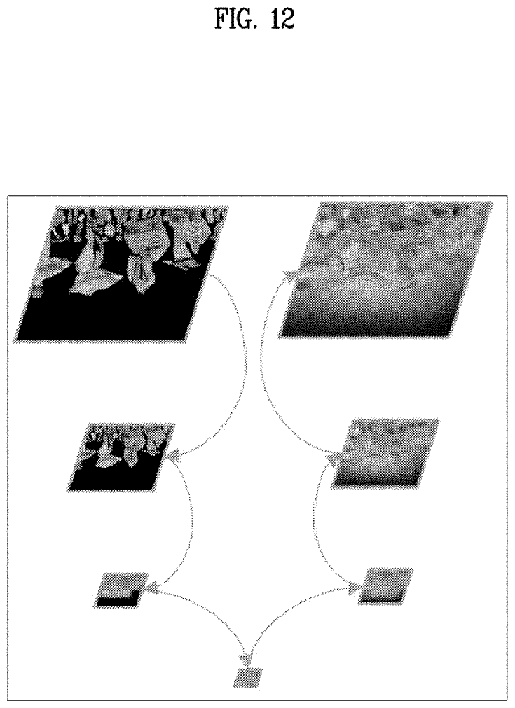

FIG. 12 illustrates push-pull background filling according to embodiments.

Image Padding and Group Dilation 40006, 40007, 40008

The image padder according to the embodiments may fill a space excluding a patch area with meaningless auxiliary data based on a push-pull background filling scheme.

Image padding is a process of filling the space other than the patch region with meaningless data to improve compression efficiency. For image padding, pixel values in columns or rows close to a boundary in the patch may be copied to fill the empty space. Alternatively, as shown in FIG. 12, a push-pull background filling method may be used. According to this method, the empty space is filled with pixel values from a low resolution image in the process of gradually reducing the resolution of a non-padded image and increasing the resolution again.

Group dilation is a process of filling the empty spaces of a geometry image and a texture image configured in two layers, d0/d1 and t0/t1, respectively. In this process, the empty spaces of the two layers calculated through image padding are filled with the average of the values for the same position.

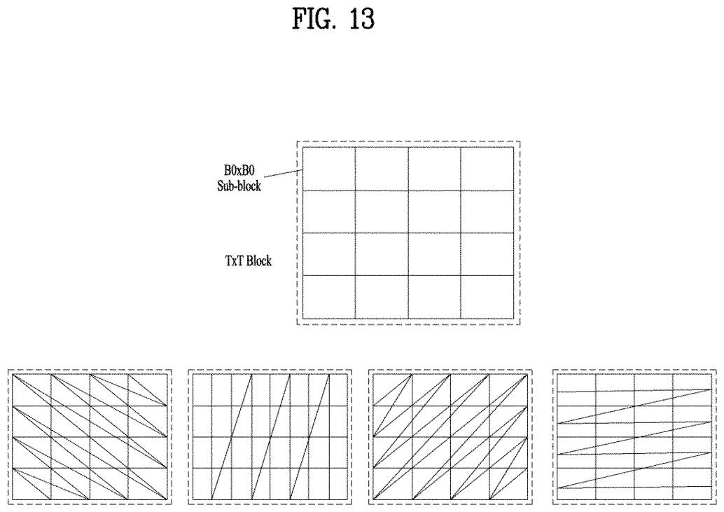

FIG. 13 shows an exemplary possible traversal order for a 4*4 block according to embodiments.

Occupancy Map Compression 40012, 40011

Occupancy map compression is a process of compressing the generated occupancy map and may include two methods: video compression for lossy compression and entropy compression for lossless compression. Video compression is described below.

The entropy compression may be performed through the following operations.

1) If a block constituting an occupancy map is fully occupied, encode 1 and repeat the same operation for the next block of the occupancy map. Otherwise, encode 0 and perform operations 2) to 5).

2) Determine the best traversal order to perform run-length coding on the occupied pixels of the block. FIG. 13 shows four possible traversal orders for a 4*4 block.

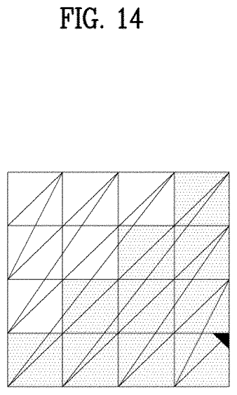

FIG. 14 illustrates an exemplary best traversal order according to embodiments.

The entropy compression unit 40012 according to embodiments may code (or encode) a block based on a traversal order method as shown in FIG. 14.

For example, the best traversal order with the minimum number of runs is selected from among the possible traversal orders and the index thereof is encoded. FIG. 14 illustrates a case where the third traversal order in FIG. 13 is selected. In the illustrated case, the number of runs may be minimized to 2, and therefore the third traversal order may be selected as the best traversal order.

3) Encode the number of runs. In the example of FIG. 14, there are two runs, and therefore 2 is encoded.

4) Encode the occupancy of the first run. In the example of FIG. 14, 0 is encoded because the first run corresponds to unoccupied pixels.

5) Encode lengths of the individual runs (as many as the number of runs). In the example of FIG. 14, the lengths of the first run and the second run, 6 and 10, are sequentially encoded.

Video Compression 40009, 40010, 40011

The video compression units 40009, 40010, 40011 may encode a sequence of a geometry image, a texture image, an occupancy map image, and the like generated in the above-described operations using a 2D video codec such as HEVC or VVC.

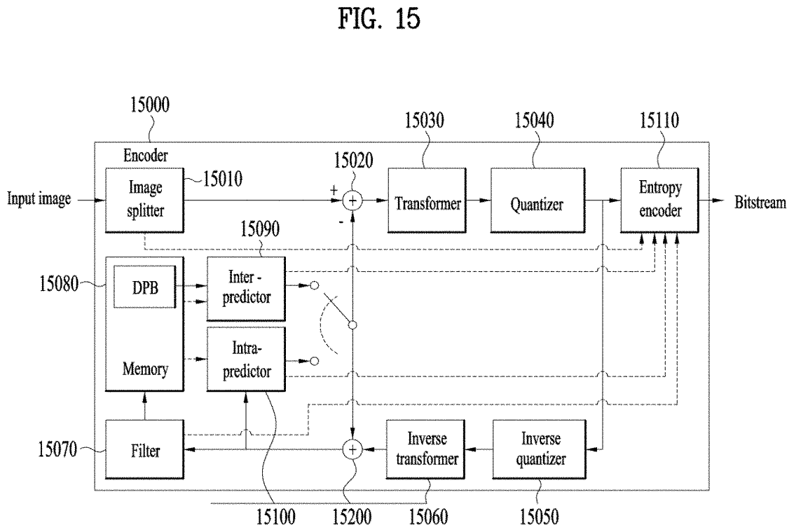

FIG. 15 illustrates an exemplary 2D video/image encoder according to embodiments and the 2D video/image encoder may be referred to as an encoding apparatus.

FIG. 15, which represents an embodiment to which video compression units 40009, 40010, and 40011 described above is applied, is a schematic block diagram of a 2D video/image encoder 15000 configured to encode a video/image signal. The 2D video/image encoder 15000 may be included in the point cloud video encoder 10002 described above or may be configured as an internal/external component. Each component of FIG. 15 may be implemented by hardware, software, a processor and/or their combination.

In this case, the input image may be one of the aforementioned geometry image, texture image (attribute(s) image), and occupancy map image. If the 2D video/image encoder of FIG. 15 is applied to the video compression module 40009, an image input to the 2D video/image encoder 15000 is a padded geometry image, and bitstreams output from the 2D video/image encoder 15000 are bitstreams of the compressed geometry image. If the 2D video/image encoder of FIG. 15 is applied to the video compression module 40010, an image input to the 2D video/image encoder 15000 is a padded texture image, and bitstreams output from the 2D video/image encoder 15000 are bitstreams of the compressed texture image. If the 2D video/image encoder of FIG. 15 is applied to the video compression module 40011, an image input to the 2D video/image encoder 15000 is an occupancy map image, and bitstreams output from the 2D video/image encoder 15000 are bitstreams of the compressed occupancy map image.

An inter-predictor 15090 and an intra-predictor 15100 may be collectively called a predictor. That is, the predictor may include the inter-predictor 15090 and the intra-predictor 15100. A transformer 15030, a quantizer 15040, an inverse quantizer 15050, and an inverse transformer 15060 may be collectively called a residual processor. The residual processor may further include a subtractor 15020. According to an embodiment, the image splitter 15010, the subtractor 15020, the transformer 15030, the quantizer 15040, the inverse quantizer 15050, the inverse transformer 15060, the adder 15200, the filter 15070, the inter-predictor 15090, the intra-predictor 15100, and the entropy encoder 15110 of FIG. 15 may be configured by one hardware component (e.g., an encoder or a processor). In addition, the memory 15080 may include a decoded picture buffer (DPB) and may be configured by a digital storage medium.

The image splitter 15010 may spit an image (or a picture or a frame) input to the encoder 15000 into one or more processing units. For example, the processing unit may be called a coding unit (CU). In this case, the CU may be recursively split from a coding tree unit (CTU) or a largest coding unit (LCU) according to a quad-tree binary-tree (QTBT) structure. For example, one CU may be split into a plurality of CUs of a lower depth based on a quad-tree structure and/or a binary-tree structure. In this case, for example, the quad-tree structure may be applied first and the binary-tree structure may be applied later. Alternatively, the binary-tree structure may be applied first. The coding procedure according to the present disclosure may be performed based on a final CU that is not split anymore. In this case, the LCU may be used as the final CU based on coding efficiency according to characteristics of the image. When necessary, a CU may be recursively split into CUs of a lower depth, and a CU of the optimum size may be used as the final CU. Here, the coding procedure may include prediction, transformation, and reconstruction, which will be described later. As another example, the processing unit may further include a prediction unit (PU) or a transform unit (TU). In this case, the PU and the TU may be split or partitioned from the aforementioned final CU. The PU may be a unit of sample prediction, and the TU may be a unit for deriving a transform coefficient and/or a unit for deriving a residual signal from the transform coefficient.

The term “unit” may be used interchangeably with terms such as block or area or module. In a general case, an M×N block may represent a set of samples or transform coefficients configured in M columns and N rows. A sample may generally represent a pixel or a value of a pixel, and may indicate only a pixel/pixel value of a luma component, or only a pixel/pixel value of a chroma component. “Sample” may be used as a term corresponding to a pixel or a pel in one picture (or image).

The subtractor 15020 of the encoder 15000 may generate a residual signal (residual block or residual sample array) by subtracting a prediction signal (predicted block or predicted sample array) output from the inter-predictor 15090 or the intra-predictor 15100 from an input image signal (original block or original sample array), and the generated residual signal is transmitted to the transformer 15030. The predictor may perform prediction for a processing target block (hereinafter referred to as a current block) and generate a predicted block including prediction samples for the current block. The predictor may determine whether intra-prediction or inter-prediction is applied on a current block or CU basis. As will described later in the description of each prediction mode, the predictor may generate various kinds of information about prediction, such as prediction mode information, and deliver the generated information to the entropy encoder 15110. The information about the prediction may be encoded and output in the form of a bitstream by the entropy encoder 15110.

The intra-predictor 15100 of the predictor may predict the current block with reference to the samples in the current picture. The samples may be positioned in the neighbor of or away from the current block depending on the prediction mode. In intra-prediction, the prediction modes may include a plurality of non-directional modes and a plurality of directional modes. The non-directional modes may include, for example, a DC mode and a planar mode. The directional modes may include, for example, 33 directional prediction modes or 65 directional prediction modes according to fineness of the prediction directions. However, this is merely an example, and more or fewer directional prediction modes may be used depending on the setting. The intra-predictor 15100 may determine a prediction mode to be applied to the current block, based on the prediction mode applied to the neighboring block.

The inter-predictor 15090 of the predictor may derive a predicted block for the current block based on a reference block (reference sample array) specified by a motion vector on the reference picture. In this case, in order to reduce the amount of motion information transmitted in the inter-prediction mode, the motion information may be predicted on a per block, subblock, or sample basis based on the correlation in motion information between the neighboring blocks and the current block. The motion information may include a motion vector and a reference picture index. The motion information may further include information about an inter-prediction direction (L0 prediction, L1 prediction, Bi prediction, etc.). In the case of inter-prediction, the neighboring blocks may include a spatial neighboring block, which is present in the current picture, and a temporal neighboring block, which is present in the reference picture. The reference picture including the reference block may be the same as or different from the reference picture including the temporal neighboring block. The temporal neighboring block may be referred to as a collocated reference block or a collocated CU (colCU), and the reference picture including the temporal neighboring block may be referred to as a collocated picture (colPic). For example, the inter-predictor 15090 may configure a motion information candidate list based on the neighboring blocks and generate information indicating a candidate to be used to derive a motion vector and/or a reference picture index of the current block. Inter-prediction may be performed based on various prediction modes. For example, in a skip mode and a merge mode, the inter-predictor 15090 may use motion information about a neighboring block as motion information about the current block. In the skip mode, unlike the merge mode, the residual signal may not be transmitted. In a motion vector prediction (MVP) mode, the motion vector of a neighboring block may be used as a motion vector predictor and the motion vector difference may be signaled to indicate the motion vector of the current block.

The prediction signal generated by the inter-predictor 15090 or the intra-predictor 15100 may be used to generate a reconstruction signal or to generate a residual signal.

The transformer 15030 may generate transform coefficients by applying a transformation technique to the residual signal. For example, the transformation technique may include at least one of discrete cosine transform (DCT), discrete sine transform (DST), Karhunen-Loève transform (KLT), graph-based transform (GBT), or conditionally non-linear transform (CNT). Here, the GBT refers to transformation obtained from a graph depicting the relationship between pixels. The CNT refers to transformation obtained based on a prediction signal generated based on all previously reconstructed pixels. In addition, the transformation operation may be applied to pixel blocks having the same size of a square, or may be applied to blocks of a variable size other than the square.

The quantizer 15040 may quantize the transform coefficients and transmit the same to the entropy encoder 15110. The entropy encoder 15110 may encode the quantized signal (information about the quantized transform coefficients) and output a bitstream of the encoded signal. The information about the quantized transform coefficients may be referred to as residual information. The quantizer 15040 may rearrange the quantized transform coefficients, which are in a block form, in the form of a one-dimensional vector based on a coefficient scan order, and generate information about the quantized transform coefficients based on the quantized transform coefficients in the form of the one-dimensional vector.

The entropy encoder 15110 may employ various encoding techniques such as, for example, exponential Golomb, context-adaptive variable length coding (CAVLC), and context-adaptive binary arithmetic coding (CABAC). The entropy encoder 15110 may encode information necessary for video/image reconstruction (e.g., values of syntax elements) together with or separately from the quantized transform coefficients. The encoded information (e.g., encoded video/image information) may be transmitted or stored in the form of a bitstream on a network abstraction layer (NAL) unit basis.

The bitstream may be transmitted over a network or may be stored in a digital storage medium. Here, the network may include a broadcast network and/or a communication network, and the digital storage medium may include various storage media such as USB, SD, CD, DVD, Blu-ray, HDD, and SSD. A transmitter (not shown) to transmit the signal output from the entropy encoder 15110 and/or a storage (not shown) to store the signal may be configured as internal/external elements of the encoder 15000. Alternatively, the transmitter may be included in the entropy encoder 15110.

The quantized transform coefficients output from the quantizer 15040 may be used to generate a prediction signal. For example, inverse quantization and inverse transform may be applied to the quantized transform coefficients through the inverse quantizer 15050 and the inverse transformer 15060 to reconstruct the residual signal (residual block or residual samples). The adder 15200 may add the reconstructed residual signal to the prediction signal output from the inter-predictor 15090 or the intra-predictor 15100. Thereby, a reconstructed signal (reconstructed picture, reconstructed block, reconstructed sample array) may be generated. When there is no residual signal for a processing target block as in the case where the skip mode is applied, the predicted block may be used as the reconstructed block. The adder 15200 may be called a reconstructor or a reconstructed block generator. The generated reconstructed signal may be used for intra-prediction of the next processing target block in the current picture, or may be used for inter-prediction of the next picture through filtering as described below.

The filter 15070 may improve subjective/objective image quality by applying filtering to the reconstructed signal output from the adder 15200. For example, the filter 15070 may generate a modified reconstructed picture by applying various filtering techniques to the reconstructed picture, and the modified reconstructed picture may be stored in the memory 15080, specifically, the DPB of the memory 15080. The various filtering techniques may include, for example, deblocking filtering, sample adaptive offset, adaptive loop filtering, and bilateral filtering. As described below in the description of the filtering techniques, the filter 15070 may generate various kinds of information about filtering and deliver the generated information to the entropy encoder 15110. The information about filtering may be encoded and output in the form of a bitstream by the entropy encoder 15110.

The modified reconstructed picture stored in the memory 15080 may be used as a reference picture by the inter-predictor 15090. Thus, when inter-prediction is applied, the encoder may avoid prediction mismatch between the encoder 15000 and the decoder and improve encoding efficiency.

The DPB of the memory 15080 may store the modified reconstructed picture so as to be used as a reference picture by the inter-predictor 15090. The memory 15080 may store the motion information about a block from which the motion information in the current picture is derived (or encoded) and/or the motion information about the blocks in a picture that has already been reconstructed. The stored motion information may be delivered to the inter-predictor 15090 so as to be used as motion information about a spatial neighboring block or motion information about a temporal neighboring block. The memory 15080 may store the reconstructed samples of the reconstructed blocks in the current picture and deliver the reconstructed samples to the intra-predictor 15100.

At least one of the prediction, transform, and quantization procedures described above may be skipped. For example, for a block to which the pulse coding mode (PCM) is applied, the prediction, transform, and quantization procedures may be skipped, and the value of the original sample may be encoded and output in the form of a bitstream.

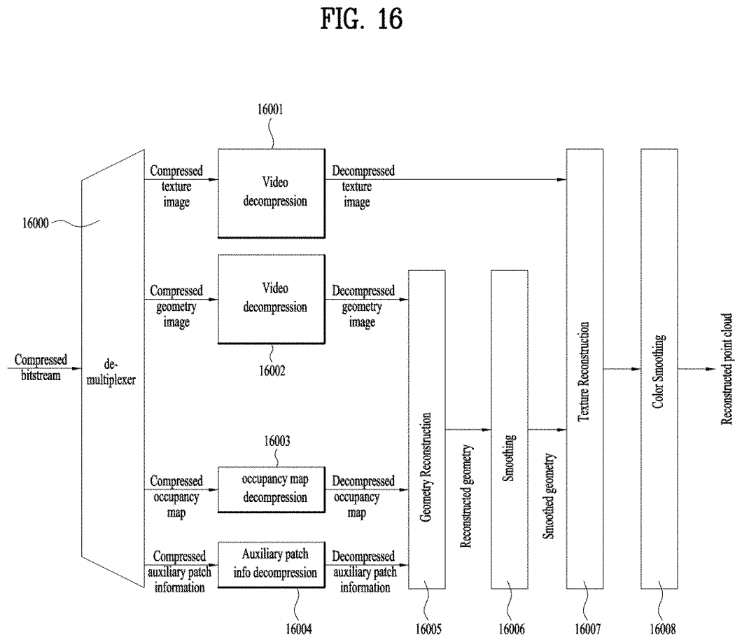

FIG. 16 illustrates an exemplary V-PCC decoding process according to embodiments.

The V-PCC decoding process or V-PCC decoder may perform an inverse process of the V-PCC encoding process (or encoder) of FIG. 4. Each component of FIG. 16 may be implemented by hardware, software, a processor and/or their combination.

A demultiplexer 16000 demultiplexes the compressed bitstream to output a compressed texture image, a compressed geometry image, a compressed occupancy map, and a compressed auxiliary patch information.

A video decompression units 16001, 16002 decompress the compressed texture image and the compressed geometry image, respectively.

An occupancy map decompression unit 16003 decompresses the compressed occupancy map.

An auxiliary patch info decompression unit 16004 decompresses the auxiliary patch information.

A geometry reconstruction unit 16005 restores (or reconstructs) geometry information based on the decompressed geometry image, the decompressed occupancy map, and/or the decompressed auxiliary patch information. For example, the geometry changed in the encoding process may be reconstructed.

A smoother 16006 may apply a smoothing operation to the reconstructed geometry. For example, smoothing filtering may be applied.

A texture reconstruction unit 16007 reconstructs a texture from the decompressed texture image and/or the smoothed geometry.

A color smoothing unit 16008 smooths color values from the reconstructed texture. For example, smoothing filtering may be applied.

As a result, reconstructed point cloud data may be generated.

FIG. 16 illustrates a V-PCC decoding process for reconstructing a point cloud by decompressing (or decoding) the compressed occupancy map, geometry image, texture image and auxiliary path information.

Each unit described in FIG. 16 may operate as at least one of processor, software and hardware.

Video Decompression 16001 and 16002

This process is a decoding process of performing a reverse process of video compression for the bitstreams of the compressed geometry image, the bitstreams of the compressed texture image and/or the bitstreams of the compressed occupancy map image.

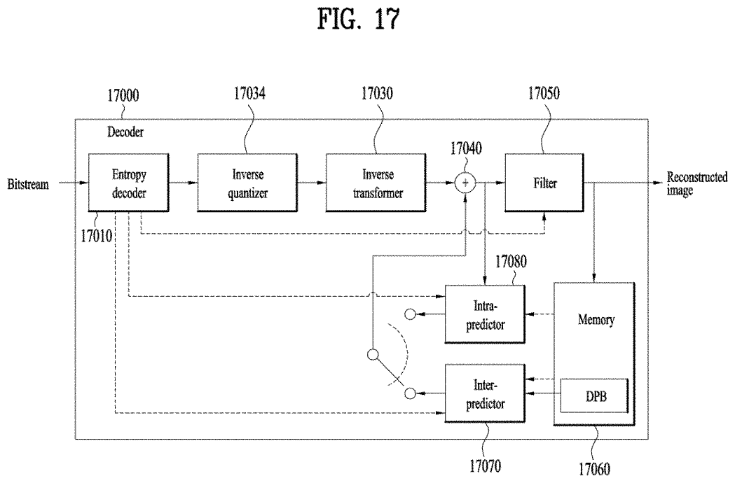

FIG. 17 illustrates an example of a 2D video/image decoder according to the embodiments, wherein the 2D video/image decoder is also referred to as a decoding device.

The 2D video/image decoder may follow a reverse process of the 2D video/image encoder of FIG. 15.

The 2D video/image decoder of FIG. 17 is an example of the video decompression units 16001 and 16002 of FIG. 16, and FIG. 17 illustrates a brief block view of a 2D video/image decoder 17000 for performing decoding of video/image signals. The 2D video/image decoder 17000 may be included in the aforementioned point cloud video decoder 10008, or may be configured as internal/external component. In this case, input bitstreams may be one of the bitstreams of the geometry, the bitstreams of the texture image (attribute(s) image), and the bitstreams of the occupancy map image. If the 2D video/image decoder of FIG. 17 is applied to the video decompression unit 16001, the bitstreams input to the 2D video/image decoder are the bitstreams of the compressed texture image, and a reconstructed image output from the 2D video/image decoder is the decompressed texture image. If the 2D video/image decoder of FIG. 17 is applied to the video decompression unit 16002, the bitstreams input to the 2D video/image decoder are the bitstreams of the compressed geometry image, and a reconstructed image output from the 2D video/image decoder is the decompressed geometry image. The 2D video/image decoder of FIG. 17 may perform decompression by receiving the bitstreams of the compressed occupancy map image.

Referring to FIG. 17, an inter-predictor 17070 and an intra-predictor 17080 may be collectively referred to as a predictor. That is, the predictor may include the inter-predictor 17070 and the intra-predictor 17080. An inverse quantizer 17020 and an inverse transformer 17030 may be collectively referred to as a residual processor. That is, the residual processor may include the inverse quantizer 17020 and the inverse transformer 17030. The entropy decoder 17010, the inverse quantizer 17020, the inverse transformer 17030, the adder 17040, the filter 17050, the inter-predictor 17070, and the intra-predictor 17080 described above may be configured by one hardware component (e.g., a decoder or a processor) according to an embodiment. In addition, the memory 17060 may include a decoded picture buffer (DPB) or may be configured by a digital storage medium.

When a bitstream containing video/image information is input, the decoder 17000 may reconstruct an image in a process corresponding to the process in which the video/image information is processed by the encoder of FIG. 15. For example, the decoder 17000 may perform decoding using a processing unit applied in the encoder. Thus, the processing unit of decoding may be, for example, a CU. The CU may be split from a CTU or an LCU along a quad-tree structure and/or a binary-tree structure. Then, the reconstructed video signal decoded and output through the decoder 17000 may be played through a player.

The decoder 17000 may receive a signal output from the encoder in the form of a bitstream, and the received signal may be decoded through the entropy decoder 17010. For example, the entropy decoder 17010 may parse the bitstream to derive information (e.g., video/image information) necessary for image reconstruction (or picture reconstruction). For example, the entropy decoder 17010 may decode the information in the bitstream based on a coding technique such as exponential Golomb coding, CAVLC, or CABAC, output values of syntax elements required for image reconstruction, and quantized values of transform coefficients for the residual. More specifically, in the CABAC entropy decoding, a bin corresponding to each syntax element in the bitstream may be received, and a context model may be determined based on decoding target syntax element information and decoding information about neighboring and decoding target blocks or information about a symbol/bin decoded in a previous step. Then, the probability of occurrence of a bin may be predicted according to the determined context model, and arithmetic decoding of the bin may be performed to generate a symbol corresponding to the value of each syntax element. According to the CABAC entropy decoding, after a context model is determined, the context model may be updated based on the information about the symbol/bin decoded for the context model of the next symbol/bin. Information about the prediction in the information decoded by the entropy decoder 17010 may be provided to the predictors (the inter-predictor 17070 and the intra-predictor 17080), and the residual values on which entropy decoding has been performed by the entropy decoder 17010, that is, the quantized transform coefficients and related parameter information, may be input to the inverse quantizer 17020. In addition, information about filtering of the information decoded by the entropy decoder 17010 may be provided to the filter 17050. A receiver (not shown) configured to receive a signal output from the encoder may be further configured as an internal/external element of the decoder 17000. Alternatively, the receiver may be a component of the entropy decoder 17010.

The inverse quantizer 17020 may output transform coefficients by inversely quantizing the quantized transform coefficients. The inverse quantizer 17020 may rearrange the quantized transform coefficients in the form of a two-dimensional block. In this case, the rearrangement may be performed based on the coefficient scan order implemented by the encoder. The inverse quantizer 17020 may perform inverse quantization on the quantized transform coefficients using a quantization parameter (e.g., quantization step size information), and acquire transform coefficients.

The inverse transformer 17030 acquires a residual signal (residual block and residual sample array) by inversely transforming the transform coefficients.

The predictor may perform prediction on the current block and generate a predicted block including prediction samples for the current block. The predictor may determine whether intra-prediction or inter-prediction is to be applied to the current block based on the information about the prediction output from the entropy decoder 17010, and may determine a specific intra-/inter-prediction mode.

The intra-predictor 17080 of the predictor may predict the current block with reference to the samples in the current picture. The samples may be positioned in the neighbor of or away from the current block depending on the prediction mode. In intra-prediction, the prediction modes may include a plurality of non-directional modes and a plurality of directional modes. The intra-predictor 17080 may determine a prediction mode to be applied to the current block, using the prediction mode applied to the neighboring block.

The inter-predictor 17070 of the predictor may derive a predicted block for the current block based on a reference block (reference sample array) specified by a motion vector on the reference picture. In this case, in order to reduce the amount of motion information transmitted in the inter-prediction mode, the motion information may be predicted on a per block, subblock, or sample basis based on the correlation in motion information between the neighboring blocks and the current block. The motion information may include a motion vector and a reference picture index. The motion information may further include information about an inter-prediction direction (L0 prediction, L1 prediction, Bi prediction, etc.). In the case of inter-prediction, the neighboring blocks may include a spatial neighboring block, which is present in the current picture, and a temporal neighboring block, which is present in the reference picture. For example, the inter-predictor 17070 may configure a motion information candidate list based on neighboring blocks and derive a motion vector of the current block and/or a reference picture index based on the received candidate selection information. Inter-prediction may be performed based on various prediction modes. The information about the prediction may include information indicating an inter-prediction mode for the current block.

The adder 17040 may add the acquired residual signal to the prediction signal (predicted block or prediction sample array) output from the inter-predictor 17070 or the intra-predictor 17080, thereby generating a reconstructed signal (a reconstructed picture, a reconstructed block, or a reconstructed sample array). When there is no residual signal for a processing target block as in the case where the skip mode is applied, the predicted block may be used as the reconstructed block.

The adder 17040 may be called a reconstructor or a reconstructed block generator. The generated reconstructed signal may be used for intra-prediction of the next processing target block in the current picture, or may be used for inter-prediction of the next picture through filtering as described below.

The filter 17050 may improve subjective/objective image quality by applying filtering to the reconstructed signal output from the adder 17040. For example, the filter 17050 may generate a modified reconstructed picture by applying various filtering techniques to the reconstructed picture, and may transmit the modified reconstructed picture to the memory 17060, specifically, the DPB of the memory 17060. The various filtering techniques may include, for example, deblocking filtering, sample adaptive offset, adaptive loop filtering, and bilateral filtering.

The reconstructed picture stored in the DPB of the memory 17060 may be used as a reference picture in the inter-predictor 17070. The memory 17060 may store the motion information about a block from which the motion information is derived (or decoded) in the current picture and/or the motion information about the blocks in a picture that has already been reconstructed. The stored motion information may be delivered to the inter-predictor 17070 so as to be used as the motion information about a spatial neighboring block or the motion information about a temporal neighboring block. The memory 17060 may store the reconstructed samples of the reconstructed blocks in the current picture, and deliver the reconstructed samples to the intra-predictor 17080.

In the present disclosure, the embodiments described regarding the filter 15070, the inter-predictor 15090, and the intra-predictor 15100 of the encoder 15000 may be applied to the filter 17050, the inter-predictor 17070 and the intra-predictor 17080 of the decoder 17000, respectively, in the same or corresponding manner.

At least one of the prediction, inverse transform, and inverse quantization procedures described above may be skipped. For example, for a block to which the pulse coding mode (PCM) is applied, the prediction, transform, and quantization procedures may be skipped, and the value of a decoded sample may be used as a sample of the reconstructed image.

Occupancy Map Decompression 16003

This is a reverse process of the occupancy map compression described above. Occupancy map decompression is a process for reconstructing the occupancy map by decompressing the occupancy map bitstream.

Auxiliary Patch Info Decompression 16004

This is a reverse process of the auxiliary patch information compression described above. Auxiliary patch information decompression is a process for reconstructing the auxiliary patch information by decoding the compressed auxiliary patch info bitstream.

Geometry Reconstruction 16005

This is a reverse process of the geometry image generation described above. Initially, a patch is extracted from the geometry image using the reconstructed occupancy map, the 2D position/size information about the patch included in the auxiliary patch information, and the information about mapping between a block and the patch. Then, a point cloud is reconstructed in a 3D space based on the geometry image of the extracted patch and the 3D position information about the patch included in the auxiliary patch information. When the geometry value corresponding to a point (u, v) within the patch is g(u, v), and the coordinates of the position of the patch on the normal, tangent and bitangent axes of the 3D space are (δ0, s0, r0), δ(u, v), s(u, v), and r(u, v), which are the normal, tangent, and bitangent coordinates in the 3D space of a position mapped to point (u, v) may be expressed as follows:

δ(u,v)=δ0+g(u,v)

s(u,v)=s0+u

r(u,v)=r0+v.

Smoothing 16006

Smoothing, which is the same as the smoothing in the encoding process described above, is a process for eliminating discontinuity that may occur on the patch boundary due to deterioration of the image quality occurring during the compression process.

Texture Reconstruction 16007

Texture reconstruction is a process of reconstructing a color point cloud by assigning color values to each point constituting a smoothed point cloud. It may be performed by assigning color values corresponding to a texture image pixel at the same position as in the geometry image in the 2D space to points of a point of a point cloud corresponding to the same position in the 3D space, based on the mapping information about the geometry image and the point cloud in the geometry reconstruction process described above.

Color Smoothing 16008

Color smoothing is similar to the process of geometry smoothing described above. Color smoothing is a process for eliminating discontinuity that may occur on the patch boundary due to deterioration of the image quality occurring during the compression process. Color smoothing may be performed through the following operations:

1) Calculate neighboring points of each point constituting the reconstructed point cloud using the K-D tree or the like. The neighboring point information calculated in the geometry smoothing process described above may be used.

2) Determine whether each of the points is positioned on the patch boundary. These operations may be performed based on the boundary information calculated in the geometry smoothing process described above.

3) Check the distribution of color values for the neighboring points of the points present on the boundary and determine whether smoothing is to be performed. For example, when the entropy of luminance values is less than or equal to a threshold local entry (there are many similar luminance values), it may be determined that the corresponding portion is not an edge portion, and smoothing may be performed. As a method of smoothing, the color value of the point may be replaced with the average of the color values of the neighboring points.

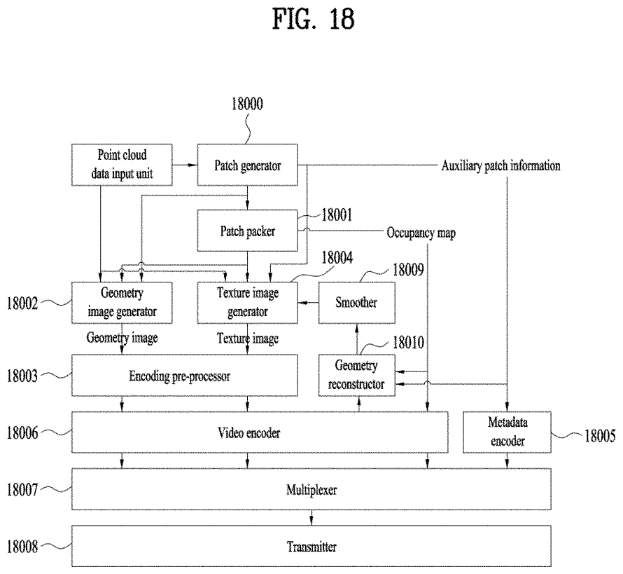

FIG. 18 is a flowchart illustrating operation of a transmission device for compression and transmission of V-PCC based point cloud data according to embodiments of the present disclosure.

Procedure of Operation of the Transmission Terminal

The transmission device according to embodiments may correspond to the transmission device of FIG. 1, the encoding process of FIG. 4, or the 2D image video/image encoder of FIG. 15 or may perform a partial/entire operation thereof. Each component of the transmission device may be implemented by hardware, software, a processor and/or their combination.

An operation process of the transmission device for compression and transmission of point cloud data using V-PCC may be performed as illustrated in the figure.

The point cloud data transmission device according to the embodiments may be referred to as a transmission device or a transmission system.

A patch generator 18000 generates a patch for 2D image mapping of a point cloud. Patch information and/or auxiliary patch information is generated as a result of the patch generation. The generated patch information and/or auxiliary patch information may be used in the processes of geometry image generation, texture image generation, smoothing or geometry reconstruction for smoothing.

A patch packer 18001 performs a patch packing process of mapping the generated patches into the 2D image. For example, one or more patches may be packed. As a result of patch packing, an occupancy map may be generated. The occupancy map may be used in the processes of geometry image generation, geometry image padding, texture image padding, and/or geometry reconstruction for smoothing.

A geometry image generator 18002 generates a geometry image based on point cloud data, patch information (or auxiliary patch information) and/or an occupancy map. The generated geometry image is pre-processed by the encoding pre-processor 18003 and then is encoded into one bitstream by video encoding unit 18006.

The encoding pre-processor 18003 may include an image padding procedure. That is, a partial space of the generated geometry image and the generated texture image may be padded with meaningless data. The encoding pre-processor 18003 may further include a group dilation process for the generated texture image or the texture image with which image padding is performed.

The geometry reconstruction unit 18010 reconstructs a 3D geometry image by using geometry bitstreams encoded by the video encoding unit 18006, auxiliary patch information and/or occupancy map.

A smoother 18009 smooths the 3D geometry image reconstructed by the geometry reconstruction unit 18010 based on the auxiliary patch information and outputs the smoothed image to the texture image generation unit 18004.

The texture image generation unit 18004 may generate a texture image by using the smoothed 3D geometry, point cloud data, patch (or packed patch), patch information (or auxiliary patch information) and/or occupancy map. The generated texture image may be preprocessed by the encoding preprocessor 18003 and then encoded as one video bitstream by the video encoding unit 18006.

A metadata encoding unit 18005 may encode the auxiliary patch information as one metadata bitstream.

A video encoding unit 18006 may encode the geometry image and texture image output from the encoding preprocessor 18003 as their respective video bitstream and encode the occupancy map as one video bitstream. In one embodiment, the video encoding unit 18006 encodes each input image by applying the 2D video/image encoder of FIG. 15 to each input image.

A multiplexer 18007 multiplexes the video bitstream of the geometry, the video bitstream of the texture image and the video bitstream of the occupancy map, which are output from the video encoding unit 18006, and the metadata (including auxiliary patch information) bitstream output from the metadata encoding unit 18005 into one bitstream.

A transmission unit 18008 transmits the bitstream output from the multiplexer 18007 to the receiving end. Alternatively, a file/segment encapsulation module may further be provided between the multiplexer 18007 and the transmission unit 18008, whereby the bitstream output from the multiplexer 18007 may be encapsulated in the form of file and/or segment and output to the transmission unit 18008.

The patch generation unit 18000, the patch packing unit 18001, the geometry image generation unit 18002, the texture image generation unit 18004, the metadata encoding unit 18005 and the smoother 18009 of FIG. 18 may respectively correspond to the patch generation unit 40000, the patch packing unit 40001, the geometry image generation unit 40002, the texture image generation unit 40003, the auxiliary patch information compression unit 40005 and the smoother 40004 of FIG. 4. The encoding preprocessor 18003 of FIG. 18 may include image padding units 40006 and 40007 and the group dilation unit of FIG. 4, and the video encoding unit 18006 of FIG. 18 may include the video compression units 40009, 40010 and 40011 and/or the entropy compression unit 40012. Therefore, a portion which is not described in FIG. 18 may be understood with reference to the description of FIGS. 4 to 15. The aforementioned blocks may be omitted or replaced with blocks having similar or same functions. Also, each block shown in FIG. 18 may operate as at least one of processor, software and hardware.

Operation Process of Reception Device

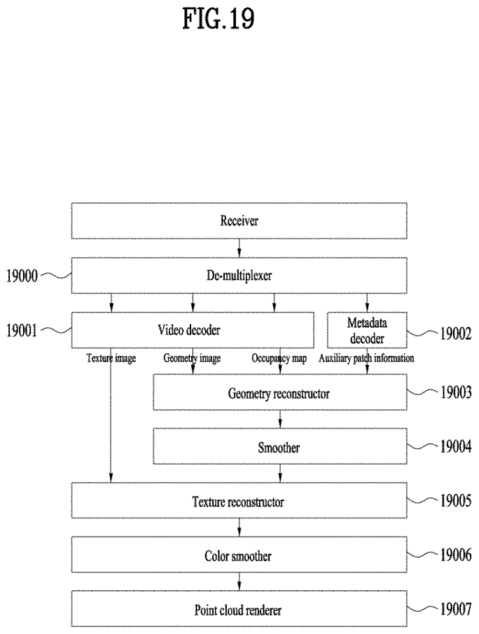

FIG. 19 illustrates an example of an operation flow chart of a reception device for reception and reconstruction of V-PCC based point cloud data according to the embodiments.

The reception device according to the embodiments may correspond to the reception device of FIG. 1, the decoding process of FIG. 16, and the 2D video/image encoder of FIG. 17, or may perform some/all of their operations. Each component of the reception device may correspond to software, hardware, processor and/or their combination.

The operation process of the receiving end for reception and reconstruction of the point cloud data using V-PCC is as shown. The operation of the V-PCC receiving end may follow the reverse process of the operation of the V-PCC transmitting end of FIG. 18.

The point cloud data reception device according to the embodiments may be referred to as a reception device, a reception system, etc.

The reception unit receives bitstreams (that is, compressed bitstreams) of the point cloud, and a demultiplexer 19000 demultiplexes the bitstream of the texture image, the bitstream of the geometry image and the bitstream of the occupancy map image from the received point cloud bitstream, and the bitstream of metadata (that is, auxiliary patch information). The demultiplexed bitstreams of the texture image, the geometry image and the occupancy map image are output to the video decoding unit 19001, and the bitstream of the metadata is output to the metadata decoding unit 19002.

In one embodiment, if the file/segment encapsulation module is provided in the transmission device of FIG. 18, a file/segment decapsulation module is provided between the reception unit and the demultiplexer 19000 of the reception device of FIG. 19. In this case, in one embodiment, the transmission device transmits the point cloud bitstream encapsulated in the form of file and/or segment, and the reception device receives and decapsulates file and/or segment including the point cloud bitstream.

A video decoding unit 19001 respectively decodes the bitstream of the geometry image, the bitstream of the texture image and the bitstream of the occupancy map image as a geometry image, a texture image and an occupancy map image. In one embodiment, the video decoding unit 19001 decodes each input bitstream by applying the 2D video/image decoder of FIG. 17 to each input bitstream. The metadata decoding unit 19002 decodes the bitstream of the metadata as auxiliary patch information and outputs the decoded data to the geometry reconstruction unit 19003.

A geometry reconstruction unit 19003 reconstructs the 3D geometry based on the geometry image, occupancy map and/or auxiliary patch information output from the video decoding unit 19001 and the metadata decoding unit 19002.

A smoother 19004 applies smoothing to the 3D geometry reconstructed by the geometry reconstruction unit 19003.

A texture reconstruction unit 19005 reconstructs a texture by using the texture image output from the video decoding unit 19001 and/or the smoothed 3D geometry. That is, the texture reconstruction unit 19005 reconstructs a color point cloud image/picture by giving a color value to the smoothed 3D geometry by using the texture image. Afterwards, in order to improve objective/subjective visual quality, a color smoother 19006 may additionally perform a color smoothing process for a color point cloud image/picture. As a result, a modified point cloud image/picture is obtained and seen to a user through a rendering process of a point cloud renderer 19007. Meanwhile, the color smoothing process may be omitted as the case may be.

The aforementioned blocks may be omitted, or may be replaced by blocks having similar or same functions. Also, each block shown in FIG. 19 may operate as at least one of processor, software and hardware.

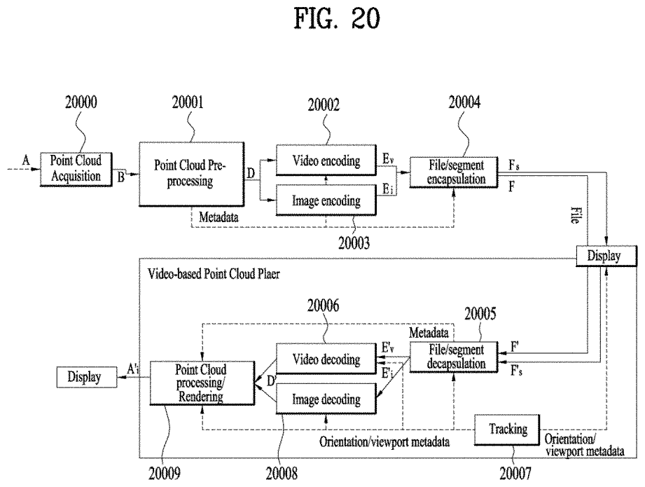

FIG. 20 illustrates an example of an architecture for storing and streaming V-PCC based point cloud data according to the embodiments.

Some/all of the system of FIG. 20 may include some/all of the transmission and reception devices of FIG. 1, the encoding process of FIG. 4, the 2D video/image encoder of FIG. 15, the decoding process of FIG. 16, the transmission device of FIG. 18, and/or the reception device of FIG. 19. Each component in FIG. 20 may correspond to software, hardware, processor and their combination.

FIG. 20 shows the overall architecture for storing or streaming point cloud data compressed based on video-based point cloud compression (hereinafter referred to as V-PCC). The process of storing and streaming the point cloud data may include an acquisition process, an encoding process, a transmission process, a decoding process, a rendering process, and/or a feedback process.

The embodiments propose a method of effectively providing point cloud media/content/data.

In order to effectively provide point cloud media/content/data, a point cloud acquirer 20000 may acquire a point cloud video. For example, one or more cameras may acquire point cloud data through capture, composition or generation of a point cloud. Through this acquisition process, a point cloud video including a 3D position (which may be represented by x, y, and z position values, etc.) (hereinafter referred to as geometry) of each point and attributes (color, reflectance, transparency, etc.) of each point may be acquired. For example, a Polygon File format (PLY) (or Stanford Triangle format) file or the like containing the point cloud video may be generated. For point cloud data having multiple frames, one or more files may be acquired. In this process, point cloud related metadata (e.g., metadata related to capture, etc.) may be generated.

Post-processing for improving the quality of the content may be needed for the captured point cloud video. In the video capture process, the maximum/minimum depth may be adjusted within the range provided by the camera equipment. Even after the adjustment, point data of an unwanted area may still be present. Accordingly, post-processing of removing the unwanted area (e.g., the background) or recognizing a connected space and filling the spatial holes may be performed. In addition, point clouds extracted from the cameras sharing a spatial coordinate system may be integrated into one piece of content through the process of transforming each point into a global coordinate system based on the coordinates of the location of each camera acquired through a calibration process. Thereby, a point cloud video with a high density of points may be acquired.

A point cloud pre-processing unit 20001 may generate a point cloud video as one or multiple pictures/frames. In this case, the picture/frame may mean a unit indicating one image of a specific time zone. Also, the point cloud pre-processing unit 20001 may generate an occupancy map picture/frame which is a binary map indicating the presence of data in a corresponding position of a 2D plane as a value of 0 or 1 when points configuring a point cloud video are mapped into a 2D plane by splitting the points into one or multiple patches. Here, a patch is sets of points that constitute the point cloud video, wherein the points belonging to the same patch are adjacent to each other in the 3D space and are mapped in the same direction among the planar faces of a 6-face bounding box when mapped to a 2D image. In addition, a geometry picture/frame, which is in the form of a depth map that represents the information about the position (geometry) of each point constituting the point cloud video on a patch-by-patch basis, may be generated. A texture picture/frame, which represents the color information about each point constituting the point cloud video on a patch-by-patch basis, may be generated. In this process, metadata needed to reconstruct the point cloud from the individual patches may be generated. The metadata may include information about the patches, such as the position and size of each patch in the 2D/3D space. These pictures/frames may be generated continuously in temporal order to construct a video stream or metadata stream.

A point cloud video encoder 20002 may encode one or more video streams related to a point cloud video. One video may include multiple frames, and one frame may correspond to a still image/picture. In the present disclosure, the point cloud video may include a point cloud image/frame/picture, and the term “point cloud video” may be used interchangeably with the point cloud video/frame/picture. The point cloud video encoder 20002 may perform a video-based point cloud compression (V-PCC) procedure. The point cloud video encoder 20002 may perform a series of procedures such as prediction, transform, quantization, and entropy coding for compression and coding efficiency. The encoded data (encoded video/image information) may be output in the form of a bitstream. Based on the V-PCC procedure, the point cloud video encoder 20002 may encode point cloud video by dividing the same into a geometry video, an attribute video, an occupancy map video, and metadata, for example, information about patches, as described below. The geometry video may include a geometry image, the attribute video may include an attribute image, and the occupancy map video may include an occupancy map image. The patch data, which is auxiliary information, may include patch related information. The attribute video/image may include a texture video/image.

A point cloud image encoder 20003 may encode one or more images related to a point cloud video. The point cloud image encoder 20003 may perform a video-based point cloud compression (V-PCC) procedure. The point cloud image encoder 20003 may perform a series of procedures such as prediction, transform, quantization, and entropy coding for compression and coding efficiency. The encoded image may be output in the form of a bitstream. Based on the V-PCC procedure, the point cloud image encoder 20003 may encode the point cloud image by dividing the same into a geometry image, an attribute image, an occupancy map image, and metadata, for example, information about patches, as described below.

In accordance with the embodiments, a point cloud video encoder 20002, a point cloud image encoder 20003, a point cloud video decoder 20006, and a point cloud image decoder 20008 may be performed by one encoder/decoder as described above, or may be performed by a separate path as shown.

A file/segment encapsulation unit 20004 may encapsulate the encoded point cloud data and/or point cloud-related metadata into a file or a segment for streaming. Here, the point cloud-related metadata may be received from the metadata processor or the like. The metadata processor may be included in the point cloud video/image encoder 20002 and 20003 or may be configured as a separate component/module. The file/segment encapsulation unit 20004 may encapsulate the corresponding video/image/metadata in a file format such as ISOBMFF or in the form of a DASH segment or the like. According to an embodiment, the file/segment encapsulation unit 20004 may include the point cloud metadata in the file format. The point cloud-related metadata may be included, for example, in boxes at various levels on the ISOBMFF file format or as data in a separate track within the file. According to an embodiment, the file/segment encapsulation unit 20004 may encapsulate the point cloud-related metadata into a file.

A transmission processor may perform processing of the encapsulated point cloud data for transmission according to the file format. The transmission processor may be included in the transmitter or may be configured as a separate component/module. The transmission processor may process the point cloud data according to a transmission protocol. The processing for transmission may include processing for delivery over a broadcast network and processing for delivery through a broadband. According to an embodiment, the transmission processor may receive point cloud-related metadata from the metadata processor as well as the point cloud data, and perform processing of the point cloud video data for transmission.

The transmitter may transmit a point cloud bitstream or a file/segment including the bitstream to the receiver of the reception device over a digital storage medium or a network. For transmission, processing according to any transmission protocol may be performed. The data processed for transmission may be delivered over a broadcast network and/or through a broadband. The data may be delivered to the reception side in an on-demand manner. The digital storage medium may include various storage media such as USB, SD, CD, DVD, Blu-ray, HDD, and SSD. The transmitter may include an element for generating a media file in a predetermined file format, and may include an element for transmission over a broadcast/communication network. The receiver may extract the bitstream and transmit the extracted bitstream to the decoder.

The receiver may receive point cloud data transmitted by the point cloud data transmission device according to the present disclosure. Depending on the transmission channel, the receiver may receive the point cloud data over a broadcast network or through a broadband. Alternatively, the point cloud data may be received through the digital storage medium. The receiver may include a process of decoding the received data and rendering the data according to the viewport of the user.

The reception processor may perform processing on the received point cloud video data according to the transmission protocol. The reception processor may be included in the receiver or may be configured as a separate component/module. The reception processor may reversely perform the process of the transmission processor above described so as to correspond to the processing for transmission performed at the transmission side. The reception processor may deliver the acquired point cloud video to a decapsulation processor, and the acquired point cloud-related metadata to a metadata parser.

A file/segment decapsulation unit 20005 may decapsulate the point cloud data received in the form of a file from the reception processor. The file/segment decapsulation unit 20005 may decapsulate files according to ISOBMFF or the like, and may acquire a point cloud bitstream or point cloud-related metadata (or a separate metadata bitstream). The acquired point cloud bitstream may be delivered to the point cloud video decoder 20006, and the acquired point cloud video-related metadata (metadata bitstream) may be delivered to the metadata processor. The point cloud bitstream may include the metadata (metadata bitstream). The metadata processor may be included in the point cloud video decoder 20006 or may be configured as a separate component/module. The point cloud video-related metadata acquired by the file/segment decapsulation unit 20005 may take the form of a box or track in the file format. The file/segment decapsulation unit 20005 may receive metadata necessary for decapsulation from the metadata processor, when necessary. The point cloud-related metadata may be delivered to the point cloud video decoder 20006 and used in a point cloud decoding procedure, or may be transferred to the renderer 20009 and used in a point cloud rendering procedure.

The point cloud video decoder 20006 may receive the bitstream and decode the video/image by performing an operation corresponding to the operation of the point cloud video encoder 20002. In this case, the point cloud video decoder 20006 may decode the point cloud video by dividing the same into a geometry video, an attribute video, an occupancy map video, and auxiliary patch information as described below. The geometry video may include a geometry image, the attribute video may include an attribute image, and the occupancy map video may include an occupancy map image. The auxiliary information may include auxiliary patch information. The attribute video/image may include a texture video/image.

The point cloud image decoder 20008 may perform a reverse process corresponding to an operation of the point cloud image encoder 20003 by receiving bitstreams. In this case, the point cloud image decoder 20008 may decode the point cloud image by dividing the point cloud image into a geometry image, an attribute image, an occupancy map image and metadata, for example, auxiliary patch information.

The 3D geometry may be reconstructed based on the decoded geometry video/image, the occupancy map, and auxiliary patch information, and then may be subjected to a smoothing process. The color point cloud image/picture may be reconstructed by assigning a color value to the smoothed 3D geometry based on the texture video/image. The renderer 20009 may render the reconstructed geometry and the color point cloud image/picture. The rendered video/image may be displayed through the display. All or part of the rendered result may be shown to the user through a VR/AR display or a typical display.

A sensor/tracker 20007 acquires orientation information and/or user viewport information from the user or the reception side and delivers the orientation information and/or the user viewport information to the receiver and/or the transmitter. The orientation information may represent information about the position, angle, movement, etc. of the user's head, or represent information about the position, angle, movement, etc. of a device through which the user is viewing a video/image. Based on this information, information about the area currently viewed by the user in a 3D space, that is, viewport information may be calculated.

The viewport information may be information about an area in a 3D space currently viewed by the user through a device or an HMD. A device such as a display may extract a viewport area based on the orientation information, a vertical or horizontal FOV supported by the device, and the like. The orientation or viewport information may be extracted or calculated at the reception side. The orientation or viewport information analyzed at the reception side may be transmitted to the transmission side on a feedback channel.

Based on the orientation information acquired by the sensor/tracker and/or the viewport information indicating the area currently viewed by the user, the receiver may efficiently extract or decode only media data of a specific area, i.e., the area indicated by the orientation information and/or the viewport information from the file. In addition, based on the orientation information and/or viewport information acquired by the sensor/tracker 20007, the transmitter may efficiently encode only the media data of the specific area, that is, the area indicated by the orientation information and/or the viewport information, or generate and transmit a file therefor.

The renderer 20009 may render the decoded point cloud data in a 3D space. The rendered video/image may be displayed through the display. The user may view all or part of the rendered result through a VR/AR display or a typical display.

The feedback process may include transferring various feedback information that may be acquired in the rendering/displaying process to the transmission side or the decoder of the reception side. Through the feedback process, interactivity may be provided in consumption of point cloud data. According to an embodiment, head orientation information, viewport information indicating an area currently viewed by a user, and the like may be delivered to the transmission side in the feedback process. According to an embodiment, the user may interact with what is implemented in the VR/AR/MR/autonomous driving environment. In this case, information related to the interaction may be delivered to the transmission side or a service provider in the feedback process. According to an embodiment, the feedback process may be skipped.

According to an embodiment, the above-described feedback information may not only be transmitted to the transmission side, but also be consumed at the reception side. That is, the decapsulation processing, decoding, and rendering processes at the reception side may be performed based on the above-described feedback information. For example, the point cloud data about the area currently viewed by the user may be preferentially decapsulated, decoded, and rendered based on the orientation information and/or the viewport information.

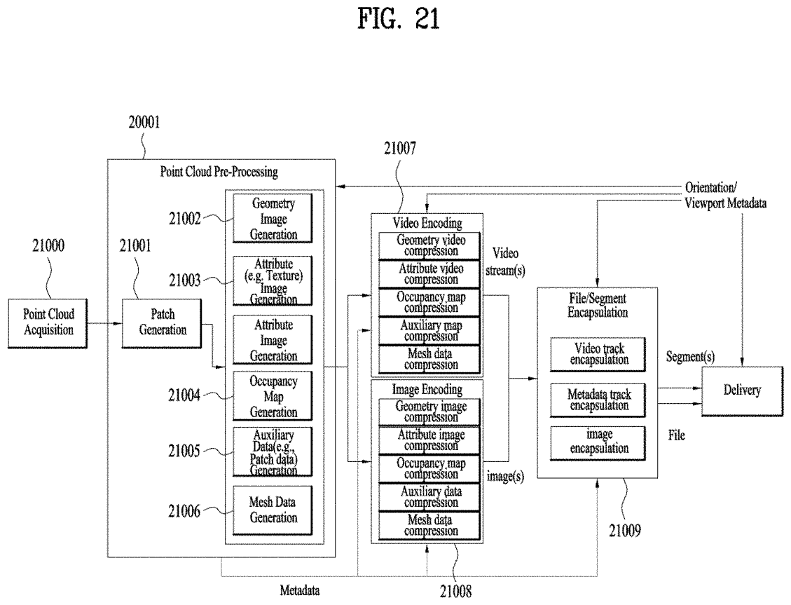

FIG. 21 is an exemplary block diagram of an apparatus for storing and transmitting point cloud data according to embodiments.

FIG. 21 illustrates a point cloud system according to the embodiments, and some/all of the system of FIG. 21 may include some/all of the transmission and reception devices of FIG. 1, the encoding process of FIG. 4, the 2D video/image encoder of FIG. 15, the decoding process of FIG. 16, the transmission device of FIG. 18, and/or the reception device of FIG. 19. Also, some/all of the system of FIG. 21 may be included in or correspond to some/all of the system of FIG. 20.

A point cloud data transmission device according to embodiments may be configured as shown in the figure. Each element of the transmission device may be a module/unit/component/hardware/software/a processor.

The geometry, attribute, auxiliary data (or auxiliary information), and mesh data of the point cloud may each be configured as a separate stream or stored in different tracks in a file. Furthermore, they may be included in a separate segment.

A point cloud acquisition unit 21000 acquires a point cloud. For example, one or more cameras may acquire point cloud data through capture, composition or generation of a point cloud. Through this acquisition process, point cloud data including a 3D position (which may be represented by x, y, and z position values, etc.) (hereinafter referred to as geometry) of each point and attributes (color, reflectance, transparency, etc.) of each point may be acquired. For example, a Polygon File format (PLY) (or Stanford Triangle format) file or the like including the point cloud data may be generated. For point cloud data having multiple frames, one or more files may be acquired. In this process, point cloud related metadata (e.g., metadata related to capture, etc.) may be generated.

A patch generation unit 21002 generates patches from the point cloud data. The patch generation unit 21002 generates point cloud data or point cloud video as one or more pictures/frames. A picture/frame may generally represent a unit representing one image in a specific time interval. When points constituting the point cloud video is divided into one or more patches (sets of points that constitute the point cloud video, wherein the points belonging to the same patch are adjacent to each other in the 3D space and are mapped in the same direction among the planar faces of a 6-face bounding box when mapped to a 2D image) and mapped to a 2D plane, an occupancy map picture/frame in a binary map, which indicates presence or absence of data at the corresponding position in the 2D plane with 0 or 1 may be generated. In addition, a geometry picture/frame, which is in the form of a depth map that represents the information about the position (geometry) of each point constituting the point cloud video on a patch-by-patch basis, may be generated. A texture picture/frame, which represents the color information about each point constituting the point cloud video on a patch-by-patch basis, may be generated. In this process, metadata needed to reconstruct the point cloud from the individual patches may be generated. The metadata may include information about the patches, such as the position and size of each patch in the 2D/3D space. These pictures/frames may be generated continuously in temporal order to construct a video stream or metadata stream.

In addition, the patches may be used for 2D image mapping. For example, the point cloud data may be projected onto each face of a cube. After patch generation, a geometry image, one or more attribute images, an occupancy map, auxiliary data, and/or mesh data may be generated based on the generated patches.

Geometry image generation, attribute image generation, occupancy map generation, auxiliary data generation, and/or mesh data generation are performed by a point cloud pre-processor 20001 or a controller (not shown). The point cloud pre-processor 20001 may include a geometry image generation unit 21002, an attribute image generation unit 21003, an occupancy map generation unit 21004, an auxiliary data generation unit 21005, and a mesh data generation unit 21006.

In the geometry image generation unit 21002, a geometry image is generated based on the result of the patch generation. Geometry represents a point in a 3D space. The geometry image is generated using the occupancy map, which includes information related to 2D image packing of the patches, auxiliary data (patch data), and/or mesh data based on the patches. The geometry image is related to information such as a depth (e.g., near, far) of the patch generated after the patch generation.

In the attribute image generation unit 21003, an attribute image is generated. For example, an attribute may represent a texture. The texture may be a color value that matches each point. According to embodiments, images of a plurality of attributes (such as color and reflectance) (N attributes) including a texture may be generated. The plurality of attributes may include material information and reflectance. According to an embodiment, the attributes may additionally include information indicating a color, which may vary depending on viewing angle and light even for the same texture.

In the occupancy map generation unit 21004, an occupancy map is generated from the patches. The occupancy map includes information indicating presence or absence of data in the pixel, such as the corresponding geometry or attribute image.

In the auxiliary data generation unit 21005, auxiliary data including information about the patches is generated. That is, the auxiliary data represents metadata about a patch of a point cloud object. For example, it may represent information such as normal vectors for the patches. Specifically, the auxiliary data may include information needed to reconstruct the point cloud from the patches (e.g., information about the positions, sizes, and the like of the patches in 2D/3D space, and projection (normal) plane identification information, patch mapping information, etc.)

In the mesh data generation unit 21006, mesh data is generated from the patches. Mesh represents connection between neighboring points. For example, it may represent data of a triangular shape. For example, the mesh data refers to connectivity between the points.

A point cloud pre-processor 20001 or controller generates metadata related to patch generation, geometry image generation, attribute image generation, occupancy map generation, auxiliary data generation, and mesh data generation.

The point cloud transmission device performs video encoding and/or image encoding in response to the result generated by the point cloud pre-processor 20001. The point cloud transmission device may generate point cloud image data as well as point cloud video data. According to embodiments, the point cloud data may have only video data, only image data, and/or both video data and image data.

A video encoder 21007 performs geometry video compression, attribute video compression, occupancy map compression, auxiliary data compression, and/or mesh data compression. The video encoder 21007 generates video stream(s) containing encoded video data.

Specifically, in the geometry video compression, point cloud geometry video data is encoded. In the attribute video compression, attribute video data of the point cloud is encoded. In the auxiliary data compression, auxiliary data associated with the point cloud video data is encoded. In the mesh data compression, mesh data of the point cloud video data is encoded. The respective operations of the point cloud video encoder may be performed in parallel.

An image encoder 21008 performs geometry image compression, attribute image compression, occupancy map compression, auxiliary data compression, and/or mesh data compression. The image encoder generates image(s) containing encoded image data.

Specifically, in the geometry image compression, the point cloud geometry image data is encoded. In the attribute image compression, the attribute image data of the point cloud is encoded. In the auxiliary data compression, the auxiliary data associated with the point cloud image data is encoded. In the mesh data compression, the mesh data associated with the point cloud image data is encoded. The respective operations of the point cloud image encoder may be performed in parallel.

The video encoder 21007 and/or the image encoder 21008 may receive metadata from the point cloud pre-processor 20001. The video encoder 21007 and/or the image encoder 21008 may perform each encoding process based on the metadata.

A file/segment encapsulation unit 21009 encapsulates the video stream(s) and/or image(s) in the form of a file and/or segment. The file/segment encapsulation unit 21009 performs video track encapsulation, metadata track encapsulation, and/or image encapsulation.

In the video track encapsulation, one or more video streams may be encapsulated into one or more tracks.

In the metadata track encapsulation, metadata related to a video stream and/or an image may be encapsulated in one or more tracks. The metadata includes data related to the content of the point cloud data. For example, it may include initial viewing orientation metadata. According to embodiments, the metadata may be encapsulated into a metadata track, or may be encapsulated together in a video track or an image track.

In the image encapsulation, one or more images may be encapsulated into one or more tracks or items.

For example, according to embodiments, when four video streams and two images are input to the encapsulator, the four video streams and two images may be encapsulated in one file.

The file/segment encapsulation unit 21009 may receive metadata from the pre-processor. The file/segment encapsulator may perform encapsulation based on the metadata.

A file and/or a segment generated by the file/segment encapsulation unit 21009 are transmitted by the point cloud transmission device or the transmitter. For example, the segment(s) may be delivered based on a DASH-based protocol.

The deliverer may transmit a point cloud bitstream or a file/segment including the bitstream to the receiver of the reception device over a digital storage medium or a network. Processing according to any transmission protocol may be performed for transmission. The data that has been processed for transmission may be delivered over a broadcast network and/or through a broadband. The data may be delivered to the reception side in an on-demand manner. The digital storage medium may include various storage media such as USB, SD, CD, DVD, Blu-ray, HDD, and SSD. The deliverer may include an element for generating a media file in a predetermined file format, and may include an element for transmission over a broadcast/communication network.

The deliverer receives orientation information and/or viewport information from the receiver. The deliverer may deliver the acquired orientation information and/or viewport information (or information selected by the user) to the point cloud pre-processor 20001, the video encoder 21007, the image encoder 21008, the file/segment encapsulation unit 20009, and/or the point cloud video encoder. Based on the orientation information and/or the viewport information, the point cloud encoder may encode all point cloud data or the point cloud data indicated by the orientation information and/or the viewport information. Based on the orientation information and/or the viewport information, the file/segment encapsulator may encapsulate all point cloud data or the point cloud data indicated by the orientation information and/or the viewport information. Based on the orientation information and/or the viewport information, the deliverer may deliver all point cloud data or the point cloud data indicated by the orientation information and/or the viewport information.

For example, the point cloud pre-processor 20001 may perform the above-described operation on all the point cloud data or on the point cloud data indicated by the orientation information and/or the viewport information. The video encoder 21007 and/or the image encoder 21008 may perform the above-described operation on all the point cloud data or on the point cloud data indicated by the orientation information and/or the viewport information. The file/segment encapsulation unit 21009 may perform the above-described operation on all the point cloud data or on the point cloud data indicated by the orientation information and/or the viewport information. The transmitter may perform the above-described operation on all the point cloud data or on the point cloud data indicated by the orientation information and/or the viewport information.

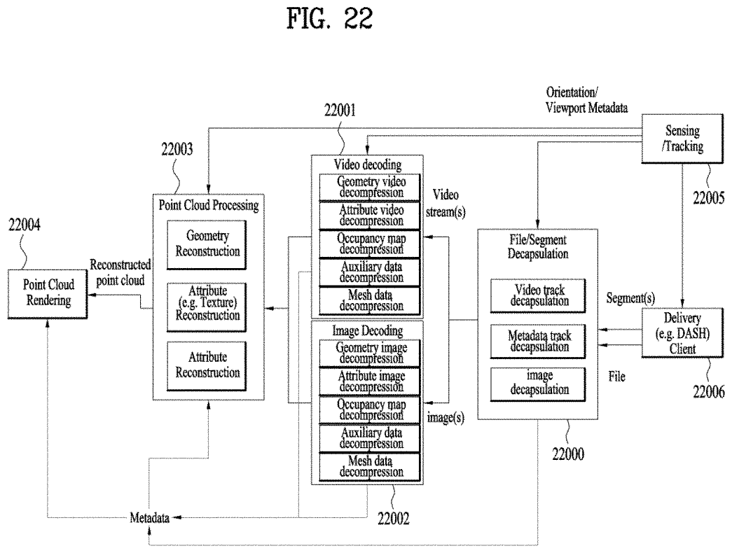

FIG. 22 is an exemplary block diagram of a point cloud data reception device according to embodiments.

FIG. 22 illustrates a point cloud system according to the embodiments, and some/all of the system of FIG. 22 may include some/all of the transmission and reception devices of FIG. 1, the encoding process of FIG. 4, the 2D video/image encoder of FIG. 15, the decoding process of FIG. 16, the transmission device of FIG. 18, and/or the reception device of FIG. 19. Also, some/all of the system of FIG. 22 may be included in or correspond to some/all of the system of FIGS. 20 and 21.

Each component of the reception device may be a module/unit/component/hardware/software/processor. A delivery client 22006 may receive point cloud data, a point cloud bitstream, or a file/segment including the bitstream transmitted by the point cloud data transmission device according to the embodiments. The receiver may receive the point cloud data over a broadcast network or through a broadband depending on the channel used for the transmission. Alternatively, the point cloud video data may be received through a digital storage medium. The receiver may include a process of decoding the received data and rendering the received data according to the user viewport. The reception processor may perform processing on the received point cloud data according to a transmission protocol. The delivery client 22006 (or reception processor) may be included in the receiver or configured as a separate component/module. The reception processor may reversely perform the process of the transmission processor described above so as to correspond to the processing for transmission performed at the transmission side. The reception processor may deliver the acquired point cloud data to the file/segment decapsulation unit 22000 and the acquired point cloud related metadata to the metadata processor.

The sensor/tracker 22005 acquires orientation information and/or viewport information. The sensor/tracker 22005 may deliver the acquired orientation information and/or viewport information to the delivery client 22006, the file/segment decapsulation unit 22000, the point cloud decoders 22001 and 22002 and the point cloud processor 22003.

The delivery client 22006 may receive all point cloud data or the point cloud data indicated by the orientation information and/or the viewport information based on the orientation information and/or the viewport information. The file/segment decapsulation unit 22000 may decapsulate all point cloud data or the point cloud data indicated by the orientation information and/or the viewport information based on the orientation information and/or the viewport information. The point cloud decoder (the video decoder 22001 and/or the image decoder 22002) may decode all point cloud data or the point cloud data indicated by the orientation information and/or the viewport information based on the orientation information and/or the viewport information. The point cloud processor 22003 may process all point cloud data or the point cloud data indicated by the orientation information and/or the viewport information based on the orientation information and/or the viewport information.

A file/segment decapsulation unit 22000 performs video track decapsulation, metadata track decapsulation, and/or image decapsulation. The file/segment decapsulation unit 22000 may decapsulate the point cloud data in the form of a file received from the reception processor. The file/segment decapsulation unit 22000 may decapsulate files or segments according to ISOBMFF, etc., to acquire a point cloud bitstream or point cloud-related metadata (or a separate metadata bitstream). The acquired point cloud bitstream may be delivered to the point cloud decoders 22001 and 22002, and the acquired point cloud-related metadata (or metadata bitstream) may be delivered to the metadata processor. The point cloud bitstream may include the metadata (metadata bitstream). The metadata processor may be included in the point cloud video decoder or may be configured as a separate component/module. The point cloud-related metadata acquired by the file/segment decapsulation unit 22000 may take the form of a box or track in a file format. The file/segment decapsulation unit 22000 may receive metadata necessary for decapsulation from the metadata processor, when necessary. The point cloud-related metadata may be delivered to the point cloud decoders 22001 and 22002 and used in a point cloud decoding procedure, or may be delivered to the point cloud renderer 22004 and used in a point cloud rendering procedure. The file/segment decapsulation unit 22000 may generate metadata related to the point cloud data.

In the video track decapsulation in the file/segment decapsulation unit 22000, a video track contained in the file and/or segment is decapsulated. Video stream(s) including a geometry video, an attribute video, an occupancy map, auxiliary data, and/or mesh data are decapsulated.

In the metadata track decapsulation in the file/segment decapsulation unit 22000, a bitstream including metadata related to the point cloud data and/or auxiliary data is decapsulated.

In the image decapsulation in the file/segment decapsulation unit 22000, image(s) including a geometry image, an attribute image, an occupancy map, auxiliary data and/or mesh data are decapsulated.

A video decoder 22001 performs geometry video decompression, attribute video decompression, occupancy map decompression, auxiliary data decompression, and/or mesh data decompression. The video decoder 22001 decodes the geometry video, the attribute video, the auxiliary data, and/or the mesh data in a process corresponding to the process performed by the video encoder of the point cloud transmission device according to the embodiments.

An image decoder 22002 performs geometry image decompression, attribute image decompression, occupancy map decompression, auxiliary data decompression, and/or mesh data decompression. The image decoder 22002 decodes the geometry image, the attribute image, the auxiliary data, and/or the mesh data in a process corresponding to the process performed by the image encoder of the point cloud transmission device according to the embodiments.

The video decoder 22001 and/or the image decoder 22002 may generate metadata related to the video data and/or the image data.

A point cloud processor 22003 performs geometry reconstruction and/or attribute reconstruction.

In geometry reconstruction, the geometry video and/or geometry image are reconstructed from the decoded video data and/or decoded image data based on the occupancy map, auxiliary data and/or mesh data.

In attribute reconstruction, the attribute video and/or the attribute image are reconstructed from the decoded attribute video and/or the decoded attribute image based on the occupancy map, auxiliary data, and/or mesh data. According to embodiments, for example, the attribute may be a texture. According to embodiments, an attribute may represent a plurality of pieces of attribute information. When there is a plurality of attributes, the point cloud processor 22003 according to the embodiments performs a plurality of attribute reconstructions.

The point cloud processor 22003 may receive metadata from the video decoder 22001, the image decoder 22002, and/or the file/segment decapsulation unit 22000, and process the point cloud based on the metadata.

A point cloud renderer 22004 renders the reconstructed point cloud. The point cloud renderer 22004 may receive metadata from the video decoder 22001, the image decoder 22002, and/or the file/segment decapsulation unit 22000, and render the point cloud based on the metadata.

The display actually displays the result of rendering on the display.

According to the methods/devices according to the embodiments, as shown in FIGS. 20 to 22, a transmission side may encode point cloud data as bitstreams, encapsulate the data in the form of file and/or segment and then transmit the encapsulated data, and a reception side may decapsulate the file and/or segment type as bitstream including point cloud and decode the decapsulated file and/or segment type as point cloud data.

For example, a point cloud data device according to the embodiments may encapsulate point cloud data based on a file. The file may include a V-PCC track containing parameters for a point cloud, a geometry track containing geometry, an attribute track containing an attribute, and an occupancy track containing an occupancy map.

In addition, a point cloud data reception device according to embodiments encapsulates the point cloud data based on a file. The file may include a V-PCC track containing parameters for a point cloud, a geometry track containing geometry, an attribute track containing an attribute, and an occupancy track containing an occupancy map.

The encapsulation operation described above may be performed by the file/segment encapsulation unit 20004 of FIG. 20 or the file/segment encapsulation unit 21009 of FIG. 21. The decapsulation operation described above may be performed by the file/segment encapsulation unit 20005 of FIG. 20 or the file/segment decapsulation unit 22000 of FIG. 22.

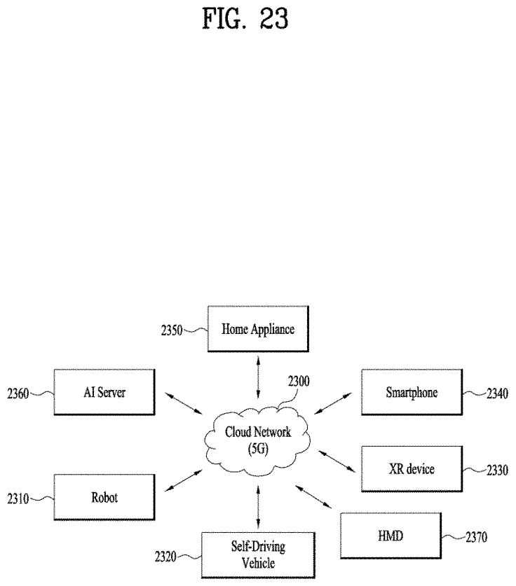

FIG. 23 illustrates an exemplary structure operable in connection with point cloud data transmission/reception methods/devices according to embodiments.

In the structure according to the embodiments, at least one of a AI (Artificial Intelligence) server 2360, a robot 2310, a self-driving vehicle 2320, an XR device 2330, a smartphone 2340, a home appliance 2350 and/or a head-mount display (HMD) 2370 is connected to a cloud network 2300. Here, the robot 2310, the self-driving vehicle 2320, the XR device 2330, the smartphone 2340, or the home appliance 2350 may be referred to as a device. In addition, the XR device 2330 may correspond to a point cloud compression data (PCC) device according to embodiments or may be operatively connected to the PCC device.

The cloud network 2300 may represent a network that constitutes part of the cloud computing infrastructure or is present in the cloud computing infrastructure. Here, the cloud network 2300 may be configured using a 3G network, 4G or Long Term Evolution (LTE) network, or a 5G network.

The AI server 2360 may be connected to at least one of the robot 2310, the self-driving vehicle 2320, the XR device 2330, the smartphone 2340, the home appliance 2350, and/or the HMD 2370 over the cloud network 2300 and may assist at least a part of the processing of the connected devices 2310 to 2370.

The HMD 2370 represents one of the implementation types of the XR device 2330 and/or the PCC device according to the embodiments. An HMD type device according to embodiments includes a communication unit, a control unit, a memory, an I/O unit, a sensor unit, and a power supply unit.

Hereinafter, various embodiments of the devices 2310 to 2350 to which the above-described technology is applied will be described. The devices 2310 to 2350 illustrated in FIG. 23 may be operatively connected/coupled to a point cloud data transmission and reception device according to the above-described embodiments.

<PCC+XR>

The XR/PCC device 2330 may employ PCC technology and/or XR (AR+VR) technology, and may be implemented as an HMD, a head-up display (HUD) provided in a vehicle, a television, a mobile phone, a smartphone, a computer, a wearable device, a home appliance, a digital signage, a vehicle, a stationary robot, or a mobile robot.

The XR/PCC device 2330 may analyze 3D point cloud data or image data acquired through various sensors or from an external device and generate position data and attribute data about 3D points. Thereby, the XR/PCC device 2330 may acquire information about the surrounding space or a real object, and render and output an XR object. For example, the XR/PCC device 2330 may match an XR object including auxiliary information about a recognized object with the recognized object and output the matched XR object.

<PCC+Self-Driving+XR>

The self-driving vehicle 2320 may be implemented as a mobile robot, a vehicle, an unmanned aerial vehicle, or the like by applying the PCC technology and the XR technology.

The self-driving vehicle 2320 to which the XR/PCC technology is applied may represent an autonomous vehicle provided with means for providing an XR image, or an autonomous vehicle that is a target of control/interaction in the XR image. In particular, the self-driving vehicle 2320, which is a target of control/interaction in the XR image, may be distinguished from the XR device 2330 and may be operatively connected thereto.

The self-driving vehicle 2320 having means for providing an XR/PCC image may acquire sensor information from the sensors including a camera, and output the generated XR/PCC image based on the acquired sensor information. For example, the self-driving vehicle 2320 may have an HUD and output an XR/PCC image thereto to provide an occupant with an XR/PCC object corresponding to a real object or an object present on the screen.

In this case, when the XR/PCC object is output to the HUD, at least a part of the XR/PCC object may be output to overlap the real object to which the occupant's eyes are directed. On the other hand, when the XR/PCC object is output on a display provided inside the self-driving vehicle 2320, at least a part of the XR/PCC object may be output to overlap the object on the screen. For example, the self-driving vehicle 2320 may output XR/PCC objects corresponding to objects such as a road, another vehicle, a traffic light, a traffic sign, a two-wheeled vehicle, a pedestrian, and a building.

The virtual reality (VR) technology, the augmented reality (AR) technology, the mixed reality (MR) technology and/or the point cloud compression (PCC) technology according to the embodiments are applicable to various devices.

In other words, the VR technology is a display technology that provides only real-world objects, backgrounds, and the like as CG images. On the other hand, the AR technology refers to a technology for showing a CG image virtually created on a real object image. The MR technology is similar to the AR technology described above in that virtual objects to be shown are mixed and combined with the real world. However, the MR technology differs from the AR technology makes a clear distinction between a real object and a virtual object created as a CG image and uses virtual objects as complementary objects for real objects, whereas the MR technology treats virtual objects as objects having the same characteristics as real objects. More specifically, an example of MR technology applications is a hologram service.

Recently, the VR, AR, and MR technologies are sometimes referred to as extended reality (XR) technology rather than being clearly distinguished from each other. Accordingly, embodiments of the present disclosure are applicable to all VR, AR, MR, and XR technologies. For such technologies, encoding/decoding based on PCC, V-PCC, and G-PCC techniques may be applied.

The PCC method/device according to the embodiments may be applied to a self-driving vehicle that provides a self-driving service.

A vehicle that provides the self-driving service is connected to a PCC device for wired/wireless communication.

When the point cloud compression data transmission and reception device (PCC device) according to the embodiments is connected to a self-driving vehicle for wired/wireless communication, the device may receive and process content data related to an AR/VR/PCC service that may be provided together with the self-driving service and transmit the processed content data to the self-driving vehicle. In the case where the point cloud data transmission and reception device is mounted on a self-driving vehicle, the point cloud transmitting and reception device may receive and process content data related to the AR/VR/PCC service according to a user input signal input through a user interface device and provide the processed content data to the user. The vehicle or the user interface device according to the embodiments may receive a user input signal. The user input signal according to the embodiments may include a signal indicating the self-driving service.

As described above, the V-PCC based point cloud video encoder of FIG. 1, FIG. 4, FIG. 18, FIG. 20 or FIG. 21 generates patches by projecting 3D point cloud data (or contents) into a 2D space. The patches generated in the 2D space are split into a geometry image (geometry frame or geometry patch frame) indicating position information and a texture image (attribute frame or attribute patch frame) indicating color information. The geometry image and the texture image are video-compressed per frame and output as video bitstreams (or geometry bitstreams) of the geometry image and video bitstreams (or attribute bitstreams) of the texture image. Projection plane information of each patch and auxiliary patch information (or patch information or metadata) including patch size information, which are required for a receiving side to decode a 2D patch, are video-compressed and output as bitstreams of the auxiliary patch information. In addition, an occupancy map indicating the presence of a point of each pixel as 0 or 1 is entropy-compressed or video-compressed depending on a lossless mode or a lossy mode and therefore output as video bitstream (or occupancy map bitstream) of the occupancy map. The compressed geometry bitstream, the compressed attribute bitstream, the compressed auxiliary patch information bitstream and the compressed occupancy map bitstream are multiplexed into an architecture of V-PCC bitstream. The V-PCC bitstream may be transmitted to the receiving side as it is, or may be transmitted to the receiving side after being encapsulated in the form of file/segment by the file/segment encapsulation module of FIG. 1, FIG. 18, FIG. 20 or FIG. 21.

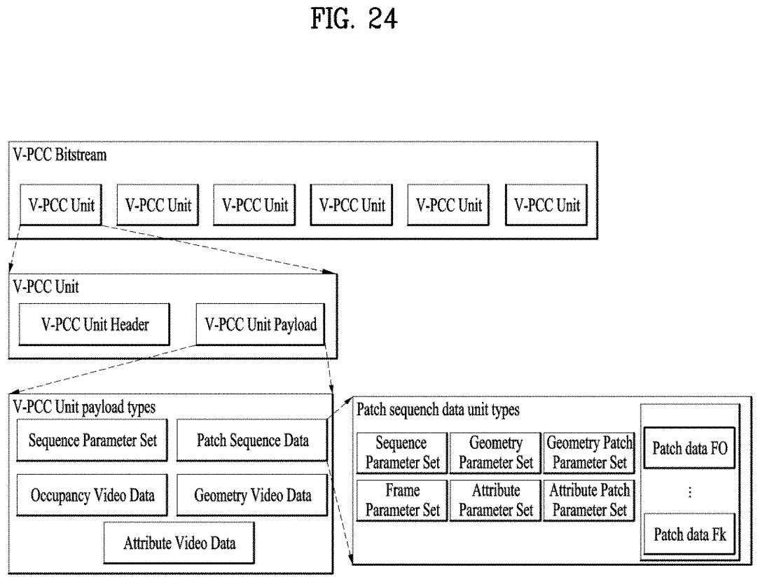

FIG. 24 illustrates an example of a V-PCC bitstream architecture according to the embodiments. In one embodiment, the V-PCC bitstream of FIG. 24 is output from the V-PCC based point cloud video encoder of FIG. 1, FIG. 4, FIG. 18, FIG. 20 or FIG. 21.

The V-PCC bitstream includes one or multiple V-PCC units. That is, the V-PCC bitstream is a set of V-PCC units. Each V-PCC unit includes a V-PCC unit header and a V-PCC unit payload. In this specification, data included in a corresponding V-PCC unit payload are identified through the V-PCC unit header. To this end, the V-PCC unit header includes type information indicating a type of the corresponding V-PCC unit. V-PCC unit payloads of the V-PCC units include initialization information for decoding and point cloud data depending on the type information.

The initialization information for decoding includes a sequence parameter set (SPS) and a patch sequence data (PSD). The sequence parameter set includes encoding information of bitstreams. The patch sequence data include auxiliary patch information (or metadata) bitstreams, and further include encoding information of a video sequence comprised of each patch and patch encoding information. The sequence parameter set and the patch sequence data may be referred to as signaling information, and may be generated by the metadata processor in the point cloud video encoder or a separate component/module in the point cloud video encoder.

In one embodiment, the patch sequence data include a sequence parameter set for patch, a geometry parameter set, a geometry patch parameter set, an attribute parameter set, an attribute patch parameter set, a frame parameter set, and k+1 patch data frames.

In one embodiment, the point cloud data include geometry video data (that is, compressed geometry bitstream), and attribute video data (that is, compressed attribute bitstream), occupancy video data (that is, compressed occupancy map bitstream). In this specification, the geometry video data, the attribute video data and the occupancy video data are referred to as 2D video encoded data (or 2D video encoded information). The patch sequence data (PSD) may be referred to as non-video encoded data (or non-video encoded information). The sequence parameter set (SPS) may be referred to as configuration and metadata information.

Also, when supposing that geometry video data of the multiple layers exist, geometry video data of each layer may be arranged in each geometry video stream. Alternatively, the geometry video data of all layers may be arranged in a single geometry video stream. Likewise, when supposing that attribute video data of the multiple layers exist, attribute video data of each layer may be arranged in each attribute video stream. Alternatively, the attribute video data of all layers may be arranged in a single attribute video stream. For another example, when supposing that geometry video data of two layers exist, geometry video data of first and second layers may be arranged in one geometry video stream.

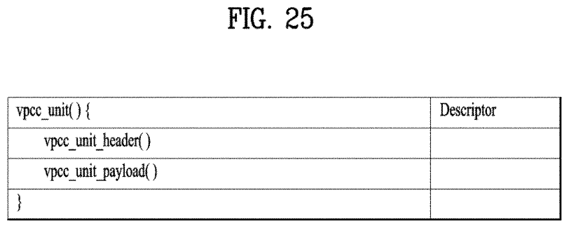

FIG. 25 illustrates an example of a syntax structure of each V-PCC unit according to the embodiments. Each V-PCC unit includes a V-PCC unit header and a V-PCC unit payload.

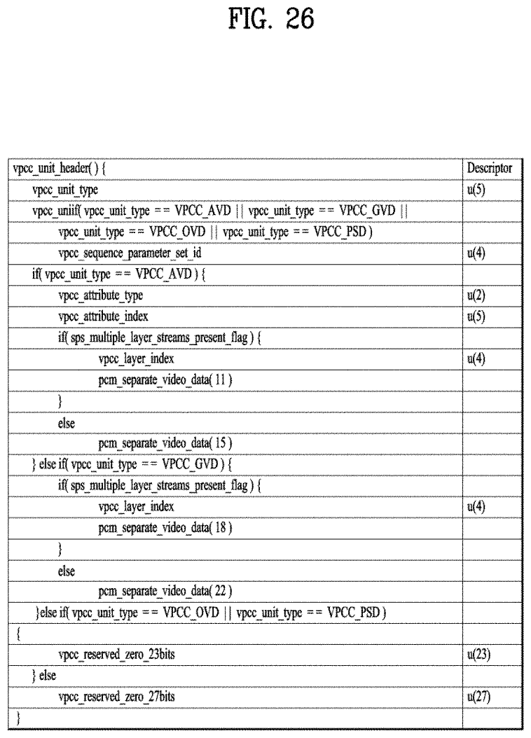

FIG. 26 illustrates an example of a syntax structure of a V-PCC unit header according to the embodiments. In one embodiment, the V-PCC unit header (vpcc_unit_header( )) of FIG. 26 includes a vpcc_unit_type field. The vpcc_unit_type field indicates a type of a corresponding V-PCC unit.

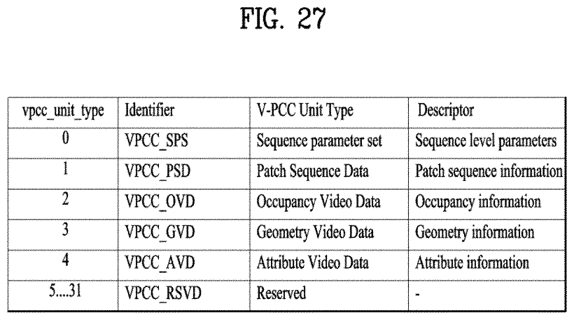

FIG. 27 illustrates an example of a type of a V-PCC unit allocated to a vpcc_unit_type field according to the embodiments.

Referring to FIG. 27, in one embodiment, if a value of the vpcc_unit_type field is 0, data included in a V-PCC unit payload of a corresponding V-PCC unit indicates a sequence parameter set (VPCC_SPS), if the value of the vpcc_unit_type field is 1, the data indicates patch sequence data (VPCC_PSD), if the value of the vpcc_unit_type field is 2, the data indicates occupancy video data (VPCC_OVD), if the value of the vpcc_unit_type field is 3, the data indicates attribute video data (VPCC_AVD), and if the value of the vpcc_unit_type field is 4, the data indicates geometry video data (VPCC_GVD).

Since meaning, order, deletion and addition of the value allocated to the vpcc_unit_type field may easily be modified by the person skilled in the art, the present disclosure is not limited to the aforementioned embodiment.

At this time, the V-PCC unit payload follows a format of HEVC NAL unit. That is, the occupancy, geometry and attribute video data V-PCC unit payloads according to the vpcc_unit_type field value correspond to video data units (for example, HEVC NAL unit) that may be decoded by a specified video decoder in the corresponding occupancy, geometry and attribute parameter set V-PCC unit.

In one embodiment, if the vpcc_unit_type field indicates attribute video data (VPCC_AVD) or geometry video data (VPCC_GVD) or occupancy video data (VPCC_OVD) or patch sequence data (VPCC_PSD), the corresponding V-PCC unit header further includes a vpcc_sequence_parameter_set_id field.

The vpcc_sequence_parameter_set_id field indicates (specifies) an identifier (that is, sps_sequence_parameter_set_id) of an active sequence parameter set (VPCC SPS). The sps_sequence_parameter_set_id field has a value in the range of 0 to 15.

In one embodiment, if the vpcc_unit_type field indicates attribute video data (VPCC_AVD), the V-PCC unit header further includes a vpcc_attribute_type field and a vpcc_attribute_index field.

The vpcc_attribute_type field indicates a type (for example, color, reflectance, and material) of attribute video data carried to an attribute video data unit.

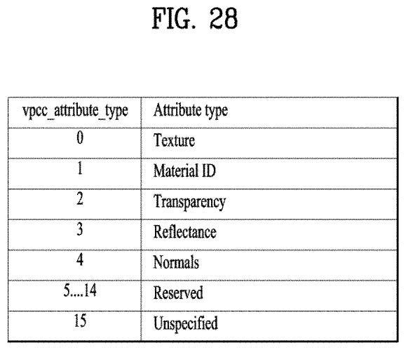

FIG. 28 illustrates an example of an attribute video data type allocated to a vpcc_attribute_type field according to the embodiments.

Referring to FIG. 28, in one embodiment, if the vpcc_attribute_type field has a value of 0, it indicates that a type of the attribute video data carried to the attribute video data unit is a texture, if the vpcc_attribute_type field has a value of 1, it indicates that the type of the attribute video data carried to the attribute video data unit is a material identifier (material ID), if the vpcc_attribute_type field has a value of 2, it indicates that the type of the attribute video data carried to the attribute video data unit is transparency, if the vpcc_attribute_type field has a value of 3, it indicates that the type of the attribute video data carried to the attribute video data unit is reflectance, and if the vpcc_attribute_type field has a value of 4, it indicates that the type of the attribute video data carried to the attribute video data unit is normal.

The texture indicates an attribute that includes texture information of a point cloud. For example, this may indicate an attribute that includes Red, Green, Blue (RGB) color information.

The material ID indicates an attribute that includes supplemental information indicating a material type of a point in one point cloud. For example, the material type may be used as an indicator for identifying an object or characteristic of a point in a point cloud.

The transparency indicates an attribute that includes transparency information related to each point in a point cloud.

The reflectance indicates an attribute that includes reflectance information related to each point in a point cloud.

The normal indicates an attribute that includes unit vector information related to each point in a point cloud.

In FIG. 26, the vpcc_attribute_index field indicates an index of attribute video data carried to the attribute video data unit.

That is, in one embodiment, the V-PCC unit header of the V-PCC unit for carrying attribute video data designates an attribute type and its index based on the vpcc_attribute_type field and the vpcc_attribute_index field while allowing multiple instances of the same attribute type to be supported.

An sps_multiple_layer_streams_present_flag field indicates whether the V-PCC unit header includes a vpcc_layer_index field and a pcm_separate_video_data(11) field.

For example, if the vpcc_unit_type field value indicates attribute video data (VPCC_AVD) and the sps_multiple_layer_streams_present_flag field has a value of true (for example, 0), the vpcc_layer_index field and the pcm_separate_video_data(11) field are further included in the corresponding V-PCC unit header. That is, if the sps_multiple_layer_streams_present_flag field has a value of true, it means that multiple layers for the attribute video data or the geometry video data exist. In this case, a field (for example, vpcc_layer_index) indicating an index of a current layer is required.

The vpcc_layer_index field indicates an index of a current layer of the attribute video data. The vpcc_layer_index field has a value between 0 and 15.

For example, if the vpcc_unit_type field value indicates attribute video data (VPCC_AVD) and the sps_multiple_layer_streams_present_flag field has a value of false (for example, 1), a pcm_separate_video_data(15) field is further included in the corresponding V-PCC unit header. That is, if the sps_multiple_layer_streams_present_flag field has a value of false, it means that multiple layers for the attribute video data or the geometry video data do not exist. In this case, a field indicating an index of a current layer is not required.

For example, if the vpcc_unit_type field value indicates the geometry video data (VPCC_GVD) and the sps_multiple_layer_streams_present_flag field has a value of true (for example, 0), the vpcc_layer_index field and a pcm_separate_video_data(18) field are further included in the corresponding V-PCC unit header.

The vpcc_layer_index field indicates an index of a current layer of the geometry video data. The vpcc_layer_index field has a value between 0 and 15.

For example, if the vpcc_unit_type field value indicates the geometry video data (VPCC_GVD) and the sps_multiple_layer_streams_present_flag field has a value of false (for example, 1), a pcm_separate_video_data(22) field is further included in the corresponding V-PCC unit header.

For example, if the vpcc_unit_type field value indicates the occupancy video data (VPCC_OVD) or the patch sequence data (VPCC_PSD), a vpcc_reserved_zero_23bits field is further included in the corresponding V-PCC unit header. If not so, a vpcc_reserved_zero_27bits field is further included in the corresponding V-PCC unit header.

Meanwhile, the V-PCC unit header of FIG. 26 may further include a vpcc_pcm_video_flag field.

For example, if the vpcc_pcm_video_flag field has a value of 1, it indicates that a related geometry video data unit or attribute video data unit includes only Pulse Coding Mode (PCM) coded points. For another example, if the vpcc_pcm_video_flag field has a value of 0, it indicates that a related geometry video data unit or attribute video data unit may include non-PCM coded points. If the vpcc_pcm_video_flag field does not exist, it may be predicted that the corresponding field has a value of 0.

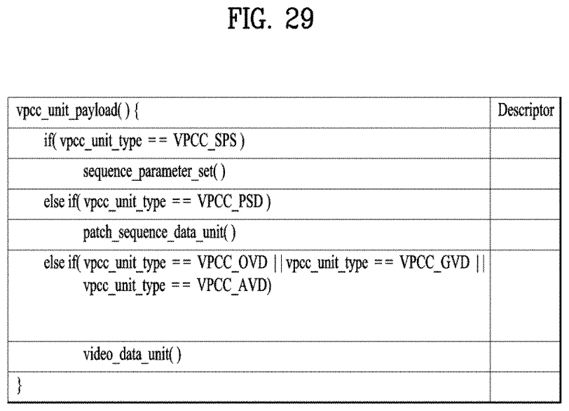

FIG. 29 illustrates an example of a syntax structure of a V-PCC unit payload according to the embodiments.

The V-PCC unit payload of FIG. 29 includes one of a sequence parameter set (sequence_parameter_set( )), a patch sequence data unit (patch_sequence_data_unit( )), and a video data unit (video_data_unit( )) in accordance with the vpcc_unit_type field value of the corresponding V-PCC unit header.

For example, if the vpcc_unit_type field indicates the sequence parameter set (VPCC_SPS), the V-PCC unit payload includes the sequence parameter set (sequence_parameter_set( )), and if the vpcc_unit_type field indicates the patch sequence data (VPCC_PSD), the V-PCC unit payload includes the patch_sequence_data_unit (patch_sequence_data_unit( )). In one embodiment, if the vpcc_unit_type field indicates the occupancy vide data (VPCC_OVD), the V-PCC unit payload includes the occupancy video data unit (video_data_unit( )) carrying the occupancy video data, if the vpcc_unit_type field indicates the geometry video data (VPCC_GVD), the V-PCC unit payload includes the geometry video_data_unit (video_data_unit( )) carrying the geometry video data, and if the vpcc_unit_type field indicates the attribute video data (VPCC_AVD), the V-PCC unit payload includes the attribute video_data_unit (video_data_unit( )) carrying the attribute video data. In one embodiment, each unit of FIG. 29 corresponds HEVC NAL unit.

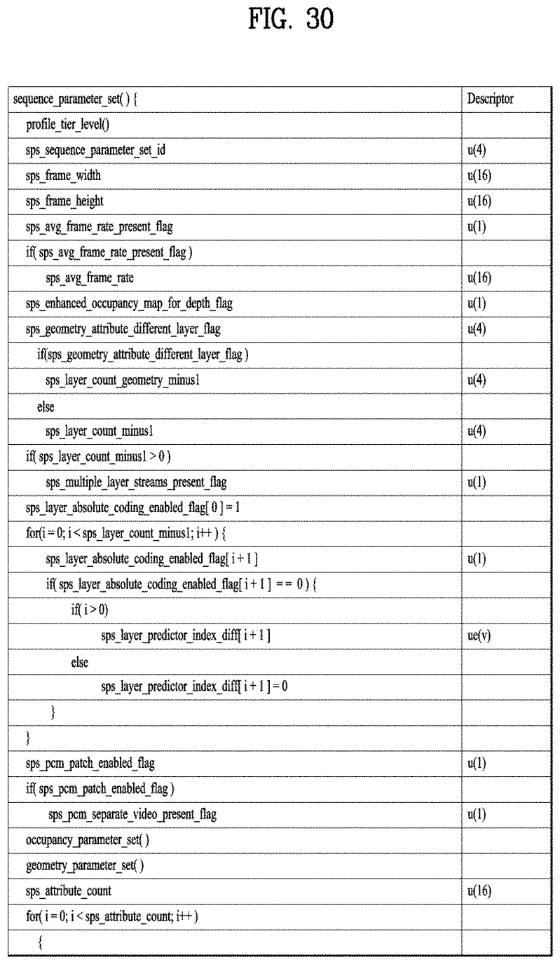

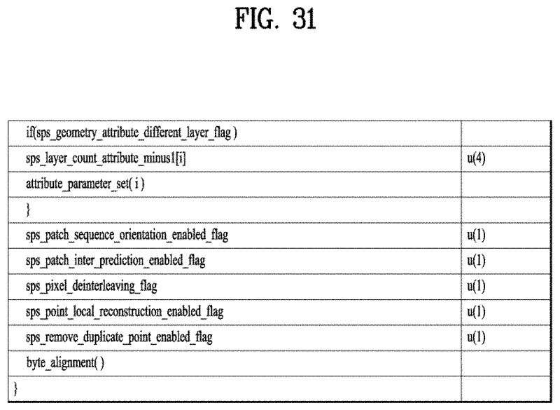

FIGS. 30 and 31 illustrate examples of a syntax structure of a sequence parameter set( ) included in V-PCC unit payload according to the embodiments.

The sequence parameter set( ) of FIGS. 30 and 31 may be applied to coded point cloud sequences that include sequences of a coded geometry video data unit, an attribute video data unit, and an occupancy video data unit.

The sequence parameter set of FIGS. 30 and 31 may include a profile_tier_level( ) field, an sps_sequence_parameter_set_id field, an sps_frame_width field, an sps_frame_height field, and an sps_avg_frame_rate_present_flag field.

The profile_tier_level( ) indicates codec information used to compress the sequence parameter set.

The sps_sequence_parameter_set_id field provides an identifier of the sequence parameter set for reference based on the other syntax elements.

The sps_frame_width field indicates a width of a nominal frame in terms of integer Luma samples.

The sps_frame_height field indicates a height of the nominal frame in terms of integer Luma samples.

The sps_avg_frame_rate_present_flag field indicates whether average nominal frame rate information is included in its bitstream. For example, if the sps_avg_frame_rate_present_flag field has a value of 0, it indicates that no average nominal frame rate information is included in the corresponding bitstream. If the sps_avg_frame_rate_present_flag field has a value of 1, it indicates that average nominal frame rate information should be indicated in the corresponding bitstream. For example, if the sps_avg_frame_rate_present_flag field has a value of true, that is, 1, the sequence parameter set further includes an sps_avg_frame_rate field, an sps_enhanced_occupancy_map_for_depth_flag field, and an sps_geometry_attribute_different_layer_flag field.

The sps_avg_frame_rate field indicates an average nominal point cloud frame rate on a basis of point cloud frames per 256 seconds. If the sps_avg_frame_rate field does not exist, its field value may be 0. During a reconstruction phase, the decoded occupancy, geometry and attribute videos may be modified to nominal, width, height and frame rate by using appropriate scaling.

The sps_enhanced_occupancy_map_for_depth_flag field indicates whether the decoded occupancy map video includes information as to whether intermediate depth positions between two depth layers are occupied. For example, if the sps_enhanced_occupancy_map_for_depth_flag field has a value of 1, it indicates that the decoded occupancy map video includes information as to whether intermediate depth positions between two depth layers are occupied. If the sps_enhanced_occupancy_map_for_depth_flag field has a value of 0, it indicates that the decoded occupancy map video does not include information as to whether intermediate depth positions between two depth layers are occupied.

The sps_geometry_attribute_different_layer_flag field indicates whether the number of layers used to encode geometry video data is different from the number of layer used to encode attribute video data. For example, if the sps_geometry_attribute_different_layer_flag field has a value of 1, it indicates that the number of layers used to encode geometry video data is different from the number of layer used to encode attribute video data. For example, two layers may be used for encoding of the geometry video data, and one layer may be used for encoding of the attribute video data. Also, if the sps_geometry_attribute_different_layer_flag field has a value of 1, it indicates whether the number of layers used to encode geometry and attribute video data is signaled to the patch sequence data unit.

The sps_geometry_attribute_different_layer_flag field indicates whether the sequence parameter set includes sps_layer_count_geometry_minus1 field and sps_layer_count_minus1 field. For example, if the sps_geometry_attribute_different_layer_flag field has a value of true (for example, 1), the sequence parameter set further includes the sps_layer_count_geometry_minus1 field, and if the sps_geometry_attribute_different_layer_flag field has a value of false (for example, 0), the sequence parameter set further includes the sps_layer_count_minus1 field.

The sps_layer_count_geometry_minus1 field indicates the number of layers used to encode geometry video data. The sps_layer_count_minus1 field indicates the number of layers used to encode attribute video data.

If the sps_layer_count_minus1 field has a value greater than 0, the sequence parameter set further includes an sps_multiple_layer_streams_present_flag field and an sps_layer_absolute_coding_enabled_flag [0]=1 field.

The sps_multiple_layer_streams_present_flag field indicates whether geometry layers or attribute layers are placed in a single video stream or separate video streams. For example, if the sps_multiple_layer_streams_present_flag field has a value of 0, it indicates that all the geometry layers or attribute layers are respectively placed in a single geometry video stream or single attribute video stream. If the sps_multiple_layer_streams_present_flag field has a value of 1, all the geometry layers or attribute layers are placed in separate video streams.

The sequence parameter set (SPS) includes an iteration statement (or for loop) repeated as much as a value of the sps_layer_count_minus1 field, wherein the iteration statement includes an sps_layer_absolute_coding_enabled_flag field. At this time, in one embodiment, i is reset to 0, 1 is increased whenever the iteration statement is executed, and the iteration statement is repeated until the value of i becomes the value of the sps_layer_count_minus1 field. In addition, if the sps_layer_absolute_coding_enabled_flag field has a value of 0 and the value of i is greater than 0, the sequence parameter set further includes an sps_layer_predictor_index_diff field, and if not so, the sequence parameter set does not include an sps_layer_predictor_index_diff field.

If the sps_layer_absolute_coding_enabled_flag [i] field has a value of 1, it indicates that a geometry layer having index of i is coded without any form of layer prediction. If the sps_layer_absolute_coding_enabled_flag [i] field has a value of 0, it indicates that a geometry layer having index of i is first predicted from another earlier coded layer before coding.

If the sps_layer_absolute_coding_enabled_flag [i] field has a value of 0, it indicates that the sps_layer_predictor_index_diff [i] field is used to calculate a predictor of the geometry layer having index of i.

The sequence parameter set (SPS) according to the present specification may further include an sps_pcm_patch_enabled_flag field. The sps_pcm_patch_enabled_flag field indicates whether the sequence parameter set includes an sps_pcm_separate_video_present_flag field, an occupancy_parameter_set( ) field, a geometry_parameter_set( ) field, and an sps_attribute_count field. For example, if the sps_pcm_patch_enabled_flag field has a value of 1, the sequence parameter set further includes an sps_pcm_separate_video_present_flag field, an occupancy_parameter_set( ) field, a geometry_parameter_set( ) field, and an sps_attribute_count field. That is, if the sps_pcm_patch_enabled_flag field has a value of 1, it indicates that patches having PCM coded points exist in their bitstreams.

The sps_pcm_separate_video_present_flag field indicates whether PCM coded geometry video data and attribute video data are stored in separate video streams. For example, if the sps_pcm_separate_video_present_flag field has a value of 1, it indicates that PCM coded geometry video data and attribute video data may be stored in separate video streams.

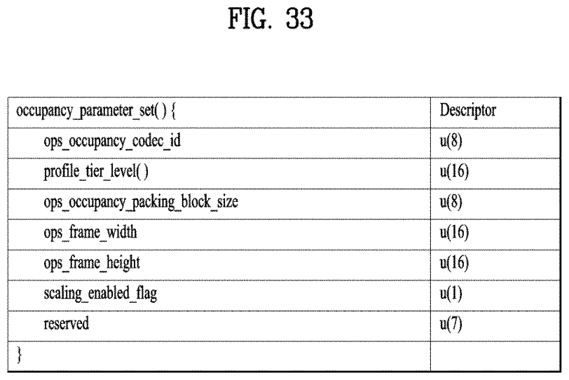

The occupancy_parameter_set( ) field includes information on an occupancy map. The information included in the occupancy_parameter_set( ) field will be described in detail with reference to FIG. 33.

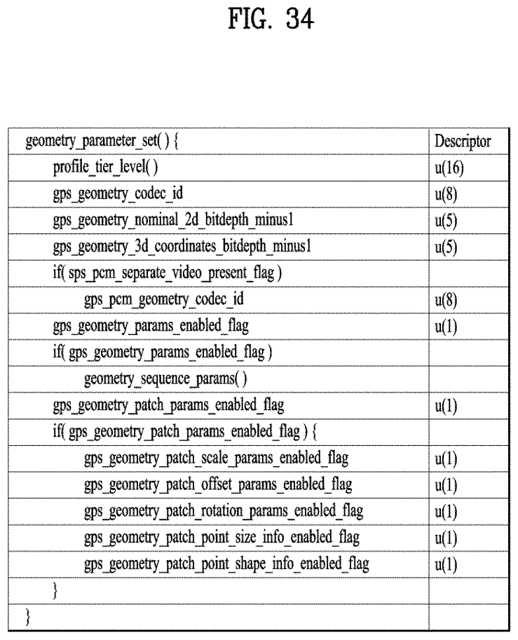

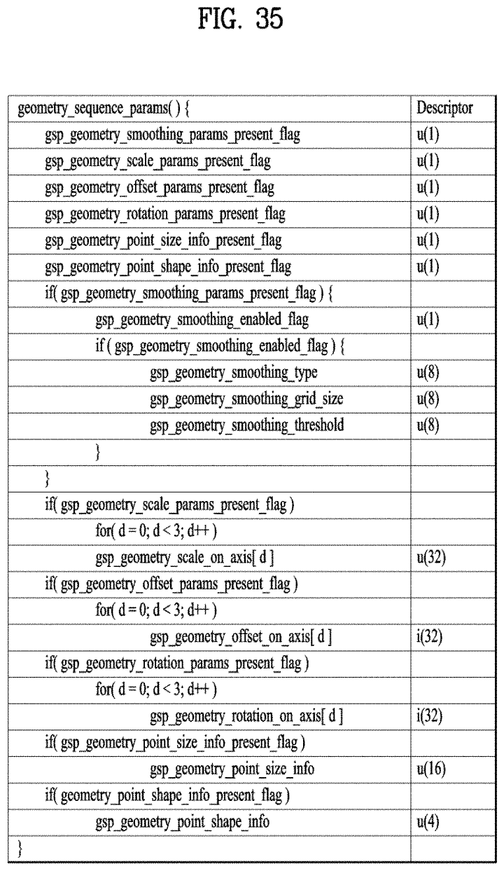

The geometry_parameter_set( ) field includes information on geometry video data. The information included in the geometry_parameter_set( ) field will be described in detail with reference to FIGS. 34 and 35.

The sps_attribute_count field indicates the number of attributes related to its point cloud.

In one embodiment, the sequence parameter set (SPS) according to the present specification includes an iteration statement repeated as much as a value of the sps_attribute_count field, wherein the iteration statement includes sps_layer_count_attribute_minus1 field and attribute_parameter_set( ) if the sps_geometry_attribute_different_layer_flag field has a value of 1. In one embodiment, i is reset to 0 in the iteration statement, 1 is increased whenever the iteration statement is executed, and the iteration statement is repeated until a value of i becomes the value of the sps_attribute_count field.

The sps_layer_count_attribute_minus1 [i] field indicates the number of layers used to encode an ith attribute video data related to a corresponding point cloud.

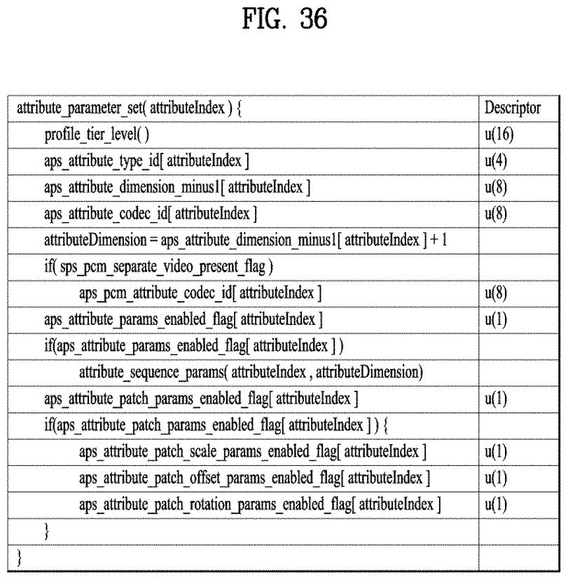

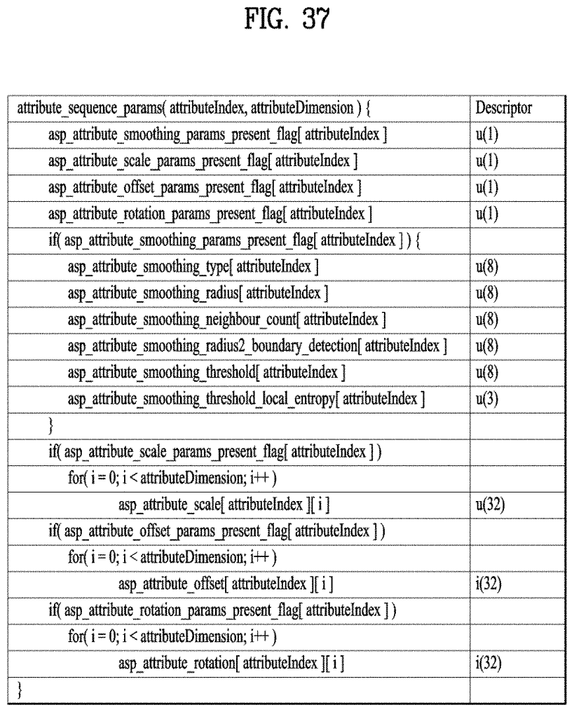

The attribute_parameter_set(i) includes information on the ith attribute video data related to the corresponding point cloud. The information included in the attribute_parameter_set(i) will be described in detail with reference to FIGS. 36 and 37.

In one embodiment, the sequence parameter set (SPS) according to the present specification further includes an sps_patch_sequence_orientation_enabled_flag field, an sps_patch_inter_prediction_enabled_flag field, an sps_pixel_deinterleaving_flag field, an sps_point_local_reconstruction_enabled_flag field, an sps_remove_duplicate_point_enabled_flag field, and a byte_alignment( ) field.

The sps_patch_sequence_orientation_enabled_flag field indicates whether flexible orientation is signaled to the patch sequence data unit. For example, if the sps_patch_sequence_orientation_enabled_flag field has a value of 1, it indicates that flexible orientation is signaled to the patch sequence data unit, and if the sps_patch_sequence_orientation_enabled_flag field has a value of 0, it indicates that flexible orientation is not signaled to the patch sequence data unit.

If the sps_patch_inter_prediction_enabled_flag field has a value of 1, it indicates that inter-prediction may be used for patch information by using patch information provided from previously encoded patch frames.

If the sps_pixel_deinterleaving_flag field has a value of 1, it indicates that decoded geometry and attribute videos corresponding to a single stream include pixels interleaved from two layers. If the sps_pixel_deinterleaving_flag field has a value of 0, it indicates that decoded geometry and attribute videos corresponding to a single stream include pixels interleaved from a single layer.

If the sps_point_local_reconstruction_enabled_flag field has a value of 1, it indicates that a local reconstruction mode is used for a point cloud reconstruction process.

If the sps_remove_duplicate_point_enabled_flag field has a value of 1, it indicates that duplicated points should not be reconstructed. In this case, the duplicated points are points having 2D and 3D geometry coordinates the same as another point from a lower layer.

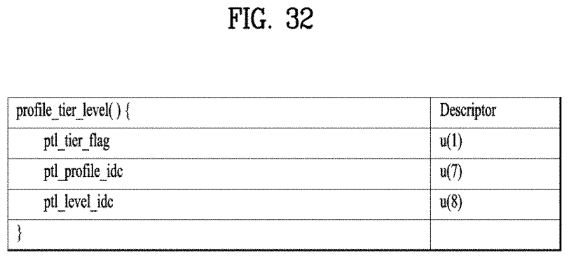

FIG. 32 illustrates an example of a syntax structure of profile tier level( ) information included in a sequence parameter set (sequence_parameter_set( )) according to the embodiments.

A profile tier level( ) field (or information) includes a ptl_tier_flag field, a ptl_profile_idc field, and a ptl_level_idc field.

The ptl_tier_flag field specifies a codec profile tier used for encoding.

The ptl_profile_idc field indicates codec profile information for identifying an encoded point cloud sequence.

The ptl_level_idc field indicates a level of a codec profile for identifying an encoded point cloud sequence.

FIG. 33 illustrates an example of a syntax structure of an occupancy parameter set (occupancy_parameter_set( )) according to the embodiments.

In one embodiment, if the sps_pcm_patch_enabled_flag field has a value of 1 in the sequence parameter set of FIGS. 30 and 31, the sequence parameter set includes the occupancy parameter set (occupancy_parameter_set( )) of FIG. 33.

The occupancy parameter set (occupancy_parameter_set( )) according to the embodiments may include an ops_occupancy_codec_id field, a profile_tier_level( ) field, an ops_occupancy_packing_block_size field, an ops_frame_width field, an ops_frame_height field, and a scaling_enabled_flag field.

The ops_occupancy_codec_id field indicates an identifier of a codec used to compress occupancy video data. The sps_sequence_parameter_set_id field has a value in the range of 0 to 255.

The profile_tier_level( ) field indicates codec information used to compress occupancy video data. This allows the other codecs to be used for occupancy video data in addition to codecs used for geometry video data and attribute video data.

The ops_occupancy_packing_block_size field indicates a size of an occupancy packing block. The size of the occupancy packing block may be used by a user. That is, the occupancy map is comprised of a block, and its resolution may be determined in accordance with a size of the block. For example, if the block as a size of 1*1, the occupancy map has resolution of a pixel unit.

The ops_frame_width field indicates a width of an occupancy map frame in terms of integer Luma samples.

The ops_frame_height field indicates a height of an occupancy map frame in terms of integer Luma samples.

If the scaling_enabled_flag field has a value of 1, it indicates that the corresponding occupancy map is allowed to be modified to nominal, width, height and frame rate, which are signaled to the sequence parameter set, by using appropriate scaling. If the scaling_enabled_flag field has a value of 0, it indicates that the corresponding occupancy map is not allowed to be modified to nominal, width, height and frame rate, which are signaled to the sequence parameter set, by using appropriate scaling.

FIG. 34 illustrates an example of a syntax structure of a geometry parameter set (geometry_parameter_set( )) according to the embodiments. In one embodiment, if the sps_pcm_patch_enabled_flag field has a value of 1 in the sequence parameter set of FIGS. 30 and 31, the sequence parameter set includes a geometry parameter set (geometry_parameter_set( )) of FIG. 34.

The geometry parameter set (geometry_parameter_set( )) according to the embodiments may include a profile_tier_level( ) field, a gps_geometry_codec_id field, a gps_geometry_nominal_2d_bitdepth_minus1 field, and a gps_geometry_3d_coordinates_bitdepth_minus1 field.

The profile_tier_level( ) field indicates codec information used to compress geometry video data. This allows the other codecs to be used for geometry video data in addition to codecs used for occupancy video data and attribute video data.

The gps_geometry_codec_id field indicates an identifier of codec used to compress geometry video data. The sps_sequence_parameter_set_id field has a value in the range of 0 to 255.

The gps_geometry_nominal_2d bitdepth minus1 field indicates a nominal 2D bitdepth for geometry video data.

The gps_geometry_3d_coordinates_bitdepth_minus1 field indicates a bitdepth of a geometry coordinate of a reconstructed point cloud.

In one embodiment, the geometry parameter set of FIG. 34 further includes a gps_pcm_geometry_codec_id field and a gps_geometry_params_enabled_flag field if the sps_pcm_separate_video_present_flag field has a value of 1. In one embodiment, the sps_pcm_separate_video_present_flag field is signaled to the sequence parameter set of FIGS. 30 and 31. The sps_pcm_separate_video_present_flag field indicates whether PCM coded geometry video data and attribute video data are stored in separate video streams. For example, if the sps_pcm_separate_video_present_flag field has a value of 1, it indicates that the PCM coded geometry video data and attribute video data may be stored in separate video streams.

The gps_pcm_geometry_codec_id field indicates an identifier of codec used to compress geometry video data for PCM coded points.

The gps_geometry_params_enabled_flag field indicates whether the geometry parameter set includes a geometry_sequence_params( ) field and a gps_geometry_patch_params_enabled_flag field. For example, if the gps_geometry_params_enabled_flag field has a value of 1, the geometry parameter set of FIG. 34 further includes a geometry_sequence_params( ) field and a gps_geometry_patch_params_enabled_flag field.

The geometry_sequence_params( ) includes geometry sequence parameters, and will be described in detail with reference to FIG. 35.

The gps_geometry_patch_params_enabled_flag field indicates whether the geometry parameter set includes information related to a geometry patch. For example, if the gps_geometry_patch_params_enabled_flag field has a value of 1, in one embodiment, the geometry parameter set of FIG. 34 further includes a gps_geometry_patch_scale_params_enabled_flag field, a gps_geometry_patch_offset_params_enabled_flag field, a gps_geometry_patch_rotation_params_enabled_flag field, a gps_geometry_patch_point_size_info_enabled_flag field, and a gps_geometry_patch_point_shape_info_enabled_flag field.

The gps_geometry_patch_scale_params_enabled_flag field indicates whether geometry patch scale parameters are signaled.

The gps_geometry_patch_offset_params_enabled_flag field indicates whether geometry patch offset parameters are signaled.

The gps_geometry_patch_rotation_params_enabled_flag field indicates whether geometry patch rotation parameters are signaled.

The gps_geometry_patch_point_size_info_enabled_flag field indicates whether geometry patch point size information is signaled.

The gps_geometry_patch_point_shape_info_enabled_flag field indicates whether geometry patch point shape information is signaled.

FIG. 35 illustrates an example of a syntax structure of geometry sequence parameters (geometry_sequence_params( )) according to the embodiments. In one embodiment, if the gps_geometry_params_enabled_flag field has a value of 1 in the geometry parameter set (gps) of FIG. 34, the geometry parameter set includes geometry sequence parameters (geometry_sequence_params( )) of FIG. 35.

The geometry sequence parameters (gsp) of FIG. 35 may include a gsp_geometry_smoothing_params_present_flag_field, a gsp_geometry_scale_params_present_flag field, a gsp_geometry_offset_params_present_flag field, a gsp_geometry_rotation_params_present_flag field, a gsp_geometry_point_size_info_present_flag field, and a gsp_geometry_point_shape_info_present_flag field.

The gsp_geometry_smoothing_params_present_flag field indicates whether the geometry sequence parameters include a gsp geometry smoothing enabled flag field. For example, the geometry sequence parameters (gsp) of FIG. 35 further include a gsp_geometry_smoothing_enabled_flag field if the gsp_geometry_smoothing_params_present_flag field has a value of 1.

The gsp_geometry_smoothing_enabled_flag field indicates that the geometry sequence parameters include a gsp_geometry_smoothing_type field, a gsp_geometry_smoothing_grid_size field and a gsp_geometry_smoothing_threshold field. For example, if the gsp_geometry_smoothing_enabled_flag field has a value of 1, the geometry sequence parameters (gsp) of FIG. 35 further include a gsp_geometry_smoothing_type field, a gsp_geometry_smoothing_grid_size field and a gsp_geometry_smoothing_threshold field.

The transmission side and/or the reception side in this specification may perform smoothing for a geometry image and/or attribute image to reduce or remove an error included in image data. For example, the transmission side may generate a smoothed geometry by performing a smoothing process for reconstructed geometry images based on patch information that is, smoothly filtering a portion where an error between data may be caused. At this time, there may be various methods for smoothing image data. For example, a filtering method, a push-pull method, a smoothed push-pull method or a combination method of push-pull and SLM.

The gsp_geometry_smoothing_type field indicates a type of geometry smoothing. For example, the type of smoothing may include a push-pull method, a smoothed push-pull method, or a combination method of push-pull and SLM.

The gsp_geometry_smoothing_grid_size field indicates a variable geometry smoothing grid size used for geometry smoothing.

The gsp_geometry_smoothing_threshold field indicates a smoothing threshold.

The gsp_geometry_scale_params_present_flag field indicates whether the geometry sequence parameters include a gsp_geometry_scale_on_axis field. For example, if the gsp_geometry_scale_params_present_flag field has a value of 1, an iteration statement is included in geometry sequence parameters (geometry_sequence_params( )), wherein the iteration statement includes a gsp_geometry_scale_on_axis[d] field. In one embodiment, d is reset to 0 in the iteration statement, 1 is increased whenever the iteration statement is executed, and the iteration statement is repeated until a value of d becomes 3.

The gsp_geometry_scale_on_axis[d] field indicates a value of a scale along d axis. The gsp_geometry_scale_on_axis[d] field has a value ranging from 0 to 2³²−1, and d is in the range of 0 to 2. For example, if the value of d is 0, d corresponds to X axis, if the value of d is 1, d corresponds to Y axis, and if the value of d is 2, d corresponds to Z axis.

The gsp_geometry_offset_params_present_flag field indicates whether the geometry sequence parameters include a gsp_geometry_offset_on_axis field. For example, if the gsp_geometry_offset_params_present_flag field has a value of 1, an iteration statement is included in the geometry sequence parameters (geometry_sequence_params( )), wherein the iteration statement includes a gsp_geometry_offset_on_axis[d] field. In one embodiment, d is reset to 0 in the iteration statement, 1 is increased whenever the iteration statement is executed, and the iteration statement is repeated until a value of d becomes 3.

The gsp_geometry_offset_on_axis[d] field indicates an offset value along d axis. The gsp_geometry_offset_on_axis[d] field has a value ranging from −2³¹ to 2³¹−1, and d is in the range of 0 to 2. For example, if the value of d is 0, d corresponds to X axis, if the value of d is 1, d corresponds to Y axis, and if the value of d is 2, d corresponds to Z axis.

The gsp_geometry_rotation_params_present_flag field indicates whether the geometry sequence parameters include a gsp_geometry_rotation_on_axis field. For example, if the gsp_geometry_rotation_params_present_flag field has a value of 1, an iteration statement is included in the geometry sequence parameters (geometry_sequence_params( )), wherein the iteration statement includes a gsp_geometry_rotation_on_axis[d] field. In one embodiment, d is reset to 0 in the iteration statement, 1 is increased whenever the iteration statement is executed, and the iteration statement is repeated until a value of d becomes 3.

The gsp_geometry_rotation_on_axis[d] field indicates a rotation value along d axis. The gsp_geometry_rotation_on_axis[d] field has a value ranging from −2³¹ to 2³¹−1, and d is in the range of 0 to 2. For example, if the value of d is 0, d corresponds to X axis, if the value of d is 1, d corresponds to Y axis, and if the value of d is 2, d corresponds to Z axis.

The gsp_geometry_point_size_info_present_flag field indicates whether the geometry sequence parameters include a gsp_geometry_point_size_info field. For example, if the gsp_geometry_point_size_info_present_flag field has a value of 1, the geometry sequence parameters include the gsp_geometry_point_size_info field. The gsp_geometry_point_size_info field indicates geometry point size information to be used for rendering.

The geometry_point_shape_info_present_flag field indicates whether the geometry sequence parameters include a gsp_geometry_point_shape_info field. For example, if the geometry_point_shape_info_present_flag field has a value of 1, the geometry sequence parameters include the gsp_geometry_point_shape_info field. The gsp_geometry_point_shape_info field indicates geometry point shape information to be used for rendering.

FIG. 36 illustrates an example of a syntax structure of an attribute parameter set (attribute_parameter_set( )) according to the embodiments. In one embodiment, if the sps_geometry_attribute_different_layer_flag field has a value of 1 in the sequence parameter set (SPS) of FIGS. 30 and 31, the sequence parameter set includes an attribute parameter set (aps) of FIG. 36.

The attribute parameter set (aps) according to the embodiments includes a profile_tier_level( ) field. The profile_tier_level( ) field indicates codec information used to compress an ith attribute video data. This allows the other codecs to be used for attribute video data in addition to codecs used for occupancy and geometry video data.

The attribute parameter set (aps) according to the embodiments may further include an aps_attribute_type_id [attributeIndex] field, an aps_attribute_dimension_minus1 [attributeIndex] field, and an aps_attribute_codec_id [attributeIndex] field, which are associated with index and/or dimension. In one embodiment, an attributeDimension field has a value obtained by adding 1 to the aps_attribute_dimension_minus1 [attributeIndex] field.

The aps_attribute_type_id [attributeIndex] field indicates an attribute type of attribute video data having a corresponding attribute index. For example, if the corresponding attribute index is i, it indicates an attribute type of the ith attribute video data. The attribute type may be one of texture, material ID, transparency, reflectance and normal. Definition and meaning of the attribute type allocated to the aps_attribute_type_id[attributeIndex] field will be understood with reference to FIG. 28.

The aps_attribute_dimension_minus1 [attributeIndex] field indicates dimension of attribute video data of the corresponding attribute index.

The aps_attribute_codec_id[attributeIndex] field indicates an identifier of codec used to compress attribute video data of the corresponding attribute index.

In one embodiment, if the sps_pcm_separate_video_present_flag field has a value of 1, the attribute parameter set includes an aps_pcm_attribute_codec_id [attributeIndex] field and an aps_attribute_params_enabled_flag[attributeIndex] field. In one embodiment, the sps_pcm_separate_video_present_flag field is signaled to the sequence parameter set of FIGS. 30 and 31. The sps_pcm_separate_video_present_flag field indicates whether PCM coded geometry video data and attribute video data area stored in separate video streams. For example, if the sps_pcm_separate_video_present_flag field has a value of 1, it indicates that the PCM coded geometry video data and attribute video data may be stored in separate video streams.

The aps_pcm_attribute_codec_id [attributeIndex] field indicates an identifier of codec used to compress attribute video data of a corresponding attribute index for PCM coded points.

The aps_attribute_params_enabled_flag[attributeIndex] field indicates whether the attribute parameter set includes an attribute_sequence_params(attributeIndex, attributeDimension) field and an aps_attribute_patch_params_enabled_flag [attributeIndex] field of the corresponding attribute index.

For example, if the aps_attribute_params_enabled_flag [attributeIndex] field has a value of 1, the attribute parameter set (aps) further includes an attribute_sequence_params (attributeIndex, attributeDimension) field and an aps_attribute_patch_params_enabled_flag [attributeIndex] field.

The attribute_sequence_params (attributeIndex, attributeDimension) field includes attribute sequence parameters of a corresponding attribute index and dimension, and will be described in detail with reference to FIG. 37.

The aps_attribute_patch_params_enabled_flag [attributeIndex] field indicates whether attribute patch related parameters are signaled. For example, if the aps_attribute_patch_params_enabled_flag [attributeIndex] field has a value of 1, the attribute parameter set (aps) may further include an aps_attribute_patch_scale_params_enabled_flag [attributeIndex] field, an aps_attribute_patch_offset_params_enabled_flag [attributeIndex] field, and an aps_attribute_patch_rotation_params_enabled_flag [attributeIndex] field.

The aps_attribute_patch_scale_params_enabled_flag field indicates whether attribute patch scale parameters are signaled for an attribute of a corresponding attribute index. If the aps_attribute_patch_scale_params_enabled_flag field has a value of 1, it indicates that the attribute patch scale parameters are signaled for an attribute having a corresponding attribute index, and if the aps_attribute_patch_scale_params_enabled_flag field has a value of 0, it indicates that the attribute patch scale parameters are not signaled.

The aps_attribute_patch_offset_params_enabled_flag field indicates whether attribute patch offset parameters are signaled for an attribute of a corresponding attribute index. If the aps_attribute_patch_offset_params_enabled_flag field has a value of 1, it indicates that the attribute patch offset parameters are signaled for an attribute having a corresponding attribute index, and if the aps_attribute_patch_offset_params_enabled_flag field has a value of 0, it indicates that the attribute patch scale parameters are not signaled.

The aps_attribute_patch_rotation_params_enabled_flag field indicates whether attribute patch rotation parameters are signaled for an attribute of a corresponding attribute index. If the aps_attribute_patch_rotation_params_enabled_flag field has a value of 1, it indicates that the attribute patch rotation parameters are signaled for an attribute having a corresponding attribute index, and if the aps_attribute_patch_rotation_params_enabled_flag field has a value of 0, it indicates that the attribute patch rotation parameters are not signaled.

FIG. 37 illustrates an example of a syntax structure of attribute sequence parameters (attribute_sequence_params (attributeIndex, attributeDimension)) according to the embodiments. In one embodiment, if the aps_attribute_params_enabled_flag [attributeIndex] field has a value of 1 in the attribute parameter set (aps) of FIG. 36, the attribute sequence parameters include attribute sequence parameters (asp) of FIG. 37.

In one embodiment, the attribute sequence parameters (asp) of FIG. 37 include an asp_attribute_smoothing_params_present_flag [attributeIndex] field, an asp_attribute_scale_params_present_flag [attributeIndex] field, an asp_attribute_offset_params_present_flag [attributeIndex] field, and an asp_attribute_rotation_params_present_flag [attributeIndex] field.

The asp_attribute_smoothing_params_present_flag [attributeIndex] field indicates whether attribute smoothing parameters of a corresponding attribute index are signaled. For example, in one embodiment, if the asp_attribute_smoothing_params_present_flag [attributeIndex] field has a value of 1, the attribute sequence parameters (asp) further include an asp_attribute_smoothing_type [attributeIndex] field, an asp_attribute_smoothing_radius [attributeIndex] field, an asp_attribute_smoothing neighbour_count [attributeIndex] field, an asp_attribute_smoothing_radius2_boundary_detection [attributeIndex] field, an asp_attribute_smoothing_threshold [attributeIndex] field, and an asp_attribute_smoothing_threshold_local_entropy [attributeIndex] field.

The asp_attribute_smoothing_type [attributeIndex] field indicates a type of attribute smoothing of an attribute having a corresponding attribute index. For example, the type of smoothing may include a push-pull method, a smoothed push-pull method, or a combination method of push-pull and SLM.

The asp_attribute_smoothing_radius [attributeIndex] field indicates a smoothing radius of an attribute having a corresponding attribute index.

The asp_attribute_smoothing_neighbour_count [attributeIndex] field indicates a smoothing neighbor count of an attribute having a corresponding attribute index.

The asp_attribute_smoothing_radius2_boundary_detection [attributeIndex] field indicates a smoothing radius2 boundary detection of an attribute having a corresponding attribute index.

The asp_attribute_smoothing_threshold [attributeIndex] field indicates a smoothing threshold of an attribute having a corresponding attribute index.

The asp_attribute_smoothing_threshold_local_entropy [attributeIndex] field indicates a local entropy threshold in a neighborhood of a boundary point of an attribute having a corresponding attribute index.

The asp_attribute_scale_params_present_flag [attributeIndex] field indicates whether the attribute sequence parameters include an asp_attribute_scale [attributeIndex][i] field. For example, if the asp_attribute_scale_params_present_flag [attributeIndex] field has a value of 1, an iteration statement is included in the attribute sequence parameters (asp), and includes an asp_attribute_scale [attributeIndex][i] field. In one embodiment, i is reset to 0 in the iteration statement, 1 is increased whenever the iteration statement is executed, and the iteration statement is repeated until a value of i becomes a value of attributeDimension. The asp_attribute_scale [attributeIndex][i] field indicates a value of a scale to be applied to values of an ith Dimension of an attribute having a corresponding attribute index.

The asp_attribute_offset_params_present_flag [attributeIndex] field indicates whether the attribute sequence parameters include an asp_attribute_offset [attributeIndex][i] field. For example, if the asp_attribute_offset_params_present_flag [attributeIndex] field has a value of 1, an iteration statement is included in the attribute sequence parameters (asp), and includes an asp_attribute_offset [attributeIndex][i] field. In one embodiment, i is reset to 0 in the iteration statement, 1 is increased whenever the iteration statement is executed, and the iteration statement is repeated until a value of i becomes a value of attributeDimension. The asp_attribute_offset [attributeIndex][i] field indicates an offset value to be added to values of the ith Dimension of an attribute having a corresponding attribute index.

The asp_attribute_rotation_params_present_flag [attributeIndex] field indicates whether the attribute sequence parameters include an asp_attribute_rotation [attributeIndex][i] field. For example, if the asp_attribute_rotation_params_present_flag [attributeIndex] field has a value of 1, an iteration statement is included in the attribute sequence parameters (asp), and includes an asp_attribute_rotation [attributeIndex][i] field. In one embodiment, i is reset to 0 in the iteration statement, 1 is increased whenever the iteration statement is executed, and the iteration statement is repeated until a value of i becomes a value of attributeDimension. The asp_attribute_rotation [attributeIndex][i] field indicates a rotation value to be applied to values of the ith Dimension of an attribute having a corresponding attribute index.

Meanwhile, as described above, the patch is generated by the patch generation unit of FIG. 4 or FIG. 18 by projecting 3D point cloud contents into a 2D space. That is, the patch generation unit determines a bounding box of a point cloud per frame and projects points closest to a hexahedron surface of the bounding box in the form of orthogonal projection, thereby generating the patch. At this time, the patch generated in the 2D space is generated by being split into a geometry image (geometry frame or geometry patch frame) indicating position information and a texture image (attribute frame or attribute patch frame) indicating color information. That is, the bounding box means a hexahedron that contain all of points of a point cloud.

The auxiliary patch information indicates metadata required to reconstruct a point cloud from individual patches, and may include information on a position and size in a 2D/3D space of the patch and information on a type of a projected surface.

In one embodiment, the auxiliary patch information according to the present specification is transmitted by being included in a patch data frame.

The patch data frame is included in the V-PCC unit payload of the corresponding V-PCC unit as shown in FIG. 24 when the vpcc_unit_type field of the sequence parameter set indicates patch sequence data (PSD).

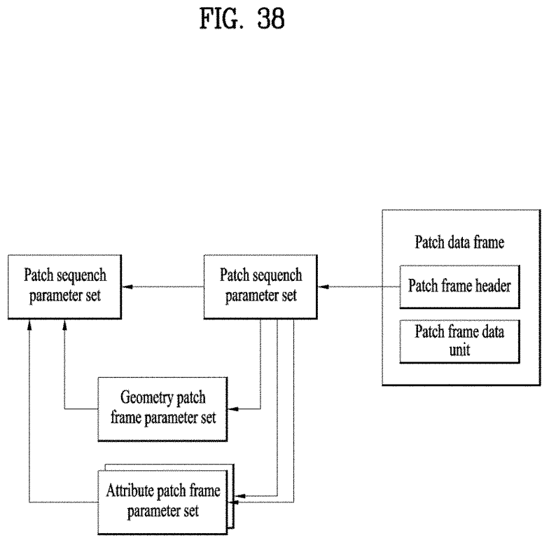

FIG. 38 illustrates an example of a structure of a patch data frame according to the embodiments.

In one embodiment, the patch data frame includes a patch frame header and a patch frame data unit.

In one embodiment, the patch frame data unit includes the aforementioned auxiliary patch information.

In one embodiment, the patch frame header includes an identifier of the active patch frame parameter set that may be applied to a sequence of the patch data frames. In one embodiment, a patch frame parameter set referenced by the identifier of the patch frame parameter set includes identifiers of an active patch sequence parameter set (psps), an active geometry patch frame parameter set (gpfps), and an active attribute patch frame parameter set (apfps).

The patch sequence parameter set (psps) according to the embodiments may include parameters that may be applied to any decoded patch data frame included in a coded sequence.

The geometry patch frame parameter sets (gpfps) according to the embodiments may include geometry patch parameters for the patch data frame.

The attribute patch frame parameter sets according to the embodiments may include attribute patch parameters for the patch data frame.

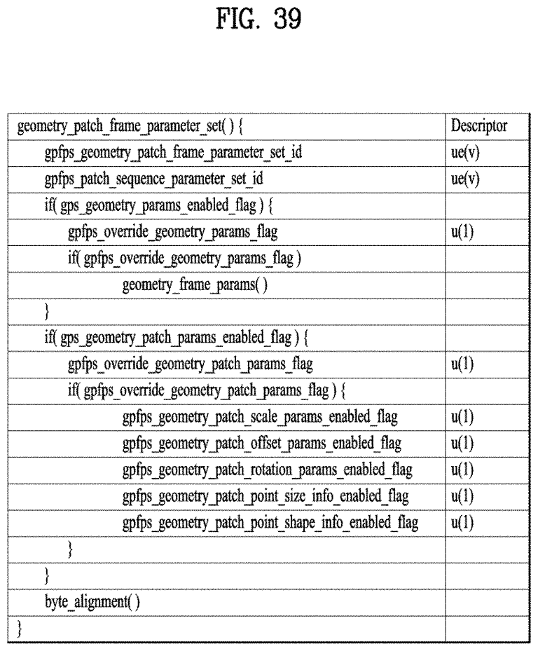

FIG. 39 illustrates an example of a syntax structure of a geometry patch frame parameter set (geometry_patch_frame_parameter_set( )) according to the embodiments.

The geometry patch frame parameter set (gpfps) according to the embodiments includes a gpfps_geometry_patch_frame_parameter_set_id field, and a gpfps_patch_sequence_parameter_set_id field. The gpfps_geometry_patch_frame_parameter_set_id field indicates an identifier for identifying the geometry patch frame parameter set for reference based on the other syntax elements. The gpfps_patch_sequence_parameter_set_id field indicates an identifier for identifying a patch sequence parameter set.

The geometry patch frame parameter set (gpfps) according to the embodiments further includes a gpfps_override_geometry_params_flag field if the gps_geometry_params_enabled_flag field has a value of 1.

In one embodiment, the gps_geometry_params_enabled_flag field is signaled to the geometry parameter set (gps) of FIG. 34.

The gpfps_override_geometry_params_flag field indicates whether the geometry patch frame parameter set includes a geometry_frame_params( ). For example, if the gpfps_override_geometry_params_flag field has a value of 1, the geometry patch frame parameter set (gpfps) further includes a geometry_frame_params( ) field.

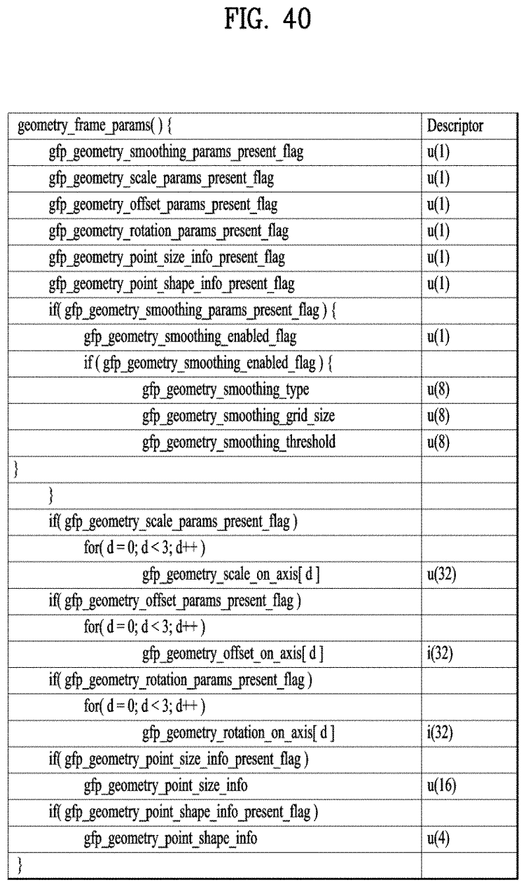

The geometry_frame_params( ) field includes geometry patch frame parameters, and will be described in detail with reference to FIG. 40.

The geometry patch frame parameter set (gpfps) according to the embodiments further includes a gpfps_override_geometry_patch_params_flag field if the gps_geometry_patch_params_enabled_flag field has a value of 1.

In one embodiment, the gps_geometry_patch_params enabled flag field is signaled to the geometry parameter set (gps) of FIG. 34.

The gpfps_override_geometry_patch_params_flag field indicates whether the geometry patch frame parameter set includes information related to a geometry patch. For example, if the gpfps_override_geometry_patch_params_flag field has a value of 1, the geometry patch frame parameter set (gpfps) of FIG. 39 may further include a gpfps_geometry_patch_scale_params_enabled_flag field, a gpfps_geometry_patch_offset_params_enabled_flag field, a gpfps_geometry_patch_rotation_params_enabled_flag field, a gpfps_geometry_patch_point_size_info_enabled_flag field, and a gpfps_geometry_patch_point_shape_info_enabled_flag field.

The gpfps_geometry_patch_scale_params_enabled_flag field indicates whether geometry patch scale parameters are signaled. The gpfps_geometry_patch_offset_params_enabled_flag field indicates whether geometry patch offset parameters are signaled. The gpfps_geometry_patch_rotation_params_enabled_flag field indicates whether geometry patch rotation parameters are signaled. The gpfps_geometry_patch_point_size_info_enabled_flag field indicates whether geometry patch point size information is signaled. The gpfps_geometry_patch_point_shape_info_enabled_flag field indicates whether geometry patch point shape information is signaled.

FIG. 40 illustrates an example of a syntax structure of geometry patch frame parameters(geometry_frame_params( )) according to the embodiments. In one embodiment, if the gpfps_override_geometry_params_flag field has a value of 1 in the geometry patch frame parameter set (gpfps) of FIG. 39, the geometry patch frame parameters(gfp) is signaled.

The geometry patch frame parameters (gfp) of FIG. 40 include a gfp_geometry_smoothing_params_present_flag field, a gfp_geometry_scale_params_present_flag_field, gfp_geometry_offset_params_present_flag field, a gfp_geometry_rotation_params_present_flag field, a gfp_geometry_point_size_info_present_flag field, and a gfp_geometry_point_shape_info_present_flag field.

The gfp_geometry_smoothing_params_present_flag field indicates whether the geometry patch frame parameters include a gfp_geometry_smoothing_enabled_flag field. For example, the geometry patch frame parameters(gfp) of FIG. 40 further include a gfp_geometry_smoothing_enabled_flag field if the gfp_geometry_smoothing_params_present_flag field has a value of 1.

The gfp_geometry_smoothing_enabled_flag field indicates whether the geometry patch frame parameters include a gfp_geometry_smoothing_type field, a gfp_geometry_smoothing_grid_size field and a gfp_geometry_smoothing_threshold field. For example, if the gfp_geometry_smoothing_enabled_flag field has a value of 1, the geometry patch frame parameters(gfp) of FIG. 40 may further include a gfp_geometry_smoothing_type field, a gfp_geometry_smoothing_grid_size field and a gfp_geometry_smoothing_threshold field.

The gfp_geometry_smoothing_type field indicates a type of geometry smoothing. For example, the type of smoothing may be a push-pull method, a smoothed push-pull method, or a combination method of push-pull and SLM. The gfp_geometry_smoothing_grid_size field indicates a variable geometry smoothing grid size used for geometry smoothing. The gfp_geometry_smoothing_threshold field indicates a smoothing threshold.

The gfp_geometry_scale_params_present_flag field indicates whether the geometry patch frame parameters include a gfp_geometry_scale_on_axis field. For example, if the gfp_geometry_scale_params_present_flag field has a value of 1, an iteration statement is included in the geometry patch frame parameters (gfp), and includes a gfp_geometry_scale_on_axis [d] field. In one embodiment, d is reset to 0 in the iteration statement, 1 is increased whenever the iteration statement is executed, and the iteration statement is repeated until d becomes 3.

The gfp_geometry_scale_on_axis[d] field indicates a value of a scale along d axis. The gfp_geometry_scale_on_axis[d] field has a value ranging from 0 to 2³²−1, and d is in the range of 0 to 2. For example, if the value of d is 0, d corresponds to X axis, if the value of d is 1, d corresponds to Y axis, and if the value of d is 2, d corresponds to Z axis.

The gfp_geometry_offset_params_present_flag field indicates whether the geometry patch frame parameters include a gfp_geometry_offset_on_axis field. If the gfp_geometry_offset_params_present_flag field has a value of 1, an iteration statement is repeated in the geometry patch frame parameters (gfp), and includes a gfp_geometry_offset_on_axis[d] field. In one embodiment, d is reset to 0 in the iteration statement, 1 is increased whenever the iteration statement is executed, and the iteration statement is repeated until d becomes 3.

The gfp_geometry_offset_on_axis[d] field indicates an offset value along d axis. The gfp_geometry_offset_on_axis[d] field has a value ranging from −2³¹ to 2³¹−1, and d is in the range of 0 to 2. For example, if the value of d is 0, d corresponds to X axis, if the value of d is 1, d corresponds to Y axis, and if the value of d is 2, d corresponds to Z axis.

The gfp_geometry_rotation_params_present_flag field indicates whether the geometry patch frame parameters include a gfp_geometry_rotation_on_axis field. For example, in one embodiment, if the gfp_geometry_rotation_params_present_flag field has a value of 1, an iteration statement is included in the geometry patch frame parameters (gfp), and includes a gfp_geometry_rotation_on_axis[d] field. In one embodiment, d is reset to 0 in the iteration statement, 1 is increased whenever the iteration statement is executed, and the iteration statement is repeated until d becomes 3.

The gfp_geometry_rotation_on_axis[d] field indicates a rotation value along d axis. The gfp_geometry_rotation_on_axis[d] field has a value ranging from −2³¹ to 2³¹−1, and d is in the range of 0 to 2. For example, if the value of d is 0, d corresponds to X axis, if the value of d is 1, d corresponds to Y axis, and if the value of d is 2, d corresponds to Z axis.

The gfp_geometry_point_size_info_present_flag field indicates whether the geometry patch frame parameters include a gfp_geometry_point_size_info field. For example, if the gfp_geometry_point_size_info_present_flag field has a value of 1, the gfp_geometry_point_size_info_present_flag field includes the gfp_geometry_point_size_info field. The gfp_geometry_point_size_info field indicates geometry point size information to be used for rendering.

The geometry_point_shape_info_present_flag field indicates whether the geometry patch frame parameters include a gfp_geometry_point_shape_info field. For example, if the geometry_point_shape_info_present_flag field has a value of 1, the geometry_point_shape_info_present_flag field includes the gfp_geometry_point_shape_info field. The gfp_geometry_point_shape_info field indicates geometry point shape information to be used for rendering.

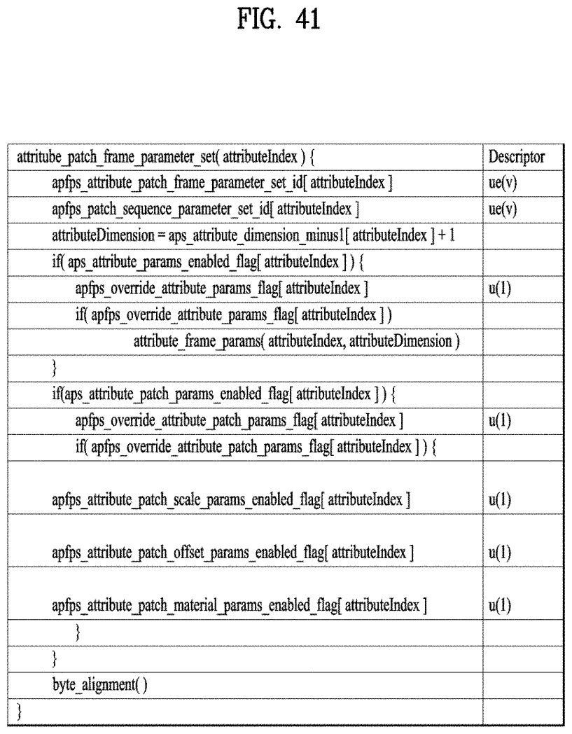

FIG. 41 illustrates an example of a syntax structure of an attribute patch frame parameter set (attribute_patch_frame_parameter_set(attributeIndex)) according to the embodiments.

The attribute patch frame parameter set (apfps) according to the embodiments includes an apfps_attribute_patch_frame_parameter_set id [attributeIndex] field and an apfps_patch_sequence_parameter_set_id [attributeIndex] field. The apfps_attribute_patch_frame_parameter_set_id field indicates an identifier for identifying the attribute patch frame parameter set for reference based on the other syntax elements. The apfps_patch_sequence_parameter_set_id field indicates an identifier for identifying a patch sequence parameter set. In one embodiment, attributeDimension is a value obtained by adding 1 to the aps_attribute_dimension_minus1[attributeIndex] field.

The attribute patch frame parameter set(apfps) according to the embodiments further includes an apfps_override_attribute_params_flag [attributeIndex] field if the aps_attribute_params_enabled_flag [attributeIndex] field has a value of 1.

In one embodiment, the aps_attribute_params_enabled_flag [attributeIndex] field is signaled to the attribute parameter set(aps) of FIG. 36.

The apfps_override_attribute_params_flag [attributeIndex] field indicates whether the attribute patch frame parameter set(apfps) includes attribute_frame_params (attributeIndex, attributeDimension). For example, if the apfps_override_attribute_params_flag field has a value of 1, the attribute patch frame parameter set(apfps) further includes attribute_frame_params (attributeIndex, attributeDimension).

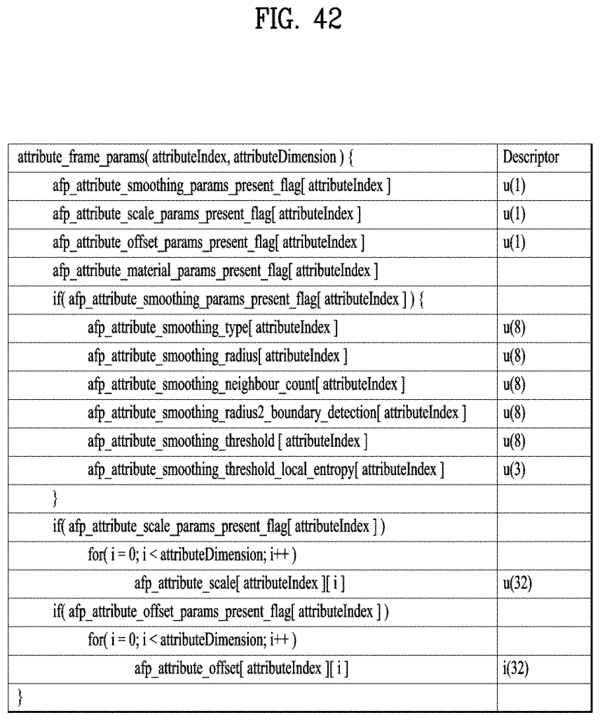

The attribute_frame_params (attributeIndex, attributeDimension) includes attribute patch frame parameters, and will be described in detail with reference to FIG. 42.

The attribute patch frame parameter set(apfps) according to the embodiments further includes an apfps_override_attribute_patch_params flag [attributeIndex] field if the aps_attribute_patch_params_enabled_flag [attributeIndex] field has a value of 1.

In one embodiment, the aps_attribute_patch_params_enabled_flag field is signaled to the attribute parameter set(aps) of FIG. 36.

The apfps_override_attribute_patch_params_flag [attributeIndex] field indicates whether attribute patch related parameters are signaled. For example, if the apfps_override_attribute_patch_params_flag field has a value of 1, the attribute patch frame parameter set(apfps) may further include an apfps_attribute_patch_scale_params_enabled_flag [attributeIndex] field, an apfps_attribute_patch_offset_params_enabled_flag [attributeIndex] field, and an apfps_attribute_patch_material_params_enabled_flag [attributeIndex] field.

The apfps_attribute_patch_scale_params_enabled_flag [attributeIndex] field indicates whether attribute patch scale parameters are signaled for an attribute of a corresponding attribute index. If the apfps_attribute_patch_scale_params_enabled_flag field has a value of 1, it indicates that the attribute patch scale parameters are signaled for an attribute having a corresponding attribute index, and If the apfps_attribute_patch_scale_params_enabled_flag field has a value of 0, it indicates that the attribute patch scale parameters are not signaled.

The apfps_attribute_patch_offset_params_enabled_flag [attributeIndex] field indicates whether attribute patch offset parameters are signaled for an attribute of a corresponding attribute index. If the apfps_attribute_patch_offset_params_enabled_flag [attributeIndex] field has a value of 1, it indicates that the attribute patch offset parameters are signaled for an attribute having a corresponding attribute index. If the apfps_attribute_patch_offset_params_enabled_flag [attributeIndex] field has a value of 0, it indicates that the attribute patch offset parameters are not signaled.

The apfps_attribute_patch_material_params_enabled_flag [attributeIndex] field indicates whether attribute patch material parameters are signaled for an attribute having a corresponding attribute index. If the apfps_attribute_patch_material_params_enabled_flag [attributeIndex] field has a value of 1, it indicates that attribute patch material parameters are signaled for an attribute having a corresponding attribute index. If the apfps_attribute_patch_material_params_enabled_flag [attributeIndex] field has a value of 0, it indicates that attribute patch material parameters are not signaled for an attribute having a corresponding attribute index.

According to the embodiments, if the apfps_override_attribute_patch_params_flag field has a value of 1, the attribute patch frame parameter set(apfps) may further include an apfps_attribute_patch_rotation_params_enabled_flag [attributeIndex] field.

The apfps_attribute_patch_rotation_params_enabled_flag [attributeIndex] field indicates whether attribute patch rotation parameters are signaled for an attribute having a corresponding attribute index. If the apfps_attribute_patch_rotation_params_enabled_flag [attributeIndex] field has a value of 1, it indicates that attribute patch rotation parameters are signaled for an attribute having a corresponding attribute index. If the apfps_attribute_patch_rotation_params_enabled_flag [attributeIndex] field has a value of 0, it indicates that attribute patch rotation parameters are not signaled for an attribute having a corresponding attribute index.

FIG. 42 illustrates an example of a syntax structure of attribute patch frame parameters(attribute_frame_params (attributeIndex, attributeDimension)) according to the embodiments. In one embodiment, if the apfps_override_attribute_params_flag [attributeIndex] field has a value of 1 in the attribute_patch_frame_parameter_set(apfps) of FIG. 41, the attribute patch frame parameter set includes attribute patch frame parameters(afp) of FIG. 42.

In one embodiment, the attribute patch frame parameters (afp) of FIG. 42 includes an afp_attribute_smoothing_params_present_flag [attributeIndex] field, an afp_attribute_scale_params_present_flag [attributeIndex] field, an afp_attribute_offset_params_present_flag [attributeIndex] field, and an afp_attribute_material_params_present_flag [attributeIndex] field. The attribute patch frame parameters (afp) may further include an afp_attribute_rotation_params_present_flag [attributeIndex] field.

The afp_attribute_smoothing_params_present_flag [attributeIndex] field indicates whether attribute smoothing parameters of a corresponding attribute index are signaled. In one embodiment, for example, if the afp_attribute_smoothing_params_present_flag [attributeIndex] field has a value of 1, the attribute patch frame parameters(afp) further include an afp_attribute_smoothing_type [attributeIndex] field, an afp_attribute_smoothing_radius [attributeIndex] field, an afp_attribute_smoothing_neighbour_count [attributeIndex] field, an afp_attribute_smoothing_radius2_boundary_detection [attributeIndex] field, an afp_attribute_smoothing_threshold [attributeIndex] field, and an afp_attribute_smoothing_threshold_local_entropy [attributeIndex] field.

The afp_attribute_smoothing_type [attributeIndex] field indicates a type of attribute smoothing of an attribute having a corresponding attribute index. For example, the type of smoothing may be a push-pull method, a smoothed push-pull method, or a combination method of push-pull and SLM.

The afp_attribute_smoothing_radius [attributeIndex] field indicates a smoothing radius of an attribute having a corresponding attribute index.

The afp_attribute_smoothing_neighbour_count [attributeIndex] field indicates a smoothing neighbor count of an attribute having a corresponding attribute index.

The afp_attribute_smoothing_radius2_boundary_detection [attributeIndex] field indicates a smoothing radius2 boundary detection of an attribute having a corresponding attribute index.

The afp_attribute_smoothing_threshold [attributeIndex] field indicates a smoothing threshold of an attribute having a corresponding attribute index.

The afp_attribute_smoothing_threshold_local_entropy [attributeIndex] field indicates a local entropy threshold in neighborhood of a boundary point of an attribute having a corresponding attribute index.

The afp_attribute_scale_params_present_flag [attributeIndex] field indicates whether the attribute patch frame parameters include an asp_attribute_scale [attributeIndex][i] field. For example, if the afp_attribute_scale_params_present_flag [attributeIndex] field has a value of 1, an iteration statement is included in the attribute patch frame parameters(afp), and includes an afp_attribute_scale [attributeIndex][i] field. In one embodiment, i is reset to 0 in the iteration statement, 1 is increased whenever the iteration statement is executed, and the iteration statement is repeated until a value of i becomes a value of attributeDimension. The afp_attribute_scale [attributeIndex][i] field indicates a value of a scale to be applied to values of an ith Dimension of an attribute having a corresponding attribute index.

The afp_attribute_offset_params_present_flag [attributeIndex] field indicates whether the attribute patch frame parameters include an afp_attribute_offset [attributeIndex][i] field. For example, if the afp_attribute_offset_params_present_flag [attributeIndex] field has a value of 1, an iteration statement is included in the attribute patch frame parameters(afp), and includes an afp_attribute_offset [attributeIndex][i] field. In one embodiment, i is reset to 0 in the iteration statement, 1 is increased whenever the iteration statement is executed, and the iteration statement is repeated until a value of i becomes a value of attributeDimension. The afp_attribute_offset [attributeIndex][i] field indicates an offset value to be added to values of an ith Dimension of an attribute having a corresponding attribute index.

In one embodiment, the afp_attribute_material_params_present_flag [attributeIndex] field indicates whether the attribute patch frame parameters include an afp_attribute_material [attributeIndex][i] field. In one embodiment, for example, if the afp_attribute_material_params_present_flag [attributeIndex] field has a value of 1, an iteration statement is included in the attribute patch frame parameters(afp), and includes an afp_attribute_material [attributeIndex][i] field. In one embodiment, i is reset to 0 in the iteration statement, 1 is increased whenever the iteration statement is executed, and the iteration statement is repeated until a value of i becomes a value of attributeDimension. The afp_attribute_material [attributeIndex][i] field indicates a material value to be applied to values of an ith Dimension of an attribute having a corresponding attribute index.

In one embodiment, the afp_attribute_rotation_params_present_flag [attributeIndex] field indicates whether the attribute patch frame parameters include an afp_attribute_rotation [attributeIndex][i] field. In one embodiment, for example, if the afp_attribute_rotation_params_present_flag [attributeIndex] field has a value of 1, an iteration statement is included in the attribute patch frame parameters(afp), and includes an afp_attribute_rotation [attributeIndex][i] field. In one embodiment, i is reset to 0 in the iteration statement, 1 is increased whenever the iteration statement is executed, and the iteration statement is repeated until a value of i becomes a value of attributeDimension. The afp_attribute_rotation [attributeIndex][i] field indicates a rotation value to be applied to values of an ith Dimension of an attribute having a corresponding attribute index.

Meanwhile, a point cloud object for point cloud data may be divided into one or multiple tiles. In this specification, tiles indicate a certain area on a 3D space. For example, the tiles may be a portion of a rectangular cuboid or a sub-bounding box or a patch data frame in one bounding box. In this specification, dividing the point cloud object into one or multiple tiles may be performed by the point cloud video encoder of FIG. 1, the patch generation unit of FIG. 18, the point cloud preprocessor of FIG. 20 or the patch generation unit of FIG. 21, or may be performed by a separate component/module.

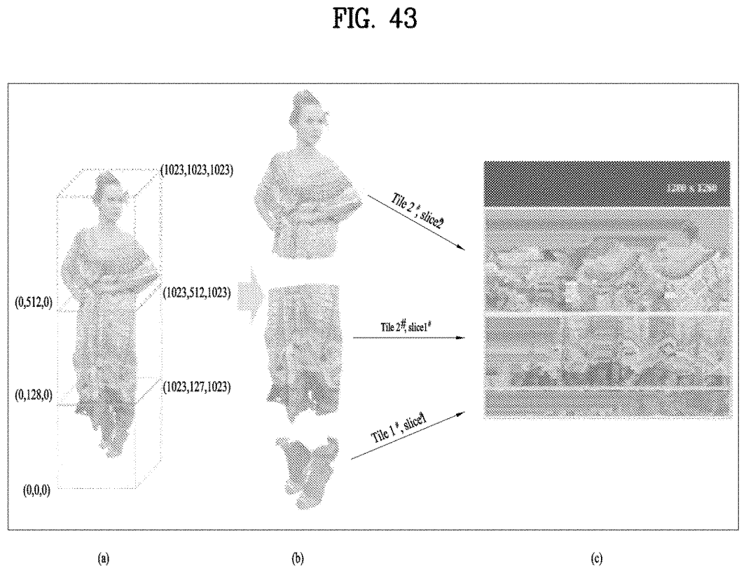

FIGS. 43(a) to 43(c) illustrate an example of dividing a point cloud object according to the embodiments into one or multiple tiles. As shown in FIG. 43(a), the point cloud object may be represented in the form of box based on a coordinate system. This is referred to as a bounding box.

FIGS. 43(b) and 43(c) illustrate examples of dividing a bounding box of FIG. 43(a) into tile 1# and tile2# and then dividing tile2# into slice 1# and slice 2#. In one embodiment of the present specification, slice is a unit that may independently be coded in a corresponding tile.

In one embodiment, information on one or multiple tiles is signaled through a tile parameter set.

The tile parameter set may be included in any parameter sets, for example, at least one of sequence parameter set, patch sequence parameter set, patch frame parameter set, geometry patch frame parameter set, attribute patch frame parameter set, geometry patch parameter set, attribute patch parameter set, patch information data and patch data frame.

The tile parameter set enables spatial access of point cloud objects.

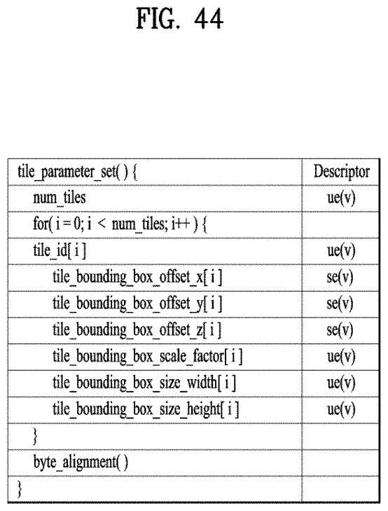

FIG. 44 illustrates an example of a syntax structure of a tile parameter set (tile parameter set( )) according to the embodiments. FIG. 44 illustrates an example of signaling 3D information on each of tiles in a point cloud object.

To this end, in one embodiment, the tile parameter set includes a num_tiles field indicating the number of tiles, and includes an iteration statement repeated as much as a value of the num_tiles field.

In one embodiment, the iteration statement includes a tile_id [i] field, a tile_bounding_box_offset_x [i] field, a tile_bounding_box_offset_y [i] field, a tile_bounding_box_offset_z [i] field, a tile_bounding_box_scale_factor [i] field, a tile_bounding_box_size_width [i] field, and a tile_bounding_box_size_height [i] field.

The num_tiles field indicates the number of tiles for a point cloud object.

The tile_id [i] field indicates an identifier of an ith tile included in Cartesian coordinates (or Descartes coordinates or orthogonal coordinates).

The tile_bounding_box_offset_x [i] field indicates x offset of an ith tile included in Cartesian coordinates.

The tile_bounding_box_offset_y[i] field indicates y offset of an ith tile included in Cartesian coordinates.

The tile_bounding_box_offset_z[i] field indicates z offset of an ith tile included in Cartesian coordinates.

The tile_bounding_box_scale_factor[i] field indicates a scale factor of an ith tile included in Cartesian coordinates.

The tile_bounding_box_size_width[i] field indicates a width of an ith tile included in Cartesian coordinates.

The tile_bounding_box_size_height[i] field indicates a height of an ith tile included in Cartesian coordinates.

The tile_bounding_box_size_depth[i] field indicates a depth of an ith tile included in Cartesian coordinates.

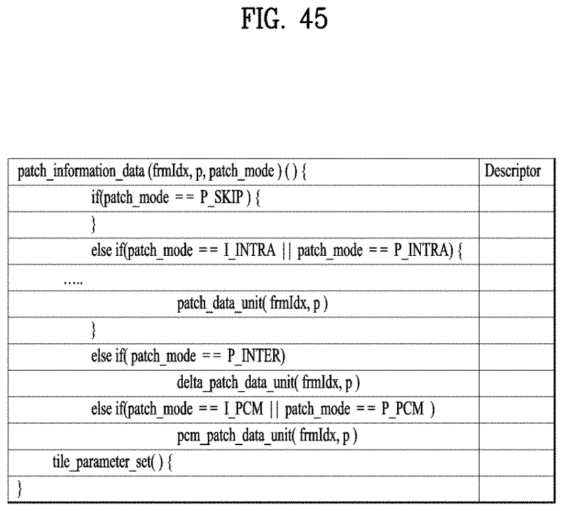

FIG. 45 illustrates an example of a syntax structure of patch information data(patch_information_data (frmIdx, p, patch_mode)) according to the embodiments. Particularly, FIG. 45 illustrates an example that patch information data include a tile parameter set(tile_parameter_set( )) of FIG. 44. Therefore, details of information included in the tile parameter set will be understood with reference to FIG. 44 and thus will be omitted herein.

In one embodiment, the patch information data are included in the patch frame data unit of the patch data frame.

The patch information data may further include at least one of a patch data unit (patch_data_unt(frmIdx, p), a delta patch data unit (delta_patch_data_unit(frmIdx, p), and a PCM patch data unit (PCM_patch_data_unit(frmIdx, p).

The patch mode (patch_mode) indicates one or multiple patch modes per I patch type group and P patch type group. For example, if the patch mode is I_INTRA, it may indicate a non-predicted patch mode, if the patch mode is I_PCM, it may indicate a PCM point patch mode, and if the patch mode is I_END, it may indicate a patch end mode. For another example, if the patch mode is P_SKIP, it may indicate a patch skip mode, if the patch mode is P_INTRA, it may indicate a non-predicted patch mode, if the patch mode is P_INTER, it may indicate an inter predicted patch mode, if the patch mode is P_PCM, it may indicate a PCM point patch mode, and if the patch mode is P_END, it may indicate a patch type mode.

In one embodiment, if the patch mode indicates I_INTRA or P_INTRA, the patch information data include a patch data unit.

In one embodiment, if the patch mode is P_INTRA, the patch information data further include a delta patch data unit (delta_patch_data_unit)(frmIdx, p).

In one embodiment, if the patch mode indicates I_PCM or P_PCM, the patch information data further include a PCM patch data unit (pcm_patch_data_unit)(frmIdx, p).

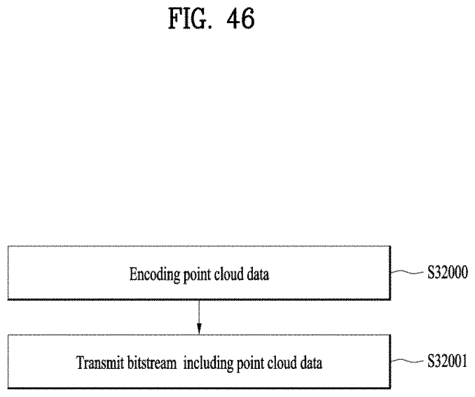

FIG. 46 illustrates a point cloud data transmission method according to the embodiments.

In S32000, the point cloud data transmission method according to the embodiments encodes point cloud data. The detailed encoding process according to the embodiments is as described in the point cloud video encoder 10002 of FIG. 1, the V-PCC encoding process of FIG. 4, the encoding process of FIG. 15, the encoding pre-processor 18003, the metadata encoding unit 18005 and/or the video encoding unit 18006 of FIG. 18, the point cloud preprocessor 20001 and the video/image encoding units 20002 and 20003 of FIG. 20, and the point cloud preprocessor 20001 and the video/image encoding unit 21007 and 21008 of FIG. 21.

In S32001, the point cloud data transmission method according to the embodiments transmits bitstreams including point cloud data. The detailed transmission process according to the embodiments is as described in the transmitter 10004 of FIG. 1, the transmission unit 18008 of FIG. 18, and V-PCC delivery of FIGS. 20 and 21, etc.

The point cloud data transmission method according to the embodiments may include the steps as shown, and may provide technical problems and/or effects of the embodiments in combination with the embodiments additionally described in the present specification.

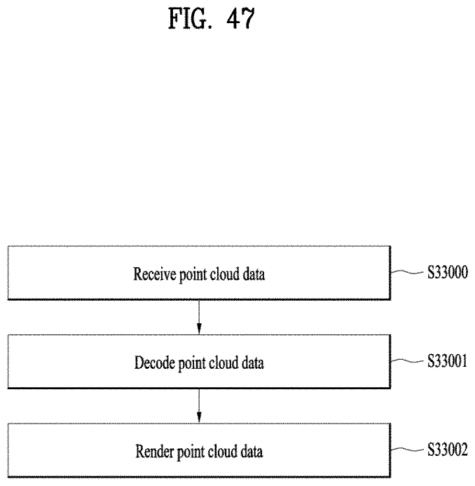

FIG. 47 illustrates a point cloud data reception method according to the embodiments.

In S33000, the point cloud data method receives point cloud data. The detailed reception process according to the embodiments is as described in the receiver 10006 of FIG. 1, the demultiplexer 16000 of FIG. 16, the decoding device 17000 of FIG. 16, the decoding device 17000 of FIG. 17, the receiver of FIG. 19, the V-PCC player of FIG. 20, the delivery of FIG. 22, etc.

In S33001, the point cloud data reception method decodes point cloud data. The detailed decoding process according to the embodiments is as described in the point cloud video decoder 10008 of FIG. 1, the V-PCC decoding process of FIG. 19, the video/image decoding unit of FIG. 17, the video decoding unit 19001 of FIG. 19, the metadata decoding unit 19002, the video/image decoding units 20006 and 20008 of FIG. 20, the video/image decoding units 22001 and 22002 of FIG. 22, the point cloud processing unit 22003, etc.

In S33002, the point cloud reception method according to the embodiments renders point cloud data. The detailed rendering process according to the embodiments is as described in the renderer 10009 of FIG. 1, the decoding process of FIGS. 16 and 17, the point cloud renderer of FIG. 19, the rendering unit 20009 and the display of FIG. 20, the point cloud rendering unit 22004, etc.

The point cloud data reception method/device according to the embodiments may be provided in combination with all/some of the aforementioned embodiments to provide point cloud contents.

Each part, module, or unit described above may be a software, processor, or hardware part that executes successive procedures stored in a memory (or storage unit). Each of the steps described in the above embodiments may be performed by a processor, software, or hardware parts. Each module/block/unit described in the above embodiments may operate as a processor, software, or hardware. In addition, the methods presented by the embodiments may be executed as code. This code may be written on a processor readable storage medium and thus read by a processor provided by an apparatus.

Although embodiments have been explained with reference to each of the accompanying drawings for simplicity, it is possible to design new embodiments by merging the embodiments illustrated in the accompanying drawings. If a recording medium readable by a computer, in which programs for executing the embodiments mentioned in the foregoing description are recorded, is designed by those skilled in the art, it may fall within the scope of the appended claims and their equivalents.

The apparatuses and methods may not be limited by the configurations and methods of the embodiments described above. The embodiments described above may be configured by being selectively combined with one another entirely or in part to enable various modifications.

Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

It will be appreciated by those skilled in the art that various modifications and variations may be made in the embodiments without departing from the scope of the disclosures. Thus, it is intended that the present disclosure cover the modifications and variations of the embodiments provided they come within the scope of the appended claims and their equivalents.

Both apparatus and method disclosures are described in this specification and descriptions of both the apparatus and method disclosures are complementarily applicable.

In this document, the term “/” and “,” should be interpreted as indicating “and/or.” For instance, the expression “A/B” may mean “A and/or B.” Further, “A, B” may mean “A and/or B.” Further, “A/B/C” may mean “at least one of A, B, and/or C.” “A, B, C” may also mean “at least one of A, B, and/or C.”

Further, in the document, the term “or” should be interpreted as “and/or.” For instance, the expression “A or B” may mean 1) only A, 2) only B, and/or 3) both A and B. In other words, the term “or” in this document should be interpreted as “additionally or alternatively.”

Various elements of the apparatuses of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the apparatus according to the embodiments may include one or more processors capable of executing one or more programs. The one or more programs may perform any one or more of the operations/methods according to the embodiments or include instructions for performing the same. Executable instructions for performing the method/operations of the apparatus according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signal unless context clearly dictates otherwise.

The terminology used to describe the embodiments is used for the purpose of describing particular embodiments only and is not intended to be limiting of the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components.

As used herein, conditional expressions such as “if” and “when” are not limited to an optional case and are intended to be interpreted, when a specific condition is satisfied, to perform the related operation or interpret the related definition according to the specific condition.

Embodiments may include variations/modifications within the scope of the claims and their equivalents.

It will be apparent to those skilled in the art that various modifications and variations can be made in the present invention without departing from the spirit and scope of the invention. Thus, it is intended that the present invention cover the modifications and variations of this invention provided they come within the scope of the appended claims and their equivalents.

What is claimed is:

1. A point cloud data transmission method comprising:
encoding point cloud data; and
transmitting a bitstream that includes the point cloud data.

2. The point cloud data transmission method of claim 1, wherein the point cloud data include geometry data, attribute data, and occupancy map data, which are encoded by a video based point cloud compression (V-PCC) scheme.

3. The point cloud data transmission method of claim 2, wherein the bitstream includes V-PCC units, each of which includes a header and a payload, and wherein the header includes type information for identifying data included in the payload that includes one of the geometry data, the attribute data, the occupancy map data and metadata, the metadata including at least patch information or parameter information.

4. The point cloud data transmission method of claim 3, wherein at least the header or the metadata includes layer information related to a layer of the geometry data and a layer of the attribute data.

5. The point cloud data transmission method of claim 4, wherein the layer information includes at least one of information for indicating whether multiple layers have been used to encode the geometry data, information for indicating whether multiple layers have been used to encode the attribute data, information for indicating whether a number of layers used to encode the geometry data is different from a number of layers used to encode the attribute data, information for indicating the number of layers used to encode the geometry data, and information for indicating the number of layers used to encode the attribute data.

6. A point cloud data transmission device comprising:
an encoder for encoding point cloud data; and
a transmitter for transmitting a bitstream that includes the point cloud data.

7. The point cloud data transmission device of claim 6, wherein the point cloud data include geometry data, attribute data, and occupancy map data, which are encoded by a video based point cloud compression (V-PCC) scheme.

8. The point cloud data transmission device of claim 6, wherein the bitstream includes V-PCC units, each of which includes a header and a payload, and wherein the header includes type information for identifying data included in the payload that includes one of the geometry data, the attribute data, the occupancy map data and metadata, the metadata including at least patch information or parameter information.

9. The point cloud data transmission device of claim 8, wherein at least the header or the metadata includes layer information related to a layer of the geometry data and a layer of the attribute data.

10. The point cloud data transmission device of claim 9, wherein the layer information includes at least one of information for indicating whether multiple layers have been used to encode the geometry data, information for indicating whether multiple layers have been used to encode the attribute data, information for indicating whether a number of layers used to encode the geometry data is different from a number of layers used to encode the attribute data, information for indicating the number of layers used to encode the geometry data, and information for indicating the number of layers used to encode the attribute data.

11. A point cloud data reception method comprising:
receiving a bitstream that includes point cloud data;
decoding the point cloud data; and
rendering the point cloud data.

12. The point cloud data reception method of claim 11, wherein the point cloud data include geometry data, attribute data, and occupancy map data, which are encoded by a video based point cloud compression (V-PCC) scheme.

13. The point cloud data reception method of claim 12, wherein the bitstream includes V-PCC units, each of which includes a header and a payload, and wherein the header includes type information for identifying data included in the payload that includes one of the geometry data, the attribute data, the occupancy map data and metadata, the metadata including at least patch information or parameter information.

14. The point cloud data reception method of claim 13, wherein at least the header or the metadata includes layer information related to a layer of the geometry data and a layer of the attribute data.

15. The point cloud data reception method of claim 14, wherein the layer information includes at least one of information for indicating whether multiple layers have been used to encode the geometry data, information for indicating whether multiple layers have been used to encode the attribute data, information for indicating whether a number of layers used to encode the geometry data is different from a number of layers used to encode the attribute data, information for indicating the number of layers used to encode the geometry data, and information for indicating the number of layers used to encode the attribute data.

16. A point cloud data reception device comprising:
a receiver for receiving a bitstream that includes point cloud data;
a decoder for decoding the point cloud data; and
a renderer for rendering the point cloud data.

17. The point cloud data reception device of claim 16, wherein the point cloud data include geometry data, attribute data, and occupancy map data, which are encoded by a video based point cloud compression (V-PCC) scheme.

18. The point cloud data reception device of claim 17, wherein the bitstream includes V-PCC units, each of which includes a header and a payload, and wherein the header includes type information for identifying data included in the payload that includes one of the geometry data, the attribute data, the occupancy map data and metadata, the metadata including at least patch information or parameter information.

19. The point cloud data reception device of claim 18, wherein at least the header or the metadata includes layer information related to a layer of the geometry data and a layer of the attribute data.

20. The point cloud data reception device of claim 19, wherein the layer information includes at least one of information for indicating whether multiple layers have been used to encode the geometry data, information for indicating whether multiple layers have been used to encode the attribute data, information for indicating whether a number of layers used to encode the geometry data is different from a number of layers used to encode the attribute data, information for indicating the number of layers used to encode the geometry data, and information for indicating the number of layers used to encode the attribute data.
